(19) United States
(12) Patent Application Publication
(10) Pub. No.: US 2002/0150094 A1
(43) Pub. Date: Oct. 17, 2002

(54) Hierarchical level-based internet protocol multicasting

(76) Inventors: Matthew Cheng, Avenel, NJ (US); John Lee, Neptune, NJ (US); Melbourne Barton, Somerville, NJ (US)

Correspondence Address: Telcordia Technologies, Inc., 445 South Street, Room 1G112R, Morristown, NJ, 07960, US

(21) Appl. No.: 10/036,032

(22) Filed: Oct. 26, 2001

Related U.S. Application Data
(60) Provisional application No. 60/243,809, filed on Oct. 27, 2000.

(51) Int. Cl. H04L 12/28

(52) U.S. Cl. 370/389; 370/395.1

(57) ABSTRACT

Hierarchical Level-Based IP Multicasting (HLIM) is a method for the multicasting of data packets from a source to a number of receivers on a network that supports both host and network mobility. In HLIM, IP routers are assigned to hierarchical levels to become hierarchical designated routers. The hierarchical levels also are used to define a scope region in which multicast data packets are to be delivered. Each scope region is associated with a unique root identifier (RID). Scope region information and root identifiers are placed into a multicast address so that multicast packers of data will be distributed to routers and hosts within the scope region. If a host (receiver or source) or sub-network moves out of the scope region but desires to continue receiving multi-cast packets the host can request receipt of such packets from its new parent hierarchical designated router through use of the RID and associated binding point (BPT). In this manner, HLIM provides a shared and shortest-path multicast tree without using a center point like a core or rendezvous point. HLIM supports not only host mobility (movements of IP hosts) but also network mobility (movements of IP routers with/without hosts). HLIM is oriented to operate in hierarchical networks, but can be also applied to flat networks by emulating the networks into organized hierarchical networks through mechanisms such as the Private Network-to-Network Interface (“PNNI”) protocol used in ATM or multimedia support for mobile wireless networks (“MMWM”). Thus, HLIM can be implemented as long as the network nodes are connected in a hierarchy, physically or virtually.

### RELATED APPLICATIONS

The present application claims the benefit of U.S. Provisional Application No. 60/243,809 filed on Oct. 27, 2000, entitled “Hierarchical Level-Based IP Multicast (HLIM).”

### GOVERNMENT LICENSE RIGHTS

This invention was made with Government Support under DAAB07-98-C-D007 awarded by the United States Army Communications—Electronics Command (CECOM). The Government has certain rights in this invention.

### FIELD OF THE INVENTION

This invention relates to a method of delivering packets of data to a user over the Internet using internet protocol (“IP”), particularly to a method of multicasting the same packet of data to a plurality of users in a hierarchical network.

### BACKGROUND

Currently Internet services rely almost entirely on unicast transport. Unicasting is a technical term for delivering a packet from a sender to only a single destination. This approach has been very successful for the majority of current Internet applications such as File Transfer Protocol (“FTP”), Simple Mail Transfer Protocol (“SMNP”), TELNET, the X window system, Network File Service (“NFS”), and the World Wide Web's (WWW) HyperText Transfer Protocol (HTTP), because these applications are built based upon one-to-one or client-to-server communications.

It is not efficient, however, to use unicasting on applications associated with one-to-many or many-to-many communications such as providing a video service to a plurality of subscribers simultaneously. Additionally, the one-time cost is not significant when compared with the cost for frequent link usage. Link utilization has recently become a significant issue in the Internet community as the number of Internet users continues to increase significantly.

Multicasting is a transmission technique that delivers a single copy of a message from a sender to selected multi-destinations (selected group members or subscribers). The basic motivation for multicasting is to save network bandwidths on paths shared by multiple receivers by sending a single copy of a message rather than sending the multiple copies of the same message to each receiver. A source has to transmit once instead of n times for n receivers. Similarly, by virtue of using a source-based tree at the network level for distribution, multicast is able to reduce the number of packets within the network significantly compared to multiple unicasts. Any service with a number of applications wishing to receive the same (or overlapping subsets of information at approximately the same time is a candidate for multicasting. For example, delivery of real-time stock quotes across an Intranet infrastructure would benefit greatly from a multicasting approach.

The demand for multicasting is increasing and more multicast applications are becoming available, especially in the Internet community. Applications such as distributed systems and databases, audio and video conferencing and distribution can benefit from the multicasting feature provided by the networks. Table 1 shows characteristics of some possible multicast applications. Since 1992, an experimental multicast backbone known as MBONE has been running in the Internet. MBONE is a cooperative voluntary effort consisting of both service providers and end users/subscribers. The number of sites participating in MBONE has grown exponentially since its inception. Due to the increasing popularity of multicast applications, an international multi-vendor forum called the IP Multicast Initiative (“IPMI”) was founded in 1996 to promote and accelerate the adoption and deployment of IP multicast standards. The IPMI has nearly 100 members now, including both manufacturers and service providers.

TABLE 1
Multicast Application Characteristics

| | | | | | Static/ | Modification |
|---|---|---|---|---|---|---|
| Application | Total Size | Multicast Size | Bandwidth | Real-time | Dynamic | Requested by |
| File System | Small | Small | 10K-1 M | No | Static | Source |
| Distributed | Medium | Small | 1-10 M | No | Static | Source |
| Database | | | | | | |
| Multiprocessor | Medium | Small | 1-100K | Yes | Static | Source |
| Telemetry | Large | Medium | <10K | No | Static | Destination |
| CAM^{† Control} | Medium | Small | <10K | Yes | Static | Destination |
| Service Location | Large | Large | <100K | No | Static | Destination |
| Audio Conference | Medium | Small | 4-64K | Yes | Dynamic | Either |
| Video Conference | Medium | Small | 2-34 M | Yes | Dynamic | Either |
| Whiteboard | Medium | Small | 1K-1 M | Yes | Dynamic | Either |
| Audio Distribution | Large | Large | 1-2 M | No | Dynamic | Destination |
| Video Distribution | Large | Large | 2-32 M | No | Dynamic | Destination |
| Broadcast | Large | Large | 1-10 M | No | Static | Either |
| Emulation | | | | | | |

Multicast communications are also essential in military tactical networks. Potential applications in tactical environments include collaborative planning through whiteboards and audio/video conferencing, data distribution from surveillance platforms, command distribution from leaders/commanders, information sharing within peer group and between peer groups, real-time control of remote platforms and database/server replications for fault tolerance.

The requirements in tactical environments are more stringent than those typically found today in commercial environments. For example, the participants in a tactical multicast group need to move around at high speed, are typically very large, and need the use of many real-time applications. Although these are currently the requirements in tactical environments, it is likely that future commercial environments will require similar features.

Existing IP multicasting schemes are basically differentiated by how a tree for connections from a sender to the associated multiple receivers (called “spanning tree” or “multicast tree”) is generated. Broadly, there are two schemes: a source-based tree and a shared tree. In the source-based tree scheme, a multicast tree is created from a sender to all the perceived receivers with the shortest paths. In this case, a sender is the root of a multicast tree. One advantage is that a path from a sender to any of the receivers is always the shortest. The drawback to a scheme using source-based trees is scalability. If many different sources (or applications) send data packets to the same set of receivers multiple multicast trees rooted at each source (depending on the locations of the sources) must be generated for the same set of receivers. This creates the need for redundant control messages to set up multicast trees for the sources. Multicast routers are required to maintain the state information specific to each individual multicast source rather then a multicast group.

The shared tree scheme reduces the scalability problem since all the multicasting sessions for a same set of receivers can be established through a single shared multicast tree (i.e., the state information specific to a multicast group). A tree from a known center point as a root to all perceived receivers is created and sources send their messages to the root. Thereafter, the root disseminates the messages to the receivers. The drawback of this scheme, however, becomes apparent when optimal routing is emphasized because the shared tree scheme provides the shortest path only between the root and receivers, not between a source and receivers (end-to-end). In addition, this scheme requires a degree of complexities or mechanisms to notify the location of the root to each source and receiver.

The basic IP multicasting model is based on the concept of host groups. A host group represents a dynamic set of receivers diversely located and is identified by a class D IP address [a 43-address]. A sender uses the host group address as the destination address to send out multicast packets to the group members. A receiver receives the multicast packets by “joining” the group. Based on the concept of host groups, two types of mechanisms are employed to transport a multicast packet from an arbitrary sender to a dynamic set of receivers of a particular host group. The first mechanism, the Local Multicasting Mechanism, manages host group memberships and the second mechanism, the Global Multicasting Mechanism, sets up routing paths from a sender to the receivers of a host group. The local multicast mechanism handles the interaction between host multicast members and the corresponding router, and the global multicast mechanism sets up multicast trees with routers based upon the information of routers maintaining the host multicast memberships.

Currently the local multicast mechanism is the Internet Group Management Protocol (“IGMP”). IGMP defines interactions between IP hosts on a subnet and any immediately neighboring multicast routers on that subnet to constitute and maintain host groups. The multicast router periodically sends a query message on the subnet. All hosts on the subnet will receive the query message. A host that wants to join a group or is currently a group member may respond to the query message. Upon receiving the query, the host will set a timer for each group it wants to join or of which it is currently a member. Each timer is set to a different random value. When a timer expires, the host will send a report message for the corresponding group to the router. Since the underlying network is a broadcast medium, all other hosts in the subnet will also receive the report message. When a host running the timer for the group receives the message, it will stop the timer associated with the group and will not send any report message for the group. In such way, no duplicate report message is generated and sent out on the subnet.

When the router receives the report message, it adds the group being reported to the list of multicast group memberships on the subnet. If the router receives a multicast packet from a remote subnet, it will then determine whether to pass or discard the multicast packet for the local subnet according to the group membership list. If the router does not receive a report message for a particular group within a certain period (around 120 seconds) after its query message, it will assume that the group has no local members, and then remove the group from the group membership list.

The updated version of IGMP allows a receiver to send a report message without waiting for a query, to speed up the group joining process, and to explicitly send a leave-group message for a route to track down the status of group membership more quickly. Such fast adjustment of the group membership status helps to save network resources on the local subnet by avoiding unnecessary multicast packets.

The IGMP version 3 includes the “source filtering” feature which helps receivers to receive the multicast packets only from selective sources or from all but specific sources sent to a particular multicast addresses.

Global multicasting mechanism establishes a multicast tree from a sender to end routers (running IGMP) of a group. The multicast tree provides an efficient routing path for multicast packet delivery from the sender to the end routers which have local group membership for the particular group. Global multicasting mechanisms can be classified into two main categories: 1) source-based tree protocol and 2) shared tree protocol.

In the source-based tree protocol, one specific multicast tree rooted at a source is generated for each source of each group. Different sources of the same group have different multicast trees. Distance Vector Multicast Routing Protocol (DVMRP), Multicast Open Shortest Path First (MOSPF), and Protocol Independent Multicast Dense Mode (PIM-DM) belong to this category.

DVMRP is based on the Routing Information Protocol (“RIP”), which provides unicast routing by applying the distance vector routing algorithm. DVMRP is dependent on the underlying unicast protocol. It has been widely used in MBONE. In DVMRP, a multicast tree provides the “shortest” path from a source to every multicast receiver of a group. “Shortest” here refers to the minimum number of hops along the path since the DVMRP uses the number of hops as the routing metric. A multicast tree is established on demand using a ‘broadcast and prune’ technique: broadcasting the first multicast packet to all routers running the IGMP, minimizing the number of replicated packets, and pruning unnecessary branches leading to no receivers. In DVMRP, each router maintains an on (forwarding) or off (pruning) state on every interface for each multicast group. The broadcasting process sets all interfaces on a router to on-state and the pruning process sets the interfaces of routers leading to no members to off-state.

In order to achieve efficient broadcasting to all IGMP routers which keep local group membership databases, a router in DVMRP forwards the multicast packet only to the necessary interfaces, not to all possible interfaces. Each router has a routing table for multicasting created by the underlying routing algorithm (i.e., RIP). Looking up the table, a router can find its upstream interface to the next hop router towards a source of a multicast group, and also its dependent downstream interfaces over which the neighboring routers receive packets from the source. When a router receives the first multicast packet from a source, it first checks whether the interface on which the packet arrives is the upstream interface for the source. This is called the Reverse Path Forwarding (RPF) check. If so, a copy of the packet is forwarded to every dependent downstream interface. Otherwise, the packet is discarded. The information about the interfaces is recorded in the forwarding cache of the router for fast processing of subsequent multicast packets.

When an IGMP router receives the first multicast packet for a group through the efficient broadcast, it consults its local group membership database. If there is any member for that group, it passes the packet to the subnets which contain a member of the group. If there is no member for the group in a sub-net, then the router sets the interface to which the sub-net is connected, to an off-state. If a router does not have any dependent downstream interface or all of its dependent downstream interfaces are in the off-state, it then sends a prune message to the upstream interface towards the source. Upon receiving the prune message, the upstream router sets the interface, over which the prune message arrived, to off-state. Multicast packets are never sent out on interfaces in off-state. Similarly, the upstream router sends out a prune message to its upstream router, if necessary, as described above. The prune information (such as pruning states, sending and receiving prune messages) is recorded in the forwarding cache at the router for use with subsequent multicast packets from the same source of the same group. A pruning state (interface in off-state) will be turned back to an on-state automatically after the expiry of prune-lifetime (usually 2 hours) and the broadcast operation is then resumed.

In order to respond to the joining of new group members in the subnets, DVMRP uses a graft message. The IGMP router associated with the subnet with new members, sets the state of the interface to which the subnet is connected, back to on-state. It then sends out a graft message on the upstream interface towards a source of the group. Upon receiving the graft message, if the upstream router is on the multicast tree, it adds the pruned branch back into the multicast tree by changing the state back to the on-state on the interface over which the graft message arrives. If the router is not on the tree, it forwards the graft message to the next upstream router towards the source until the graft message reaches a router that is on the tree.

DVMRP works well for a multicast group that is densely populated within an autonomous system. However, for a multicast group that is sparsely populated over a wide-area network, the broadcast behavior of DVMRP would cause serious performance problems. Another problem with DVMRP is the amount of multicast routing state information that must be stored in the multicast routers. All multicast routers must store state information for every (source, group) pair, either for forwarding or for pruning. For these reasons, DVMRP does not scale well to support multicast groups that are sparsely populated over a large network.

The Protocol Independent Multicast (PIM) protocol is a standard multicast routing protocol that can provide scalable intra/inter-domain multicasting across the Internet, and be independent of the underlying unicast routing protocol. PIM has two operation modes: 1) PIM-DM (Dense Mode) for densely distributed multicast groups and 2) PIM-SM (Sparse Mode) for sparsely distributed multicast groups.

PIM-DM is similar to DVMRP. Both protocols employ the reverse path forwarding checks, broadcast and prune operations to construct source-rooted multicast trees. The major difference between DVMRP and PIM-DM is that PIM-DM is completely independent of the underlying unicast routing protocol, while DVMRP relies on specific mechanisms associated with the RIP. Therefore, PIM-DM has no concept of dependent downstream interface, which is used in DVMRP to provide more efficient broadcast. A PIM-DM router forwards a multicast packet to all interfaces (except the one receiving the packets), instead of only the dependent downstream interfaces as in DVMRP. This would result in some unnecessary replicates during the broadcast of the first multicast packet to all IGMP routers. Though PIM-DM is less efficient than DVMRP in the broadcast operation, it is less complex than DVMRP.

Multicast Open Shortest Path First (“MOSPF”) is derived by adding enhancements to the underlying Open Shortest Path First (OSPF) unicast protocol to support IP multicast routing. MOSPF is dependent on the underlying unicast protocol. It forwards a multicast packet based on both the packet's source and destination addresses. It constructs a source-rooted multicast tree, which provides the shortest path from a source to the receivers of a group by applying the same algorithm used in OSPF.

In OSPF, every router maintains an identical database describing a network (an autonomous system) topology through flooding link-state advertisements such as the state of a router's interfaces and neighbors. Link state advertisement describes the local state of a router or network. This includes the state of the router's interfaces and adjacencies. Each link state advertisement is flooded throughout the routing domain. The protocol's topological database, which describes a directed graphical view of the network consisting of routers and sub-networks, is formed at every router from the collected link state advertisements of all routers and networks. From the topological database, each router constructs a tree of shortest paths to all other routers with itself as the root. Based on the shortest path tree, the unicast routing table is created.

In MOSPF, a new type of link state advertisement, group-membership-link-state advertisement, is added to OSPF. The locations of all multicast group members are identified in a topological database. The path of a multicast packet can then be calculated by building a shortest path tree rooted at the source. All branches not containing any multicast members are pruned from the tree during the calculation. The pruned shortest-path tree from a source of a group is first computed at a router when it receives the first multicast packet (i.e., on demand). The results of the shortest path calculation are then cached for subsequent multicast packets of the same source and group. Through this process, the router knows its upstream interface at which a multicast packet from the group source should arrive, and its downstream interfaces to which it should forward the packet towards the group members. Though MOSPF eliminates the broadcast overhead in DVMRP and PIM-DM, it still does not scale well due to the periodic flooding of link-state information among the routers.

In shared tree protocols, only one multicast tree is shared by all different sources of a particular group. The root of the tree is usually a router within a topological central area. Core Based Tree (CBT) and Protocol Independent Multicast Sparse Mode (PIM-SM) belong to this category.

Unlike DVMRP, PIM-DM or MOSPF, which constructs the shortest-path tree for each (source, group) pair, the CBT protocol constructs a single multicast tree that is shared by all sources of a group. The shared tree approach offers an improvement in scalability over the source-based tree approach by a factor of the number of active sources in the group. For applications with many active senders, such as distributed interactive simulation and audio/video conferencing, the shared tree solutions appear to be more appropriate.

In CBT, a router called the core is chosen and its address is advertised to all local routers running the IGMP. The local routers that have a group member invoke the tree joining process by generating a join message for the group and sending it to the next hop router towards the core router. This join message must be explicitly acknowledged either by the core router itself, or by another router on the unicast path between the sending router and the core which has joined the shared multicast tree. During the joining process, the involved routers create the forwarding cache which contains the downstream interfaces and upstream interface for the group. In this way, the shared multicast tree for the group is formed rooted at the core router. A source sends multicast packets to the core router and the core router then disseminates the multicast packets on the shared multicast tree.

When the local on-tree router finds that all the local members leave the group, it sends a prune message on the upstream interface for the group towards the core router. Upon receiving the prune message, the upstream router deletes the downstream interface on which the prune message arrives from the group's forwarding cache entry. Because CBT produces the shortest paths only between the core and local routers but not between the source and receivers, it cannot provide an optimal routing. Higher delay may be the result of using the shared tree. This is a disadvantage over the source-based tree mechanisms.

Similar to the CBT protocol, PIM-SM constructs a shared multicast tree rooted at a router called a rendezvous point (RP). This rendezvous point plays the same role as the core in the CBT protocol. However, PIM-SM is a more flexible protocol than CBT. While multicast trees in CBT are always group-shared trees, an individual receiver in PIM-SM may choose to construct either a group-shared tree or a source-based shortest-path tree. With these flexible operations, PIM-SM eliminates the disadvantages of CBT and source-based protocols (e.g., DVMRP, PIM-DM and MOSPF). However the complexity would be more required than that of CBT.

The PIM-SM protocol initially constructs a shared multicast tree to support a multicast group. Similar to the CBT protocol, a multicast tree rooted at the RP is formed by the receivers of a group and the sources send the multicast packets to the RP through unicast tunnels. After the tree is constructed, a receiver (actually the router associated with the receiver) can choose to change its connection to a particular source through the use of a shortest path tree. This may happen, for example, when the packet rate is higher than a threshold. This is accomplished by having the router send a join message to the source (not to the RP). Once the shortest path from the source to the receiver is created, the extraneous branches of the shared tree from the RP are pruned. The shortest paths from the source to the particular receivers and the shared multicast tree from the RP to the rest of receivers coexist in PIM-SM.

The shared tree is relatively easy to construct and it reduces the amount of state information that must be stored in the routers, compared to the source-based tree. It also conserves more network resources if the multicast group consists of a large number of sources. However, the shared tree causes a concentration of traffic around the core or the rendezvous point. This phenomenon can result in performance degradation if there is a large volume of multicast traffic. Another disadvantage of the shared tree is that multicast traffic does not often traverse the shortest path from a source to a destination, which is always formed in the source-based tree protocols. If low latency is a critical application requirement, it would be preferable to route the traffic along the shortest path. PIM-SM possesses all the advantages but eliminates the disadvantages from both the shared and source-based trees, with increased protocol complexity.

The multicasting schemes that use source-based trees suffer from drawbacks associated with the overhead due to broadcast of packets in the initial tree setup process, extensive router memory requirement for maintaining the on/off states, and bandwidth consumption due to unnecessary packet delivery. On the other hand, the shared-tree schemes encounter more delay due to non-optimal routing, bottleneck at a core or RP router, and poor paths due to inefficient positioning of the core or RP routers. The impact of these problems can be significant or moderate depending on whether the receivers are densely or sparsely populated. For instance, the problems caused by the source-based trees may not be significant for densely distributed receivers. However, the problems caused by the shared trees would be significant in the same scenario. In reality, the receiver distribution of a multicast group may be unpredictable and dynamic in the Internet environment.

The explosive growth of wireless communications has attracted interest in the integration of wireless networks with the Internet. Wide area wireless networks allow devices to be connected to the network while roaming freely from area to area. The goal is to achieve seamless communication for applications as hosts move, without disruptions, while preserving the current routing and addressing mechanisms. This can be achieved by extending IP to transparently handle mobile hosts that attach themselves to various network access points, hiding mobility form the transport services. In order to support host mobility in IP multicast, the most of proposed approaches combine the concepts of Mobile IP with the current IP multicasting schemes described above.

The goal of mobile IP is to allow a mobile host (MH) to change its points of attachment to the network without losing connectivity at the transport layer. Mobile IP provides a mechanism to a MH to retain one permanent IP address, called its home address, from its home network (its original subnet) and one temporal IP address, called a care-of address, from a foreign network (other than its home network). A MH has only its home address while being in its home network, while, it has both its home address and a care-of address when visiting networks other than its home network.

IP datagram packets are delivered to their destinations via a series of IP routers. When receiving a packet, a router examines the network part of its IP destination address. An IP address consists of a network and host part. If the network part indicates that the destination host is local, the packet can be directly delivered to the host indicated by the host part of its destination IP address, since each router has detailed knowledge of its attached networks and routing information as well. The routing information contains the IP addresses of all the reachable IP routers and corresponding distance metrics. However, if the host is not local, the router forwards the packet toward the destination network. Thus, each router can track destination hosts via their network part addresses.

The problem of delivering an IP datagram packet to a mobile host visiting a foreign network is incurred in the course of the routing process. According to the function of IP routers, the packet is always forwarded to the MH's home network. The MH never gets the packet while being in a foreign network.

Mobile IP introduces a new function on routers to resolve that problem: the router with this function, called home agent (“HA”) or foreign agent (“FA”) (if located in a home or foreign network). These are two end points of the bridge between a home and foreign network. In Mobile IP, the packet is first forwarded to the mobile host's home agent located within the mobile host's home network. After receiving the datagram, the home agent sends the datagram to the foreign agent of the mobile host, since the home agent keeps track of locations of its mobile hosts and thus knows the corresponding foreign agent. Finally the foreign agent forwards the datagram to the mobile host. The path from the sender to the MH in the foreign network is not shortest path. This becomes the major issue in mobile IP, called “triangle routing”.

All the proposed works on supporting host mobility in IP multicasting are based upon mobile IP. The details in operational specifications have not been addressed up to date. The basic idea to support host mobility is that two additional operations assisted by the mobile IP are added to the current IP multicast schemes providing the ability to multicast from mobile hosts and to receive multicasts on mobile hosts.

DVMRP and MOSPF depend on the underlying unicasting protocols, and the multicast routing relies on the IP address of a multicast sender: a multicast tree is generated from a sender which is the root of the tree. In the course of generating a multicast tree, when a router receives a multicast packet, it uses the network part of sender's IP address as a key parameter to determine the outgoing interfaces for the packet. If a mobile sender moves to a foreign network while engaging a multicast session, the multicast packets from the foreign network will arrive on many routers via unexpected links or will not reach to the expected routers (because routers determine the multicast links based upon the network part of the sender's IP address, not of the IP address of the foreign agent), which results in that some destinations are not reached. Thus, DVMRP and MOSPF with Mobile IP need some techniques to overcome these undesired situations.

One simple approach is to use the foreign agent's address as the sender. This approach keeps the optimal routing, but it causes the replies from the receivers to the foreign agent, not mobile sender. The other approach is to make a path between the home agent and the foreign agent. In this approach, the foreign agent first sends the multicast packet to the home agent through tunneling (encapsulating the multicast packet into a unicasting packet). After receiving the encapsulated packet and then decapsulating the packet back to the multicast packet, the home agent sends out the multicast packet just as the packet is sent out from the home network. This approach manifests the triangle routing as issued in Mobile IP. However, CBT and PIM-SM do not face the undesired routing because multicast packets in these schemes are routed based only on their destinations.

There are two main approaches to route multicast packets to mobile receivers: home agent routing and foreign agent routing. In home agent routing, the home agent handles multicast routing by executing IGMP and delivering multicasts to the MH (receivers) as if it were a home network. Packet delivery is achieved by tunneling via the foreign agent, while membership reports from the MH can be unicast to the home agent. Because the home agent and the mobile host communicate via virtual point-to-point links, MH dependent information must be kept in the home agent, and also IGMP operation should be modified to keep track of the MH. This approach can't provides the shortest path to the MH because the multicast packets always pass via the HA which may not be located on the shortest path.

If the foreign agent is willing to support multicasting for any MH (remote and local MH in reference to this FA), then current IP multicasting models can be directly used with treating the foreign agent as an IGMP router. In this approach, multicast packets for a MH (a multicast receiver) are routed by the corresponding foreign agent to which the MH belongs. Since the multicast packets are routed from the sender directly to the FA, not via the HA, and then the FA directly delivers them to the MH, this approach always provides the shortest path between the sender to the MH. The only drawback is that the local network owner may not want to provide multicast service to visiting MHs.

The main drawback for the schemes of extended IP multicasting with Mobile IP is that they totally depend on the Mobile IP. This causes problems in implementation because the source codes of both two separated IP multicasting and Mobile IP protocols should be modified for the multicasting protocol to associate with the Mobile IP protocol. Every time one of the protocols needs to be upgraded, the software implementation for the both protocols should be modified. It seems that a new design of IP multicasting protocol that can support mobility and operate without any help of the Mobile IP or other mobility management protocol for unicast is necessary.

In addition to such shortcomings of existing IP multicasting schemes, they have no provision for host and network mobility because the schemes have been derived in the basis of fixed IP network environments. Recently, some ideas for supporting host mobility have been proposed. The basic idea is to extend the current IP multicasting schemes to adapt to mobile environments with the help of Mobile IP. Mobile IP allows a mobile host (MH) to change its points of attachment to the network without losing connectivity at the IP transport layer. Mobile IP provides a mechanism to an MH to retain one permanent IP address, called its home address, from its home network (its original subnet) and one temporal IP address, called a care-of address, from a foreign network (other than its home network). However this extending approach can not completely handle the mobility problems incurred by the movements of multicasting senders or receivers; in case of the source-based scheme, the shortest path between a sender and receivers generated in the stationary network won't be preserved once the sender moves away. Also, because the use of mobile IP is necessary for this approach to work, the extended multicasting scheme is not robust by itself. Furthermore, to date, the network mobility issue has not even been addressed at all. Thus, it is desired to have an IP multicasting scheme that can support both host and network mobility.

For these reasons, DVMRP does not scale well to support multicast groups that are sparsely populated over a large network. It is desirable to have a new IP multicasting protocol which can avoid the shortcomings from each of the source-based and shared trees, so that the new protocol can provide a shared tree which can produce shortest paths from a multicast sender to receivers.

### SUMMARY

A method of multicasting data packets in an IP network called “Hierarchical Level-based IP Multicasting (HLIM)” is described. HLIM overcomes the shortcomings from the conventional IP multicasting schemes and also support both host and network mobility. In HLIM a hierarchical levels is assigned to each IP router, and a scope is defined for each of those levels. Scope information is placed into a multicast address. HLIM provides a new concept of multicast scope in a way that multicast sessions flexible to hierarchical network environment such as the tactical network can be generated, which is not the case in the current multicasting protocols using the conventional scope controlled by the IP TTL. Along with such flexible scope concept, the HLIM can avoid the center point (e.g., core router in the share tree scheme) and hence eliminates the multicast traffic concentration on a particular link.

Although HLIM is naturally oriented to operate in hierarchical networks, it can be also applied to flat networks by emulating the networks into organized hierarchical networks through mechanisms such as the Private Network-to-Network Interface (PNNI) protocol used in ATM or MMWN (an acronym for multimedia support for mobile wireless networks). Thus, HLIM can be implemented as long as the network nodes are connected in a hierarchy, physically or virtually.

The HLIM protocol provides optimal and efficient IP multicasting in hierarchical networks such as Tactical IP Networks (“TIN”) by taking advantage of the hierarchical structure and broadcast nature of such networks. HLIM demonstrates the benefits of both a source-based algorithm (providing the shortest multicasting paths) and a shared tree algorithm (providing one shared tree per group for efficient utilization of network resources). In addition to that, the proprietary scope concept of HLIM provides the control on multicast traffics over the network.

In HLIM a hierarchical level is assigned to each IP router and scope regions bounded by two hierarchical level indicators (one for the highest level and the other for the lowest level that a multicast packet for a group can reach) are created. The scope regions are uniquely identified by a root identifier (RID). Information on the scope region is part of the multicast group address and multicast packets are forwarded to the scope region assigned in the packets.

Each multicast packet carries its own scope region information that indicates how far it should traverse, and each IP router determines whether or not it should discard a multicast packet received by comparing its own level with the scope region specified in the packet. In addition to the packet forwarding, HLIM includes mechanisms to establish a multicast tree for a multicast session, to maintain such a tree dynamically, and for autoconfiguration. Both host and network mobility is addressed by the HLIM protocol.

Each router has its own hierarchical level. If there are a total of N hierarchical levels in the whole network, then routers at the highest level are assigned to level N and routers at the lowest level are labeled as level 1. For instant, each HLIM router (a router which implements the HLIM protocol) and HDR (a HLIM router which is designated to handle multicast traffic between different subnets) should be assigned with a level between 1 to 4 as follows: a HLIM router (1) & HDR (1) is assigned at the lowest level, HLIM router (2) & HDR (2) for the next highest level, HLIM router (3) & HDR (3) for the next highest level, and HLIM router (4) & HDR (4) for the highest level. These levels can be automatically configured, and expanded if necessary

A scope region is uniquely defined by a scope field comprised of two hierarchical levels (one setting the upper boundary and the other setting the lower boundary for a multicast packet generated within the region) and the identity of the root of the region, called “Root ID” (RID) (i.e., the HDR at the level right above the region). The RID will be null if the highest level of the region is equal to the highest level in the whole network

The notation SR(L,H), where L is the lowest level and H is the highest level of a scope region, is used to label a scope region in the figures. Note that the root ID of a region is omitted and only one hop is shown between the HDRs at adjacent levels for simplicity. In the HMN, the scope field (1,4) represents the largest scope region and includes the whole HMN, and a scope field (1,1), (2,2), (3,3) or (4,4) defines the smallest region.

Thus the present invention provides for a method of multicasting data packets from a source to a plurality of routers and associated hosts wherein each router has been assigned a hierarchical level and the routing information in each multicasting data packet contains information regarding the scope region of levels to which the data packet should be routed.

### BRIEF DESCRIPTION OF THE DRAWINGS

FIG. 1 depicts a hierarchical mobile network in accordance with the present invention;

FIG. 2 depicts a core IP subnet with local subnets attached in a hierarchical mobile network in accordance with the present invention;

FIG. 3 depicts three possible interfaces in hierarchical IP subnets in accordance with the present invention;

FIG. 4 depicts a hierarchical mobile network with assigned hierarchical designated routers in accordance with the present invention;

FIG. 5 depicts another example of a hierarchical mobile network with assigned hierarchical designated routers in accordance with the present invention;

FIG. 6 depicts scope regions in a hierarchical mobile network in accordance with the present invention;

FIG. 7 depicts two identical scope regions in different portions of a hierarchical mobile network in accordance with the present invention;

FIG. 8 depicts HLIM scope regions in a hierarchical mobile network in accordance with the present invention;

FIG. 9 depicts an embodiment of a HLIM multicast address for use in a hierarchical mobile network in accordance with the present invention;

FIG. 10 depicts an example of a HLIM receiver join operation in accordance with the present invention;

FIG. 11 depicts an example of multicast forwarding using the present invention;

FIG. 12 depicts examples of binding points in a hierarchical mobile network in accordance with the present invention;

FIG. 13 depicts three possible movements for mobile hosts in a hierarchical mobile network in accordance with the present invention;

FIG. 14 depicts join operations for a mobile host after movement in a hierarchical mobile network in accordance with the present invention;

FIG. 15 depicts an example of multicast forwarding for mobile sources and receivers in a hierarchical mobile network in accordance with the present invention;

FIG. 16 depicts movement of a mobile network within a scope region in a hierarchical mobile network in accordance with the present invention;

FIG. 17 depicts movement of a mobile network outside a scope region in a hierarchical mobile network in accordance with the present invention;

FIG. 18 depicts movement of a mobile network to inside of a scope region in a hierarchical mobile network in accordance with the present invention;

FIG. 19 depicts movement of a mobile network within the area outside a scope region in a hierarchical mobile network in accordance with the present invention;

FIG. 20 depicts movement of a mobile network containing a BPT/RID region in a hierarchical mobile network in accordance with the present invention;

FIGS. 21a-c depict three possible unmatched attachments incurred by network mobility in a hierarchical mobile network in accordance with the present invention;

FIG. 22 depicts a multicast tree before movement of a mobile network in accordance with the present invention;

FIG. 23 depicts a HLIM_Net_Join(R) operation after movement of a mobile network in accordance with the present invention;

FIG. 24 depicts the resultant multicast tree after the movement of the mobile network and the HLIM_Net_Join(R) operation;

FIG. 25 depicts the message flows in a HLIM_Net_Join(R) operation in a hierarchical mobile network in accordance with the present invention;

FIG. 26 depicts an example of a HLIM_Net_Join(S) operation before movement of a mobile network;

FIG. 27 depicts an example of a HLIM_Net_Join(S) operation after movement of a mobile network;

FIG. 28 depicts the message flows in a HLIM_Net_Join(S) operation in a hierarchical mobile network in accordance with the present invention;

FIG. 29 depicts the resultant multicast tree after the HLIM_Net_Join(S) operation for the example depicted in FIG. 27

FIG. 30 depicts the message flow in a reliable regular join to GA(L,H,RID,APL_ID) for a mobile host at level i.

FIG. 31 depicts the message flow for reliable mobile join operations.

FIG. 32 depicts a first example of a source prune operation in a hierarchical mobile network in accordance with the present invention;

FIG. 33 depicts a second example of a source prune operation in a hierarchical mobile network in accordance with the present invention;

FIG. 34 depicts the prune messages and timers in time sequence at a router in a hierarchical mobile network in accordance with the present invention;

FIG. 35 depicts a receiver prune operation in a hierarchical mobile network in accordance with the present invention;

FIG. 36 depicts a format for the HLIM Group Address in accordance with the present invention;

FIG. 37 depicts a format for the HLIM Group Address in IP header of an HLIM multicast data packet in accordance with the present invention;

FIG. 38 depicts a format for an IGMP header in accordance with the present invention;

FIG. 39 depicts a format for the IP header for IGMP messages in accordance with the present invention;

FIG. 40 depicts a format for the IGMP_RID_Request message in accordance with the present invention;

FIG. 41 depicts a format for the IGMP_RID_Reply message in accordance with the present invention;

FIG. 42 depicts a format for the IGMP_Query message in accordance with the present invention;

FIG. 43 depicts a format for the IGMP_Specific Query, IGMP_Leave, IGMP_Report, IGMP_M_Report, and IGMP_M_Reply mesages in accordance with the present invention;

FIG. 44 depicts a format for the IGMP_Hello message in accordance with the present invention;

FIG. 45 depicts a format for the IGMP_Flush message in accordance with the present invention;

FIG. 46 depicts a format for the IP header for HLIM messages and HLIM header in accordance with the present invention;

FIG. 47 depicts a format for the HLIM_Join, HLIM_ACK, HLIM_M_ACK, HLIM_Prune, HLIM_Prune Reply, HLIM_M_Prune_Reply, HLIM_M_Prune and HLIM_Prune_Reply messages in accordance with the present invention;

FIG. 48 depicts a format for the HLIM_M_Join message in accordance with the present invention;

FIG. 49 depicts a format for the HLIM_HDR_List_Update message in accordance with the present invention;

FIG. 50 depicts a format for the HLIM_HDR_List_Solicit message in accordance with the present invention;

FIG. 51 depicts a format for the HLIM_P_Hello message in accordance with the present invention;

FIG. 52 depicts a format for the HLIM_C_Hello message in accordance with the present invention;

FIG. 53 depicts a format for the HLIM_Net_Join message in accordance with the present invention;

FIG. 54 depicts a format for the HLIM_Net_Join_ACK message in accordance with the present invention;

FIG. 55 depicts a format for the HLIM_Flush message in accordance with the present invention;

FIG. 56 depicts a format for the HLIM_Conf_Hello message in accordance with the present invention;

FIG. 57 depicts a format for the various HLIM_Compare messages in accordance with the present invention;

FIG. 58 depicts a hierarchical network software architecture in accordance with the present invention;

FIG. 59 depicts a local multicasting module in a hierarchical network in accordance with the present invention;

FIG. 60 depicts the flow of a multicasting packet at a host in a hierarchical network in accordance with the present invention;

FIG. 61 depicts the control paths between modules in an embodiment of the HLIM architecture in accordance with the present invention;

FIG. 62 depicts the high-level data paths between modules in an embodiment of the HLIM architecture in accordance with the present invention;

FIG. 63 depicts the control routine in the local multicasting module in an embodiment of the HLIM architecture in accordance with the present invention;

FIG. 64 depicts the data paths between the local multicasting module and the global multicasting module in an embodiment of the HLIM architecture in accordance with the present invention;

FIG. 65 depicts the multicast components in an embodiment of a hierarchical designated router in accordance with the present invention;

FIG. 66 depicts the control paths between a plurality of global multicasting modules in an embodiment of the HLIM architecture in accordance with the present invention; and,

FIG. 67 depicts the data paths between a plurality of global multicasting modules in an embodiment of the HLIM architecture in accordance with the present invention.

### DETAILED DESCRIPTION

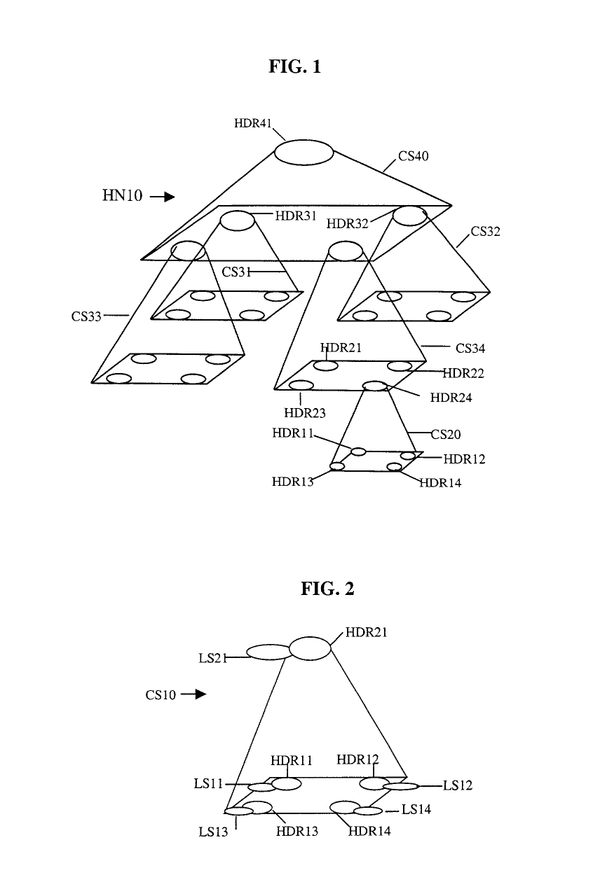

The IP multicasting model of the present invention is applicable to hierarchical networks, particularly hierarchical mobile networks (“HMN”), and more particularly tactical IP network (TIN), in which routers (or switches) are hierarchically connected generally as shown in FIG. 1. In a hierarchical network HN10 a hierarchical designated router (or switch) such as router HDR41 at level N at one level (level 4 in FIG. 1) is connected to a plurality of routers at another level such as level 3 where the routers are denoted in FIG. 1 as HDR31, HDR32, HDR33 and HDR34. Such a direct interconnection between one higher-level and multiple lower-level routers constitutes a core subnet CS40. The HMN can therefore be pictured as an integration of such core subnets CS40, CS31, CS32, CS33, CS34, CS20 in the form of a hierarchy. Except for the highest level router, i.e., HDR41, each router in the hierarchy is associated with two sub-nets: one comprised of a higher-level router-level router and a number of same-level routers, and another comprised of a number of lower-level routers (except for the lowest-level routers).

One example of a hierarchical network would be to have router HDR41 be a router on the backbone portion of the network with hierarchical designated routers HDR31, HDR32, HDR33 and HDR34, being associated with primary internet service providers, and routers HDR21, HDR22, HDR23, and HDR24 being associated with secondary internet service provides. Routers at the lowest level are always at level 1 (HDR11, HDR12, HDR13, HDR14) would comprise routers attached to the secondary internet service providers.

FIG. 2 illustrates a core sub-net CS10 with local sub-nets attached at each router. The router HDR21 having a local subnet LS21 attached thereto at the upper level (N=2 in this example) is connected to four routers HDR11-HDR14 at lower level 2. Attached to each lower level router is a local subnet LS11-LS4L1 respectively. In each subnet (core or local) some wireless multiple access technology with broadcast/multicast capabilities (e.g., wireless LAN) is used to interconnect the IP hosts and/or routers. By issuing a single transmission, one node can deliver its message to all other nodes, and every node can hear what every other node has sent. For example when HDR11 in FIG. 2 sends a message to HDR21, not only HDR21 but also HDR12, HDR13 and HDR14 hear the message. Such capabilities are assumed in the present invention. If some wireless non-broadcast multiple access technology (e.g., TDMA or CDMA) is used instead, emulation for the broadcast/multicast capabilities may be required.

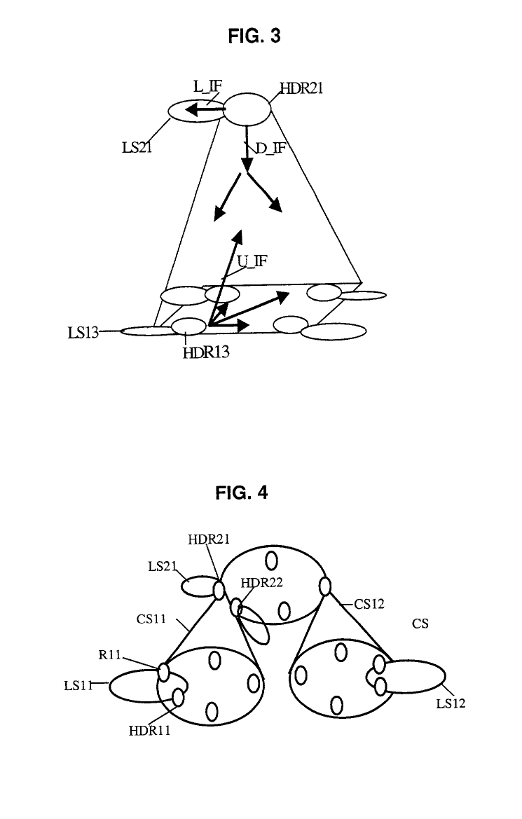

In a hierarchical network, each IP router (except those located at the lowest level) has three interfaces: local interface (L_IF), down interface (D_IF), and up interface (U_IF). Routers at the lowest level have only the L_IF and U_IF since there are no IP routers below them. An IP router uses its L_IF to exchange traffic between with its local subnet “ls”, and the D_IF to communicate with its descendant (child) routers located at the next lower level. Through its U_IF, the router communicates with not only its ascendant (parent) IP router at the next higher level but also the neighboring routers at that next higher level. FIG. 3 shows the three different interfaces for routers HDR21 and HDR13. These three interfaces can be also referred to as an incoming interface (Inc_IF) or outgoing interface (Outg_IF) according to the direction of the packets flowing through the interfaces. For example, if a packet is coming from the L_IF and outgoing through the D_IF, then the L_IF is referred to as an Inc_IF, and the D_IF are referred to as an Outg_IF.

Though only one router is shown in a local sub-net (or at the higher level in a core subnet) in FIGS. 2 and 3, it is possible to have more than one IP router to handle IP traffic between the local subnet and the ascendant/descendant routers. In unicast, this would not produce any duplicate messages because one preferred IP router among them is selected by the unicast routing protocol. However in multicasting, if a designated IP router is not assigned in advance, unnecessary duplicate multicast traffic may result. To avoid this situation, a hierarchical designated router (“HDR”) is selected that handles multicast traffic between its local subnet and its ascendant/descendant routers. The other non-HDR routers within a subnet ignore any multicast control or data packets received. This concept is illustrated in FIG. 4. In FIG. 4, there are two multicast routers R11 and HDR11 in the local subnet LS11 at the lowest level 1, through which the hosts in the local subnet can send/receive packets to/from the rest of the network. One of the routers HDR11 will be elected to be the local HDR (“LHDR”) to handle multicasting for the local subnet LS11. Similarly, in the core subnet CS11, there are two multicast routers HDR21 and HDR22 at that upper level 2, through which the routers at level 2 can send/receive packets to/from the higher level. One of the routers HDR22 will be elected to be the global HDR (“GHDR”) to handle multicasting between the levels in the core subnet CS11. The two routers in the local subnet LS21 may be on the same descendant subnet or separate descendant subnets. If they are on the same descendant subnet, the elected HDR for the local subnet should also serve the descendant subnet. If they are on separate descendant subnets, both routers should be the HDRs for their own descendant subnets. Both routers at level 1 in the core subnet CS11 may be elected to be the LHDRs of their own local subnets. Other non-HDR routers may serve as backups for the elected HDRs, in case that a HDR moves away, has a malfunction, or is destroyed.

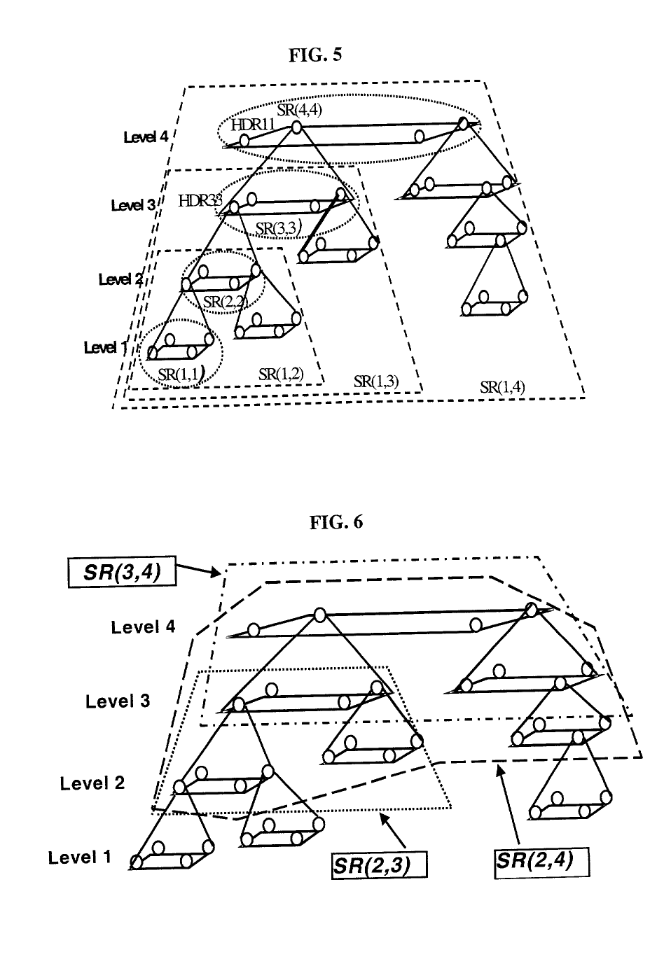

An HMN can be viewed as a hierarchical network interconnected with four levels (N=4) of HDRs as shown in FIG. 5. Router HDR41 is an HDR at level 4 (i.e., top level) generically referred to as HDR(4), HDR(3) denotes an HDR such as HDR33 at the next level down from level 4 and so on.

Though only one hop is shown between the HDRs at adjacent levels in FIG. 5, there may be more than one hop within each hierarchical level. In order words, an HDR at a level may reach its immediate upper or lower level through several hops. For example, some routers at level 2 may be close to a router in the top level but some may be far away. The packets from the “far-way” routers may need to be routed through the “close-by” second level routers to the top level. Our design for the hierarchical levels provides such flexibility that the hierarchical levels do not necessarily tie to the “physical levels” due to the network topology.

In the hierarchical mobile network, all hosts (receivers or sources) and routers are mobile. A host can move to anywhere in the network. The host attached to a HDR(k), where k denotes any level (0<k≦N) can move not only to any other HDR(k) but also to HDRs at levels other than k. A router, however, is allowed to move only within the same level. It can move alone, with its local subnet only or with its whole descendant sub-networks (including its local subnet). Though the hosts within a moving network also move physically, they do not need to invoke any mobility management treatment since they remain “stationary” with respect to their serving router.

In order to provide an optimal (at most) and efficient IP multicasting in such network environments, the present invention is to take advantage of the hierarchical structure and broadcast nature of the hierarchical mobile networks so that it can provide the flexible way of generating multicast sessions with variety of multicast scope in accordance with the hierarchical network environment.

HLIM assigns a hierarchical level for each IP router, to create scope regions bounded by two hierarchical level indicators or fields (one for the highest level and the other for the lowest level that a multicast packet for a group can reach), and uniquely identified by a root identification (RID), to include this scope information in a multicast group address and to forward multicast packets according to the scope assigned in the packets.

Each multicast packet carries its own scope information that indicates how far it should traverse, and each IP router determines whether or not it should discard a multicast packet received by comparing its own level with the scope levels specified in the packet. In addition to the packet forwarding, HLIM includes mechanisms to establish a multicast tree for a multicast session, to maintain such a tree dynamically, and for autoconfiguration. Both host and network mobility is addressed by the HLIM protocol.

Each router has its own hierarchical level. If there are a total of N hierarchical levels in the whole network, then routers at the highest level are assigned to level N and routers at the lowest level are labeled as level 1. For instance, each HLIM router (a router which implements the HLIM protocol) and a hierarchical designated router “HDR” (a HLIM router which is designated to handle multicast traffic between different subnets) should be assigned with a level between 1 to 4 as follows: a HLIM router (1) & HDR (1) is assigned at the bottom level, HLIM router (2) & HDR (2) for the next level up, HLIM router (3) & HDR (3) for the next level up, and HLIM router (4) & HDR (4) for top level. These levels can be automatically configured, and expanded if necessary.

A scope region is uniquely defined by a scope field comprised of two hierarchical levels (one setting the upper boundary and the other setting the lower boundary for a multicast packet generated within the region) and the identity of the root of the region, called root identifier, “Root ID” or “RID” (i.e., the HDR at the level right above the region). The RID will be null if the highest level of the region is equal to the highest level in the whole network. FIGS. 5 and 6 shows some possible scope regions in a HMN. The notation SR(L,H), where L is the lowest level and H is the highest level of a scope region, is used to label a scope region in the figures. Note that the root ID of a region is omitted and only one hop is shown between the HDRs at adjacent levels in the figures for simplicity. In the HMN of FIGS. 5 and 6, the scope region SR (1,4) represents the largest scope region and includes the whole HMN, and a scope region SR (1,1), SR (2,2),SR (3,3) or SR (4,4) define the smallest regions.

Multicast packets generated within a scope region will not go beyond the region (except for mobile cases when the on-going multicast sessions of a mobile host need to be maintained after movement). For example, a multicast packet associated with SR(2,3) under a level-4 HDR is not allowed to go beyond the HDRs at level 3 and below the HDRs at level 2 under that level-4 HDR. A scope region is also defined in a way that a multicast packet from any host within a scope region can be delivered to any other host within the same region, without traversing beyond the region. As a result, the multicast traffic can be limited to the intended parties only

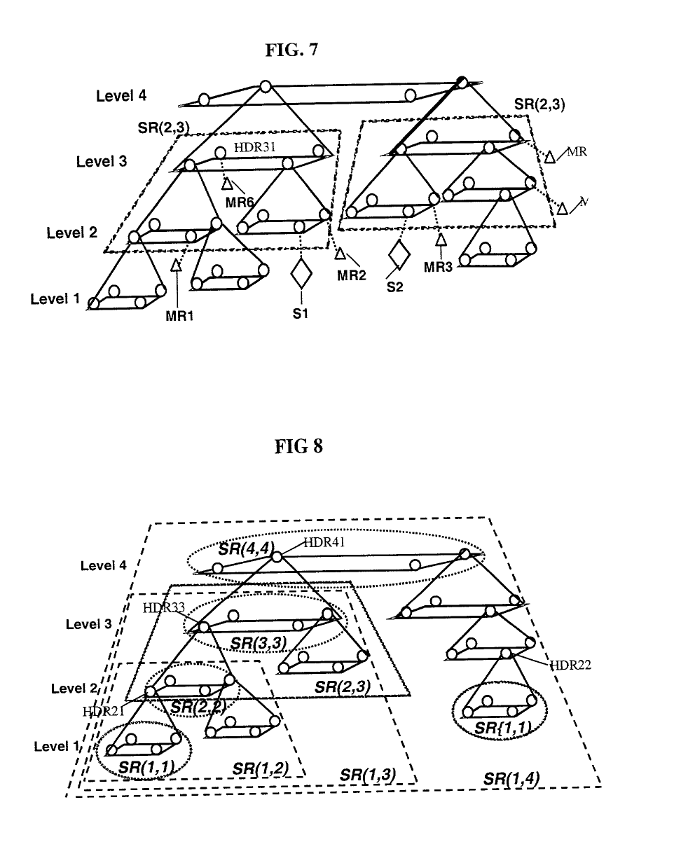

If the hosts and routers never move, the RID of a scope region is not necessary. Even though two regions use the same scope field and the same group address which represents an specific multicast application at this time, the packets flowing within one region will not interfere with those in the other, as long as the hosts and routers remain in their original scope regions. This is because the regions bounded by the same scope field do not overlap with one another. This concept is illustrated by an example shown in FIG. 7. This example assumes a multicast service delivering local data specific to a scope region. Such service can be identified by the same multicast application identifier (APL_ID) in any region. For example the pay-per-view video service for “Movie 1” in the left SR(2,3) and “Movie 2” in the right SR(2,3) can be assigned by the same APL_ID of ‘1234’. A server S1 or S2 delivering data specific to its local SR(2,3) region can use a multicast address carrying the scope field, SR(2,3) and APL_ID, 1234 (denote as G(2,3,1234)) to send the packets without carrying the RID of the scope region. The data (i.e., multicast data with the destination multicast address of G(2,3,1234)) from a server in a SR(2,3) region will not interfere with that from a server in another SR(2,3) region because the packets are bounded by the scope field and will not go beyond the region. In other words, the receivers in the left SR(2,3) can watch “Movie 1” but not “Movie 2” and visa versa for the right region. If a viewer of Movie 1 moves to the right region and wants to continue watching the Movie 1, the multicast address causes the conflict between the two different video services. The viewer cannot continue watching the Movie 1 because it is not provided in the new region. Instead the viewer can watch Movie 2 with the multicast address which represents the “Movie 2” within that region.

Thus, for a fixed network environment where the viewers are all stationary, no traffic conflict occurs. However, in a mobile environment, the problem of multicast address ambiguity may arise if a mobile host (source or receiver) moves (alone or with a network) from one scope region to another represented by the same scope field and is willing to continue the multicast sessions with its original scope region. For example in FIG. 7 a mobile receiver MR1 or MR2 in the left SR(2,3) scope region moves to the right SR(2,3) region but still wants to continue receiving the data specific to the left SR(2,3) region (e.g., it is in the middle of a file distribution from the server in the left SR(2,3) region and wants to complete it). Our mobility design allows the receiver to do so and the packets in the left SR(2,3) region will be forwarded to the receiver's new location in the right SR(2,3) region. If the packet forwarding is not performed properly, the packets forwarded from the left SR(2,3) region may interfere with those generated locally in the right SR(2,3) region. Additional information is required to identify the left and right SR(2,3) regions differently in order to support such “handover” of on-going multicast sessions. As a result, the RID identifies a region in the multicast “address” carried in each multicast packet. The multicast “address” here does not refer to the standard class D_IP multicast address, but the complete addressing information given by the scope field, RID, and Application ID.

A scope region cannot be uniquely identified with only the scope field, (L,H), but is uniquely identified by using both the scope field and RID. For example, the two scope regions of a same scope field, (1,1), on left and right shown in FIG. 8 are distinguished by different RIDs. The RID for a given scope region can be represented by the root HDR of scope region which is located right above the scope region. Thus router HDR41 is the RID for scope regions SR(3,3), SR(1,3) and SR(2,3). Router HDR33 is the RID for SR(2,2) and SR(1,2). Router HDR21 is the RID for SR(1,1) on the left and the router HDR22 is the RID for SR(1,1) on the right.

Every HDR maintains a list of IP addresses (or hierarchical unique IDs) of ascendant HDRs through the update function of the HLIM protocol, which will be described later. For instance, a HDR at level 2 keeps the IP addresses of its ascendant HDRs, HDR(3) and HDR(4). Such a list is used to identify the RID for a SR(L,H) and handle host and network mobility.

In HLIM, a multicast packet and control packet carrying a group address has the scope information, SR(L,H) and RID, that indicates how far the packet should traverse, and which scope region it originally belong to. According to such scope information, an HDR can determine how to respond to packets incoming such as forwarding and discarding the packet, joining a multicast tree.

A standard IPv4 multicast address has 28 bits for APL_ID while a standard IPv6 multicast address has 4 bits for scope and 112 bits for APL_ID. The HLIM scope field directly into the IPv6 scope field without modifying the address format. The four bits of the scope field can be used for specifying the upper (H bits) and lower (L bits) hierarchical levels of our HLIM scope field, two bits for each level. Alternatively, the HLIM scope field may be introduced inside the APL_ID field or in an IP option of the IP header. The alternative scheme allows a longer HLIM scope field so that more levels can be supported. Besides, the HLIM scope field can work independently of and not interfere with the scope defined in the IPv6 standard. The alternative scheme can also be applied to IPv4 as there is no pre-defined scope field. However, the IP option seems to be more preferable because of the limited number of bits in the IPv4 address format. In any case, the HLIM scope will work independently of the TTL (Time To Live) field in the IP header.

The RID of a scope region can be the IP address of the root (i.e., the HDR right above the highest level of the region). In this case, the RID is too long to be carried inside the IPv6 or IPv4 address format. It should then be carried in an IP option of the IP header. Alternatively, shorter IDs can be assigned to the HDRs for this RID purpose. Such IDs may be assigned independently of the IP addresses of the HDRs. The IDs assigned to the HDRs within the same level should be unique to one another but the same ID can be assigned to the HDRs at different levels. However, this scheme requires more administration efforts. Another approach is to derive the shorter IDs from the IP addresses of the HDRs. For example, if the whole TIN is assigned the same IP address prefix, the address suffix can be used as a RID. In any case, the choice of the RID scheme will not affect the basic HLIM operations described later.

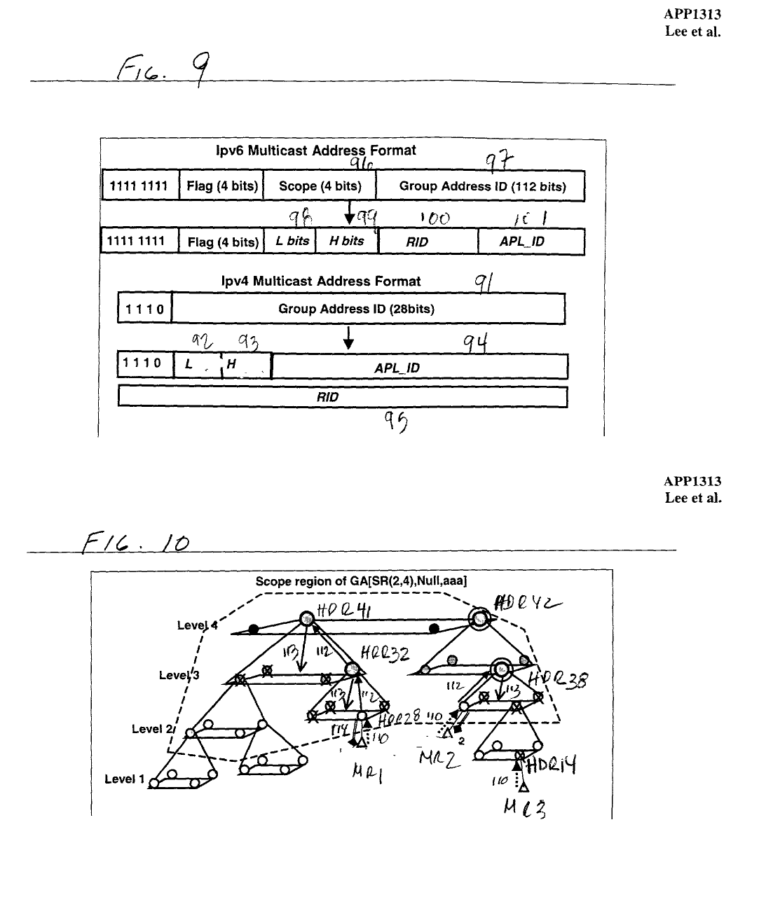

A complete HLIM group address is comprised of the scope boundary (SR(L,H)), the root ID (RID) of the scope region, and the application identifier (APL_ID) identifying a specific multicast application/service. It is denoted as G(L,H,RID,APL_ID) in this document. Any multicast packet will carry this complete HLIM group address and the routers will forward the packets only within the specified scope region. FIG. 9 shows possible HLIM multicast address formats for the present invention based on Ipv4 and Ipv6. In IPv4, the destination group address field 91 in the IP header is not long enough to carry all the necessary HLIM address information. The bits representing the lower boundary L of SR(L,H) can be placed in field 92 with the bits representing the upper boundary H can be placed in field 93. The APL_ID field 94 can be placed as the 28-bit group ID in an IP class D address, and the RID 95 can be defined to as an IP option in the IP header. In IPv6, the complete HLIM group address can be placed into the IPv6 destination address field using the unicast address prefix portion of the group address field 97 as the RID 100 and placing the APL_ID 101 thereafter. Scope bits 96 can be used for the L 98 and H 99 identifiers for SR(L,H).

The basic HLIM operations for fixed hosts and routers are the operations for a mobile host to start a new multicast session. To facilitate the explanation of the HLIM operations, it is to be assumed that a router that is an HDR is elected to be both a local HDR (L_HDR) and global HDR (G_HDR). Every HDR should keep a HDR list, which contains the IP addresses of its ascendant HDRs at all levels above it. For example a HDR(2) keeps the IP addresses of its ascendant HDRs, HDR(3) and HDR(4). The HDR list is updated through the HDR_List_Solicit and HDR_List_Update operations, which are described below. The HDR list is used by hosts and HDRs to obtains RIDs and to determine the appropriate HLIM operation when a mobile host and router moves to a new location and wants to maintain its on-going multicast sessions.

### LOCAL HOST JOINING A GROUP

New IGMP messages, such as IGMP_RID_Request, IGMP_RID_Reply, IGMP_M_Report, IGMP_M_Reply, IGMP_Hello and IGMP_Flush, are added into the current IGMP protocol to support the new features of IGMP in HLIM. Other existing IGMP messages are modified to carry the new multicast group address defined in HLIM and handle both multicast sources and receivers.

When a multicast application is started at a receiver host at level k, the host will obtain SR(L,H) and APL_ID of the multicast session being joined from the application. The application may obtain such information through some advertising mechanisms such as SAP (session announcement protocol), SDP (session description protocol), or web. Once the host obtains the SR(L,H) and APL_ID for the multicast session, it will join the multicast session by sending an IGMP_RID_Request to its parent HDR. Upon receiving the IGMP_RID_Request, the parent HDR invokes the HLIM regular receiver join operation. After the HDR completes the HLIM regular receiver join process, it sends an IGMP_RID_Reply with the RID of the scope region back to the host. When a multicast application is started at a source host, the same procedure is followed except that the host indicates it is a source instead of a receiver and the HDR invokes the HLIM source join operation instead of the receiver join operation. Similar to the existing IGMP, a HDR periodically issues an IGMP_Query message to its local sub-net, and the local hosts (sources and receivers) respond to the query by sending IGMP_Report. Note that the operations for establishing a multicast tree are now initiated by IGMP_RID_Request/IGMP_RID_Reply, instead of IGMP_Report. The detailed procedure is described below.

When a host at level k wants to start a multicast session, it first asks its parent HDR (HDR(k)) for the RID for the session by sending a IGMP_RID_Request[SR(L,H),APL_ID,R] if it is a receiver, or IGMP_RID_Request[SR(L,H),APL_ID,S] if it is a source, to its local subnet. Upon receiving a IGMP_RID_Request(R/S), the HDR(k) determines whether the requesting host is located at the right scope region or not. If L≦k≦H (i.e., the host is within the scope requested), the HDR(k) finds the RID from its HDR list and forms a complete HLIM multicast address, GA[SR(L,H),RID,APL_ID)], invokes the regular receiver or source join operation (HLIM_Join[GA,R/S] which will be discussed in the next subsection), and then replies to the host with an IGMP_RID_Reply[GA,R/S] once the join operation is completed.

Note that the regular join operation is initiated by IGMP_RID_Request(R/S), not by IGMP_Report as in the existing IGMP paradigm. In HLIM, IGMP_Report is used only for maintaining a local group membership.

If the host is outside the scope requested, the HDR(k) ignores the IGMP_RID_Request(R/S). Once the host gets an IGMP_RID_Reply[GA,R/S], it records the GA in its receiver or source GA list. When it receives an IGMP_Query later, it issues IGMP_Report[GA,R/S] in response to the IGMP_Query. If the host is a source, it sets up the host-forwarding cache for the GA after receiving the IGMP_RID_Reply[GA,S]. This cache is used to insert the RID as an IP option in the IP header of outgoing multicast packets and is transparent to the applications.

### ESTABLISHING THE HLIM MULTICAST TREE

Once the HDR(k) receives a valid IGMP_RID_Request from a multicast receiver or source (distinguished by the flag inside the message (i.e., S for source and R for receiver)), it sets up a transient forwarding cache which consists of a group address and the corresponding outgoing interface for the receiver or source (i.e., L_IF for receiver, U_IF for source). Once the cache is set, the HDR(k) sends a HLIM_Join[GA,R] message for receiver or HLIM_Join[GA,S] message for sender to its immediate parent HDR(k+1) and then waits for a HLIM_ACK[GA,R/S] message from it. The HLIM messages are multicast with IP TTL of 1. The detailed procedure is described below.

When a HDR(k) receives a valid IGMP_RID_Request(R/S) from a host, the HDR checks whether it is an on-tree HDR (i.e., with an existing receiver/source forwarding cache for the GA) or not. If it is an on-tree HDR, it just issues an IGMP_RID_Reply[GA,R/S] back to the host and no further operation is required. Otherwise, it initiates the regular join operation by sending HLIM_Join[GA,R] for a receiver, or HLIM_Join[GA,S] for a source, to its parent HDR (HDR(k+1)) via its U_IF.

When the HDR(k+1) receives a HLIM_Join[GA, R/S], it checks the following. If it is outside the scope region (k>H or k<L or RID≠HDR(H+1)) or the message is received from its U_IF (i.e., from a peer, not child, HDR), it ignores the message. Otherwise, if it is an on-tree HDR, it issues a HLIM_ACK[GA,R/S] back to its child HDR(k) via its D_IF. Otherwise, if it is located at the highest level of the scope region (i.e., k=H), it sets up a “confirmed” forwarding cache for the group and sends a HLIM_ACK[GA,R/S] back to its child HDR(k) via its D_IF. Otherwise, it sets up a “transient” forwarding cache for the group and relays the HLIM_Join[GA,R/S] to its parent HDR (HDR(k+2)) via its U_IF.

The HDR(k+2) repeats the last step. Eventually, the HLIM_Join[GA,R/S] message reaches an on-tree HDR or the highest HDR for the GA, and then a HLIM_ACK[GA,R/S] is returned.

When a HDR receives a HLIM_ACK[GA,R/S] message, it will check the following. If it has a “transient” forwarding cache for the GA specified in the HLIM_ACK[GA,R/S] message and receives the message from the U_IF, it switches the “transient” forwarding cache to the “confirmed” forwarding cache and becomes an on-tree HDR for the GA. It then forwards the message to the D_IF. Otherwise, the message is ignored.

Eventually, the HDR(k) receives a HLIM_ACK[GA,R/S] message and establishes the “confirmed” forwarding cache for the GA. It then sends an IGMP_RID_Reply[GA,R/S], which includes the RID, back to the host.

FIG. 10 shows examples of the HLIM receiver join operations. Multicast receiver (one type of host) MR1 sends an IGMP_RID_Request [SR(2,4), aaa, R] 110 to router HDR28 in order to join a multicast session in SR(2,4) having APL_ID aaa. An HLIM_Join request 112 is then sent by router HDR28 to router HDR23. The HLIM_Join message 112 from the mobile receiver MR1 is forwarded 114 up to the highest router HDR41 on the scope region, HDR(4), and this HDR issues a HLIM_ACK 113 down to the HDR to which the receiver is attaching. On the other hand, the HLIM_Join message 112 from the mobile receiver MR2 traverses only up to the router HDR38 at HDR(3) which is an on-tree HDR and a HLIM_ACK 113 is returned by this on-tree HDR. Both mobile routers MR1 and MR2 receive IGMP_RID messages 114 from their respective parent routers. The IGMP_RID_Request from the invalid mobile receiver MR3 is discarded by router HDR14 since the receiver is located outside of the scope region SR[2,4]. The operations are the same for a source except that the messages are marked “S” instead of “R”. In FIG. 10 all routers that are marked with an “X” discard any HLIM_Join or HLIM_RID_Request packets.

### FORWARDING MULTICAST PACKETS

When a HDR receives a multicast packet (denoted as MP[GA,Src] where Src is the source IP address of the packet), it simply forwards the packet to the outgoing interfaces indicated in the forwarding cache for the GA (if any), except the incoming interface of the packet. If the cache does not exist, the packet is discarded.

FIG. 11 shows some multicast forwarding examples in the regular case. The multicast packets 200 from the invalid source, Src₂, S2 are outside the scope region and are discarded at its parent HDR router HDR14. The multicast packets from the Src₁ S1 are delivered to the receivers joining the GA through the on-tree HDR routers HDR41, HDR42, HDR32, HDR37, HDR38, HDR28, HDR29. These are all HDR's having a forward cache {GA, Outg_IF(D_IF/L_iF}}. Those routers denoted with “X” in FIG. 11 are not on tree and discard the multicast packets 200. Note that the HLIM provides the shortest path from a source to each of the receivers and the multicast tree is shared by all sources and receivers of the same group.

### HLIM OPERATIONS FOR MOBILITY

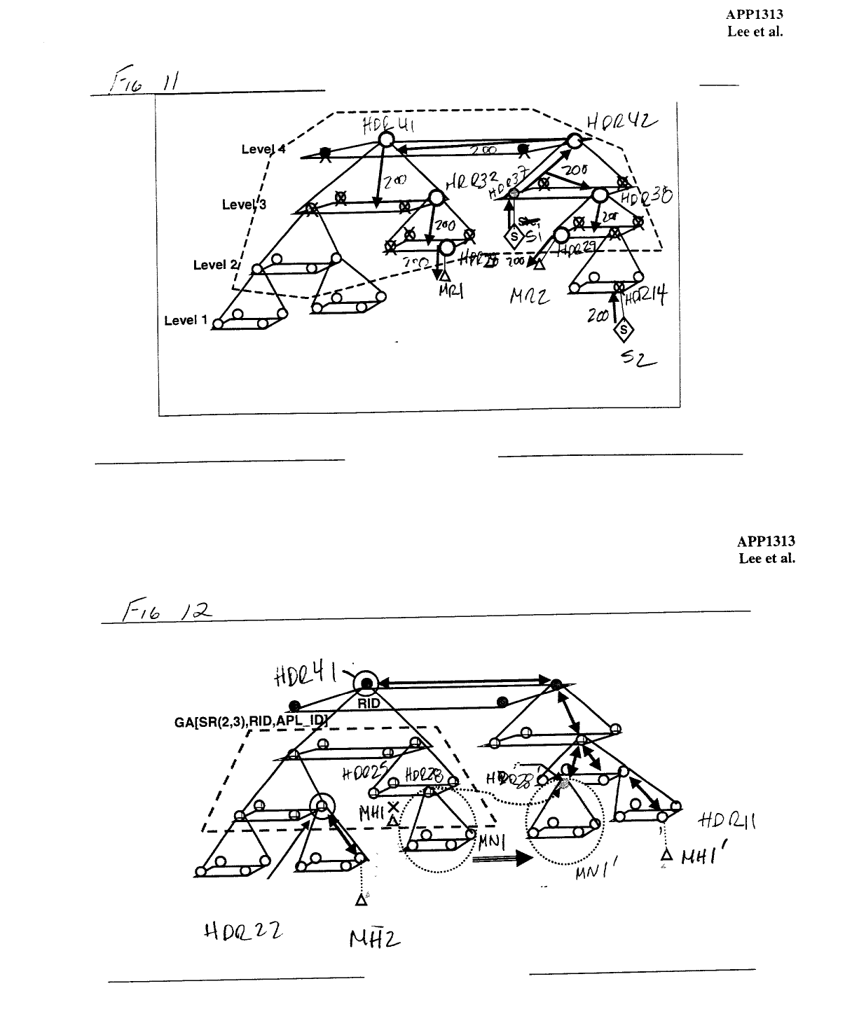

The basic idea to support mobility in HLIM is to find a binding point (BPT) in the established multicast tree for a mobile receiver or source moving out of its original scope region. When a mobile host (a mobile receiver or source) moves out of the scope region while engaging in a multicast session, it must join the same multicast tree established within its original scope region in order to continue participating in the same multicast session. The BPT is the HDR that provides linkages between the original scope region and the new location of a mobile host through the shortest path. It is located at the bottom of or right above the original scope region depending on the new location of a mobile host. Through the BPT, a mobile receiver or source outside its original scope region can continue to receive or send multicast packets from the sources or to the receivers in the same multicast session. It should be noted that all the multicast packets are still delivered to/from the new location of the mobile host through the shortest path. Two example BPTs are shown in FIG. 12. Router HDR41 is the BPT for mobile host MH1 and mobile network MN1.

Each HDR keeps a list of all its ascendant HDRs (referred to as the HDR list) and updates its HDR list whenever any of its ascendant HDRs is changed. If an HDR moves to a new location, it will get a new HDR list. When the movement of a mobile host (or network) engaged in a multicast session is detected, the new parent HDR of the mobile host or the root of the mobile network will determine the movement type (i.e., inside or outside the scope region) with respect to its on-going multicast sessions. For example, the determination of movement type for the mobile host MH1 to MH1′ shown in FIG. 12 takes place at router HDR11 which has become the new HDR(1) for mobile host MH1′ which has moved from being MH1 attached to router HDR25. The determination of movement type for the mobile network MN1 takes place at router HDR28′. Mobility detection mechanism is built into HLIM. This is to eliminate the dependence of HLIM on other protocols (e.g., the lower layers, or Mobile IP). However, if other mobility detection mechanism is available, HLIM could interact with the other scheme (e.g., the radio layer) instead to provide a more efficient mobility detection.

### Forwarding Caches in HDR

In order to forward multicast packets and support mobility, each HDR maintains R_MFC (multicast forwarding cache for receivers) and S_MFC (multicast forwarding cache for sources) lists. The followings are possible entries in the forwarding cache lists.

In the R_MFC list:

For R_MFC located within the scope region of the multicast group,

{GA, R, Out_IF[L_IF]},

{GA, R, Out_IF[D_IF]},

{GA, R, Out_IF[L_IF;D_IF])}

For R_MFC located outside the scope region of the multicast group,

{GA, MR, Out_IF[L_IF]},

{GA, MR, Out_IF[D_IF]},

{GA, MR, Out_IF[L_IF;D_IF]},

{GA, MR, Out_IF[U_IF]},

{GA, MR, Out_IF[L_IF;U_IF]}.

In the S_MFC list:

For S_MFC located within the scope region of the multicast group,

{GA, S, Out_IF[D_IF]},

For S_MFC located outside the scope region of the multicast group,

{GA, MS, Out_IF[D_IF]},

{GA, MS, Out_IF[U_IF]}.

GA is a HLIM group address which contains SR(L,H), APL_ID, and RID. R/S/MR/MS indicates the type of the cache. R is for receiver-created cache located within the scope region of the multicast group. S is for source-created cache located within the scope region of the multicast group. MR is for receiver-created cache located outside the scope region of the multicast group. And MS is for source-created cache located outside the scope region of the multicast group. In software implementation, a flag will be used in the cache to differentiate between source and receiver. Whether a cache is located inside or outside a scope region will be determined by a HDR by comparing the RID in its cache and the HDR(H+1)'s ID (i.e., the IP address of its parent HDR at level H+1) in its HDR list when the cache is processed by an operation, rather than using a flag. If the two RIDs are the same and k is between L and H, the cache is inside the scope region; otherwise, it is outside the scope region. In the rest of the document, we will also use these notations (R/S/MR/MS) to refer to receivers or sources inside or outside the scope region. Out_IF[L_IF/D_IF/U_IF] indicates the outgoing interface(s) that a multicast packet of the GA should be forwarded to.

### Host Mobility

Hosts in the HMN are allowed to move to anywhere in the network. There are three possible movement types 301, 302, 303 for a mobile host MH1 as shown in FIG. 13. With movement type 301, mobile host MH1 remains within its original scope region to position MH1′. With movement type 302 mobile host MH1 moves below its original scope region to position MH1″. With movement type 303 out of (but not below) its original scope region mobile host MH1 moves to mobile host position MH1′″. In HLIM, the movement type of a mobile host must be determined first in order to invoke the appropriate host mobility operations. Movement type 301 mobility can be handled by the regular operations described for the stationary case. The mobile host MH1′ can simply join the group again at the new location as in the stationary case. For movements types 302 and 303, operations additional to those for the stationary case are required to handle the host mobility. The “out-of-scope” movement is distinguished into movement types 302 and 303 because the two cases require different HDRs at different places to forward the multicast packets to/from the new location of the mobile host. Note that the “original” scope region refers to the scope region of the multicast group started by a mobile host through the HLIM regular operations. New messages added into the current IGMP protocol to handle host mobility explicitly are IGMP_M_Report, IGMP_M_Reply and IGMP_Hello.

### HOST MOBILITY DETECTION

The IGMP_Hello message is used to detect host mobility. A HDR periodically sends IGMP_Hello to its local subnet at the rate of 1 message per 1 to 5 seconds (the rate can be adaptive to the degree of mobility). Through this message, the local hosts detect the change of their affiliating HDR. Once a host detects its mobility through the IGMP_Hello message, it issues an IGMP_M_Report(R/S) for each of on-going multicast sessions to its new parent HDR. Note that the affiliating HDR can be changed by not only host mobility but also the HDR election process. In the case of HDR election, the change of HDR is detected and informed through an IGMP_Flush message rather than an IGMP_Hello message. This case is not considered as host mobility and does not cause to invoke the host mobility operations. The HDR election process will be discussed below.

### IGMP OPERATIONS FOR A MOBILE HOST

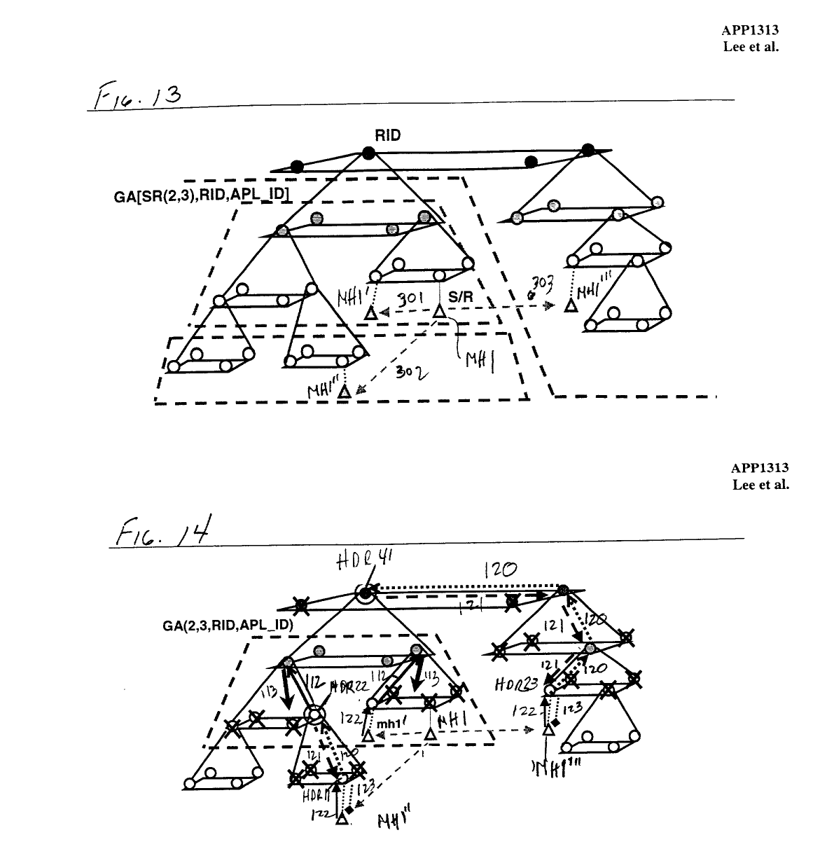

Some example operations for host mobility are shown in FIG. 14. Mobile host MH1 may move to positions denoted as MH1′, MH1″ or MH1′″. For movement to MH1′, because mobile host MH1 has moved within the scope region, only the regular join operations HLIM_Join 112 and HLIM_Ack 113 are invoked. For the other two situations where mobile host MH1 moves to become a mobile host at positions MH1″ or MH1′″ that mobile host has moved out of the scope region. Because it has moved out of the scope region, the mobile join operations are performed between the new HDR HDR11 serving mobile host MH1″ and the BPT_L at router HDR22, and between the new HDR HDR23 serving mobile host MH1′″ and the BPT_H at router HDR41. The prune operation is not shown in FIG. 14.

The mobile host at MH1″ issues an IGMP_M_Report[GA, R/S] message 122 to its new parent (HDR) router HDR11 at the new location, where GA is illustrated as GA[SR(L,H),RID,APL_ID].

Upon receiving the IGMP_M_Report, the router HDR(k) finds out whether the mobile host moved within or outside the original scope region by the following comparisons:

H=N (where N is the number of levels in the hierarchy) and k≧L

H<N and L≦k≦H and RID=HDR(H+1) in the HDR list

If one of these conditions satisfies, the HDR(k) determines that the mobile host has moved within the original scope region. Otherwise, the mobile host has moved out of the original scope region.

If the HDR(k) has already a membership record for the requested GA, it returns an IGMP_M_Reply[GA, R/S] 123 to the host. Otherwise, it invokes the HLIM regular join operation by sending a HLIM_Join[GA, R/S] 112 to its U_IF if the host moved within the original scope region, or starts the mobile join operation by sending a HLIM_M_Join[GA, R/S] 120 toward the RID if the host moved outside of the original scope region. After completing the join procedure and tree adjustment, the HDR(k) sends an IGMP_M_Reply[GA, R/S] 123 back to the mobile host. MH1′

### ADJUSTING THE HLIM TREE FOR A MOBILE HOST

The new HDR to which a source or receiver has moved invokes the mobile join operation by sending a HLIM_M_Join[GA,R/S] 120 toward the RID of the affected multicast session. On the way toward the RID, if the message reaches an on-tree HDR outside the scope region or the BPT, a HLIM_M_ACK(R/S) 121 message is returned and the multicast tree will be extended along the path. The procedure is now described.

When the new HDR receives and accepts an IGMP_M_Report(R/S) 122 from its local subnet and has no existing member for the requested GA, it adds the GA into its membership database. It then looks up the unicast routing table to find out the outgoing interface toward the RID. If an IGMP_M_Report(R) 122 is received, the HDR sets up a “transient” forwarding cache with L_IF set in the Out_IF. If an IGMP_M_Report(S) 122 is received, the HDR sets up a “transient” forwarding cache with the outgoing interface toward the RID set in the Out_IF. The HDR then sends a HLIM_M_Join(R/S) message 120 toward the RID. Note that the HLIM_M_Join(R/S) 120 message is sent in multicast so that all HDRs in the subnet attached to the outgoing interface will receive it.

When a HDR receives a HLIM_M_Join(R/S) message 120, it determines if it is the BPT for the mobility. If its own address=RID or the address of its ascendant HDR(k+1)=RID and its level=L, it is the BPT and then go to the step following the next step. Otherwise, proceed to the next step.

If a HDR is not the BPT, it first determines the outgoing interface toward the RID from the unicast routing table. If the outgoing interface is the same as the incoming interface of the HLIM_M_Join(R/S) message 120, the HDR discards the message (such as at routers marked by “X” in FIG. 14). Otherwise, it processes the message as follows:

If the HDR is on-tree for the group (i.e., it already has the receiver/source forwarding cache that the received HLIM_M_Join(R/S) tries to set up), it stops forwarding the HLIM_M_Join(R/S) and replies with a HLIM_M_ACK(R/S) message to the incoming interface of the HLIM_M_Join.

Otherwise, the HDR sets up a “transient” forwarding cache for the group with the incoming interface of the HLIM_M_Join (for receiver) or the outgoing interface toward the RID (for source) set in the Out_IF. It then forwards the HLIM_M_Join(R/S) to the outgoing interface toward the RID.

When the BPT receives the HLIM_M_Join(R/S) message, if the level of the BPT=L (i.e., at the bottom of the scope region) and the message is received from the D_IF, it returns a HLIM_M_ACK(R/S) to the D_IF. If it is not yet an on-tree HDR for the group, it sets up a “transient” forwarding cache with the D_IF set in the Out_IF and issues a regular HLIM_Join(R/S) message to its U_IF, which is then processed as in the regular case. If the BPT=RID and the message is received from the U_IF, it returns a HLIM_M_ACK(R/S) to the U_IF. If the required receiver/source forwarding cache does not exist, it sets up a “confirmed” forwarding cache for the group with the U_IF (for receiver) or D_IF (for source) set in the Out_IF. Otherwise, the message is ignored.

When a HDR receives a HLIM_M_ACK(R/S) for a group, if it has the corresponding “transient” forwarding cache and the message is received from the outgoing interface toward the RID, it switches the cache to a “confirmed” cache and forwards the HLIM_M_ACK(R/S) to the Out_IF in the cache for receiver, or to the interface opposite to the Out_IF in the cache for source. Otherwise, the message is ignored.

Eventually, the new HDR receives a HLIM_M_ACK(R/S) from the outgoing interface toward the RID. It then switches the “transient” forwarding cache for the group into the “confirmed” state and returns a IGMP_M_Reply to the mobile host.

After the source or receiver moves away, the previous parent HDR at the old location will invoke the prune operation if no other sources or receivers of the affected multicast sessions exist in its local subnet. The prune operation eliminates unnecessary branches of the multicast trees. The details of the prune operation will be described below.

FIG. 15 depicts how multicast packets 200 are forwarded from mobile sources S1 and to mobile receivers MR2 and MR3 after their movements to positions S1′ and MR2′ and MR3′.

### Network Mobility

Network movement in the HMN is allowed only within the same level. A router at level k can only move to the same level at another branch of the hierarchy. It can move with its whole descendant sub-networks (including its local subnet), its local subnet only, or alone. The goal is to hide any network mobility from the hosts or routers within the moving network. In other words, no operations are required from the hosts or routers inside the moving network. Only the “topmost” router interacts with the outside of the moving network to hand over any on-going multicast sessions to the new location.

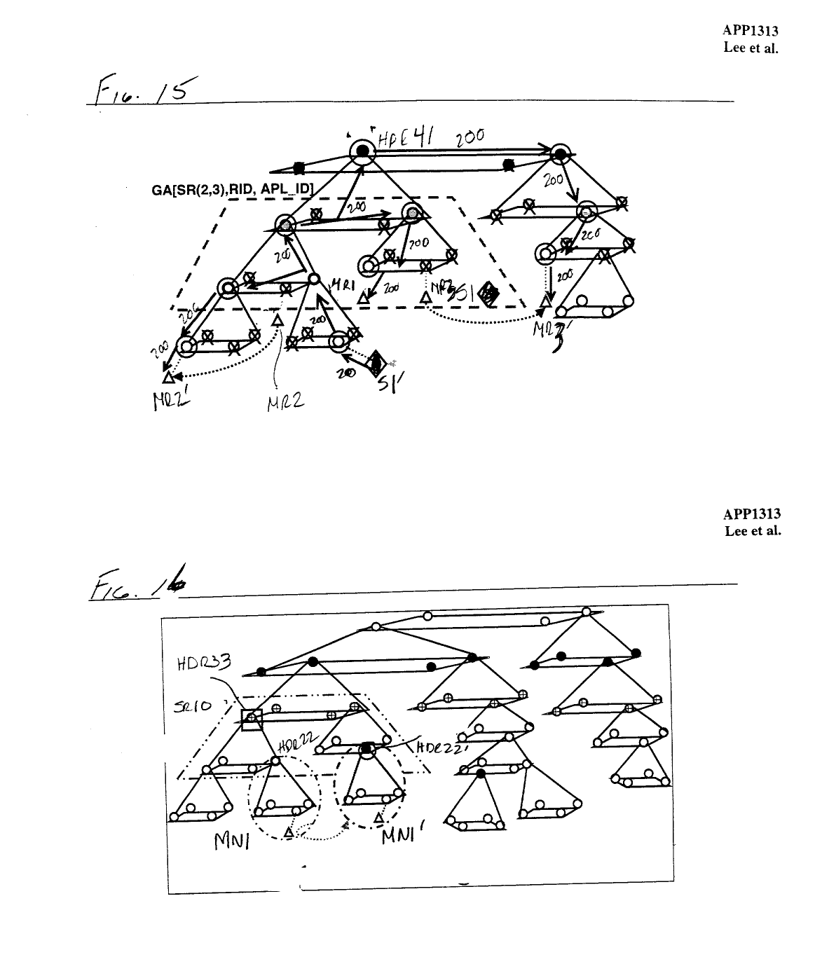

Only the movement of an “on-tree” HDR (i.e., the HDR with one or more forwarding caches established by HLIM_Join or HLIM_M_Join) will invoke mobility operations to hand over all the on-going multicast sessions through the router. There are five possible cases of network movement as shown in FIG. 16 through FIG. 20 respectively.

FIG. 16 shows the movement of a mobile network MN1 within the scope region SR10 (SR[2,3]) to position MN1′. For any on-going multicast sessions, both the router HDR33 that was the parent HDR at the old location for router HDR22, the router at the root of the moving subnetwork have the forwarding cache entries, (R: D_IF) or (S: U_IF) in their MFC lists. The parent HDR HDR33 at the old location will invoke the regular prune operation. The root of the moving subnetwork at the new location at router HDR22′ invokes the regular join and HDR list update operation.

FIG. 17 shows the network movement to the outside of the scope region SR10. Router HDR41 is the BPT for scope region SR10. For any on-going multicast session, both the parent HDR router HDR32 at the old location and the root router HDR28 of the moving subnetwork MN1 have the forwarding cache entries, (R: D_IF, L_IF) or (S: U_IF) in their MFC's. The parent HDR router HDR32 at the old location will invoke the regular prune operation since it is located within the scope region. The root router HDR28 of the moving subnetwork MN1′ at the new location HDR28′ will invoke the mobile join operation since it is outside the scope region. It also invokes the HDR list update operation. After the operations, its forwarding cache entries will become (MR: D_IF, or L_IF) or (MS: U_IF).

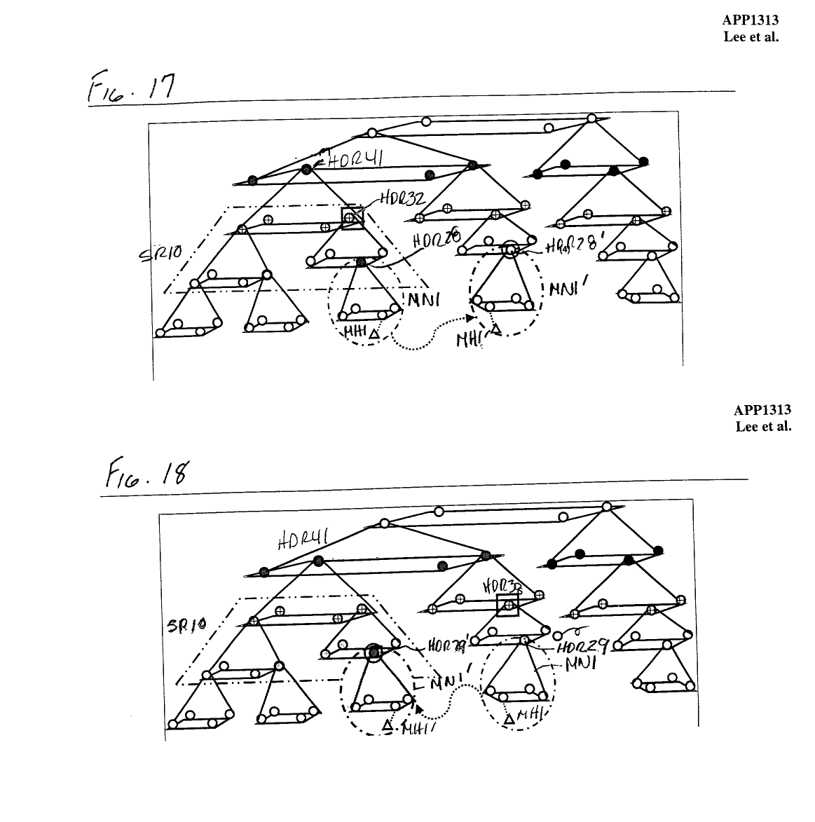

FIG. 18 shows the network movement of mobile network MN1 to a position inside the scope region SR10. Both the parent HDR router HDR38 at the old location and the root router HDR29 of the moving subnetwork have the forwarding entries, (MR: D_IF, or L_IF) or (MS: U_IF) in their MFC lists. The parent HDR HDR38 at the old location will invoke the mobile prune operation because it is located outside the scope region. The root router HDR29′ of the moving subnetwork MN1′ at the new location will invoke the regular join operation since it is inside the scope region. Again, it will invoke the HDR list update operation. After the operations, its forwarding cache entries will become (R:D_IF, or L_IF) or (S:U_IF). Router HDR41 is the top BPT for scope region SR10.

FIG. 19 shows the network movement of mobile network MN1 within the area outside of the scope region SR10 (SR[2,3]), i.e., movement from position MN1′ to MN1″. Both the parent HDR router HDR38 at the old location MN1′ and the root HDR28′ of the moving subnetwork have the forwarding entries, (MR: D_IF, or L_IF) or (MS: U_IF) in their MFC lists. The parent HDR router HDR38 at the old location and the root HDR28″ of the moving subnetwork at the new location MN1″ will invoke the mobile prune operation and the mobile join operation, respectively, since they are located outside the scope region. Again, the root of the moving subnetwork will invoke the HDR list update operation. Router HDR41 is the top BPT for scope region SR10.

FIG. 20 shows the movement of a mobile network MN10 including the BPT router HDR33 and RID for SR20 to position MN10′. Both the parent HDR router HDR41 at the old location and the root router HDR33 of the moving subnetwork have the forwarding entries, (MR: U_IF or L_IF) or (MS: D_IF) in their MFC lists. This is a special case of network mobility. The root of the moving subnetwork at the new location HDR33′ will invoke the new network join operations as well as the HDR update operations. The parent HDR router HDR41 at the old location MN10 will invoke the network prune operation afterwards if necessary.

### DETECTION OF NETWORK MOVEMENT

Network movement is detected through the operations of HLIM_P_Hello and HLIM_C_Hello. A parent HDR periodically sends an HLIM_P_Hello message to its child HDRs and each child HDR also periodically sends an HLIM_C_Hello message to the parent HDR. The parent HDR detects the disappearance of child HDR (i.e., the movement of child HDR) by tracking each of the HLIM_C_Hello message from its child HDR whereas the child HDR detects its movement by tracking the source of the HLIM_P_Hello message.

A parent HDR can detect a movement (disappearance) of one of its child HDRs through periodic HLIM_C_Hello message. A child HDR periodically issues an HLIM_C_Hello to its parent HDR. Upon receiving an HLIM_Hello, the parent HDR records the source of the message into its child list. In this way, a parent HDR keeps track of the presence of all of its child HDRs. If the parent HDR doesn't get an HLIM_C_Hello from one of its expected child HDRs until the C_Hello_Wait_Timer expires, it regards that child HDR has moved away from its coverage.

When a HDR detects that one of its child HDRs moves away from its coverage, the HDR invokes the HLIM_Compare(M) operation to determine any inconsistency in its forwarding caches due to the movement of the child HDR. The detail operations of the HLIM_Compare(M) will be described later.

A moving subnetwork can detect movement. A HDR periodically receives a HLIM_P_Hello message from its parent HDR (i.e., immediate ascendant HDR) and keeps tracking the source of the message, which is the parent HDR. If the change of the source (i.e., the change of parent HDR) is detected, it regards that it has moved to a new location. When it detects its own movement, it acquires a new HDR list through the HLIM_HDR_List_Solicit and HLIM_HDR_List_Update operations and updates its HDR list. By referring to its forwarding cache lists, R_MFC and S_MFC lists, it invokes appropriate operations such as HLIM_Join, HLIM_M_Join, or HLIM_Net_Join operations to extend the multicast trees of the ongoing sessions to/from the moving subnetwork.

### NETWORK MOBILITY OPERATIONS

Network movement is detected by both the parent HDR at an old location and a moving child HDR at a new location. Once the network movement is detected, both HDRs invoke the appropriate operations to adjust the inconsistent forwarding caches incurred by the network movement. At the old location, once the movement of a child HDR is detected, the parent HDR needs to adjust its forwarding cache by deleting any invalid cache entry which had been solely created by the moved child HDR (or moving subnetwork). Such cache adjustment is achieved through the HLIM_Compare(M) operation.

There are two types of HLIM_Compare operations. When a new HDR is elected, the HDR invokes the HLIM_Compare(E) operation for recovering the forwarding caches in the previous HDR that went down. When a HDR detects the movement of one of its child HDRs, it invokes the HLIM_Compare(M) operation for finding out and rearrange any inconsistent forwarding caches caused by network mobility made by one of its child HDRs (or with carrying subnets). The HDR election and HLIM_Compare(E) operation will be described in the next chapter in details. The procedure of HLIM_Compare(M) operation is described below.

When a HDR detects the movement of one of its child HDRs, it sends a HLIM_Compare(M) to its child HDRs through its D_IF (i.e., toward its lower core subnet), and sets a Compare_Repeat_Timer during which the HLIM_Compare_Reply(M) messages from its child HDRs will be collected. A HLIM_Compare(M) message contains inbound and outbound GAs. “Inbound GAs” refer to the group addresses for which multicast packets are sent into the core subnet through that interface (i.e., the group addresses with an Outg_IF the same as the interface through which the HLIM_Compare(M) is being sent). Similarly, “outbound GAs” refer to group addresses for which multicast packets are sent out of the core subnet (i.e., the group addresses with an Outg_IF the same as the L_IF or the interface opposite to which the HLIM_Compare(M) is being sent).

When a HDR receives a HLIM_Compare(M) from its parent HDR, it sets two timers: a Compare_RandTimer which is a random timer (its maximum value should be less than the Compare_Repeat_Timer mentioned above) to wait before sending a HLIM_Compare_Reply(M), and a Compare_Timer (its value should be longer than the maximum time for the parent HDR to finish all the retransmissions of the HLIM_Compare(M)) during which the HLIM_Compare_Reply(M) messages from its neighboring HDRs will be collected. A HLIM_Compare_Reply(M) is multicast and also contains inbound/outbound GAs associated with either regular or mobile hosts (R/S/MR/MS).

When the Compare_Repeat_Timer expires, the parent HDR checks if it has received the reply from all of its child HDRs. If not, it unicasts the HLIM_Compare(M) to the missing children and starts the Compare_Repeat_Timer again. This operation is repeated until the maximum number of trials. The repeated transmissions are to increase the reliability of this operation.

When a child HDR has its Compare_Timer expire or the parent HDR receives replies from all of its children or finishes the maximum number of HLIM_Compare(M) transmissions, the HDR will invoke the inbound and outbound GAs comparison (IOGC) and then take appropriate actions such as join or prune operations. In the IOGC, receiver-created and source-crated inbound GAs are compared with receiver-created and source-created outbound GAs, respectively.

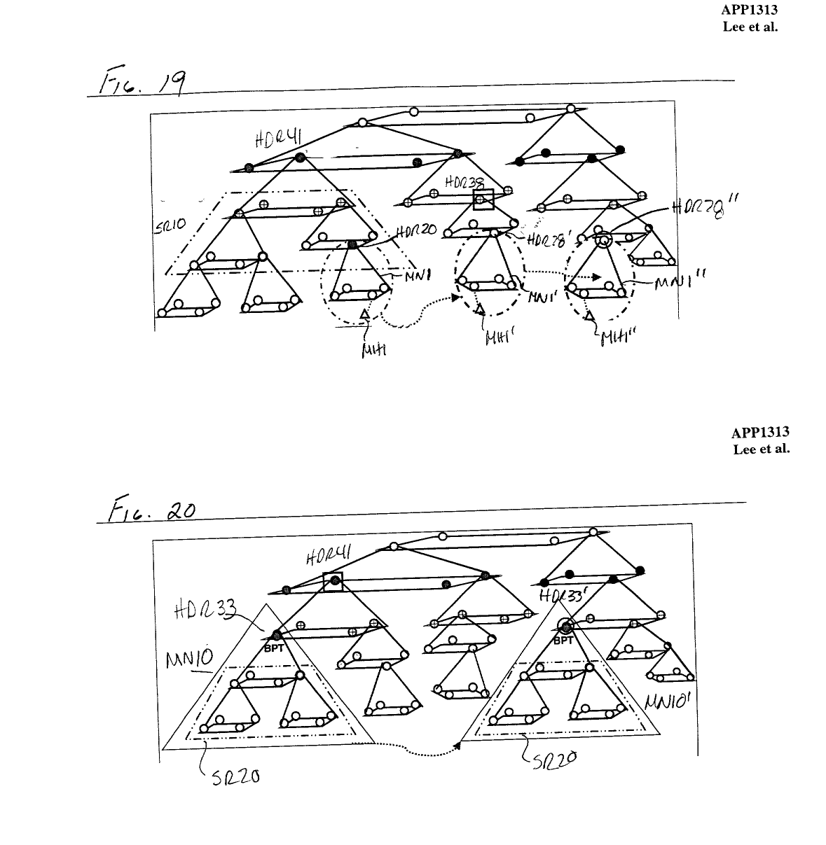

Through the IOGC, the parent HDR finds the unmatched GAs and identifies the attachments of the unmatched GAs, comprised of R/S/MR/MS and L_IF/D_IF/U_IF. By referring to the attachments, the HDR finds out whether regular/mobile receivers/sources for the unmatched GAs are located within the moving subnetwork. FIGS. 21a-c show the possible cases.

The attachments, (R:D_IF), (S:U_IF), (MR:D_IF), and (MS:U_IF), for a GA imply that some regular/mobile sources/receivers for the GA are located within the moving subnetwork. In these cases, the prune operations are invoked for those forwarding caches that match the attachments since they are no longer needed at the HDR. In other words, the tree already established via the HDR at the old location needs to be pruned. The following prune operations corresponding to the attachments are invoked:

HLIM_Prune(R) for (R:D_IF)

HLIM_Prune(S) for (S:U_IF)

HLIM_M_Prune(R) for (MR:D_IF)

HLIM_M_Prune(S) for (MS:U_IF)

All the prune operations mentioned above are sent toward the RID. The details of prune operations are described below.

The attachments, (MR:U_IF) and (MS:D_IF), for a GA imply that the moving subnetwork contains the BPT or RID of the GA. In this case (e.g., in FIG. 21c), no operation is required by this parent HDR at this moment because the HLIM_Net_Join operation invoked by the root HDR (i.e. the moved child HDR) at a new location will take care of this case. The HLIM_Net_Join operation will discribed in the next subsection.

Once the root of a moving subnetwork detects its own movement through HLIM_Hello and HLIM_Hello_Reply at the new location, it will invoke an appropriate operation for every entry in both R_MFC and S_MFC lists.

For entries with (R:D_IF), (S:U_IF), (MR:D_IF), or (MS:U_IF) for a GA, the join operations should be invoked because a regular/mobile source/receiver for the GA is located inside the moving subnetwork, thus the multicast tree of the GA needs to be extended to/from the moving subnetwork. The following join operations are invoked:

HLIM_Join(R) for (R:D_IF)

HLIM_Join(S) for (S:U_IF)

HLIM_M_Join(R) for (MR:D_IF)

HLIM_M_Join(S) for (MS:U_IF)

All the join messages mentioned above are sent toward the RID of the GA.

For entries with (MR:U_IF) or (MS:D_IF) for a GA, which imply that the moving subnetwork contains the BPT or RID of the GA, HLIM_Net_Join(R) or HLIM_Net_Join(S) operation is invoked. A HLIM_Net_Join message is sent toward the parent HDR at the old location. The operations are described in detail in the next subsection.

### NETWORK JOIN OPERATIONS: HLIM_NET_JOIN(R/S)

The network join operation is used to handle a special case of network mobility in which the moving subnetwork contains the BPT or RID of an on-going multicast session. It is invoked by the root HDR of the moving network when the root HDR has the forwarding cache of (MR:U_IF) or (MS:D_IF). A HLIM_Net_Join(R/S) message is forwarded toward the old parent HDR at the old location and processed by the HDRs on the path to the old parent. The other HDRs (i.e., HDRs are not on the path) will discard the message.

The root HDR sets the listed outgoing interface (i.e., U_IF for MR and D_IF for MS) as transient state and sends a HLIM_Net_Join[GA, R/S] toward the old parent HDR.

When a HDR on the shortest path between the new location and the old parent HDR receives the HLIM_Net_Join message, it checks if it has a R_MFC (if HLIM_Net_Join(R) is received) or S_MFC (if HLIM_Net_Join(S) is received) for the GA.

If the corresponding MFC is not found, the HDR will create a transient forwarding cache for the GA and relay the message toward the old parent as in the mobile join operation. The direction of the outgoing interface set in the forwarding cache is opposite to the mobile join operation: the outgoing interface for a HLIM_Net_Join[GA, R] message is listed as an Outg_IF in the R_MFC for the GA and the incoming interface for a HLIM_Net_Join[GA, S] is listed as an Outg_IF in the S_MFC for the GA.

Otherwise, it compares the incoming interface of the message with the Outg_IF listed in its MFC. Note that L_IF is excluded in this comparison.

For a HLIM_Net_Join[GA, R],

If the incoming interface and the listed Outg_IF are not the same, the HDR ignores the message. Otherwise, the listed Outg_IF is switched to a transientdeletedstate and a new transient R_MFC pointing to the opposite interface is set. The HDR then forwards the HLIM_Net_Join toward the old parent HDR. For a HLIM_Net_Join[GA, S], if the incoming interface and the listed Outg_IF are the same, the HDR ignores the message. Otherwise, the listed Outg_IF is switched to a transient deleted state and a new transient R_MFC pointing to the opposite interface is set. The HDR then forwards the HLIM_Net_Join toward the old parent HDR.

The HLIM_Net_Join operation will proceed to the old parent HDR at the old location. When the old parent receives a HLIM_Net_Join[GA, R/S], it sets a confirmed state of forwarding cache for the GA and returns a HLIM_Net_Join_ACK toward the root HDR of the moving network. It then invokes the HLIM_Compare(M) operation as described previously.

When a HDR with a transient R_MFC for the GA receives a HLIM_Net_Join_ACK, it switches the R_MFC into a confirmed state and forward the HLIM_Net_Join_ACK toward the root HDR of the moving network

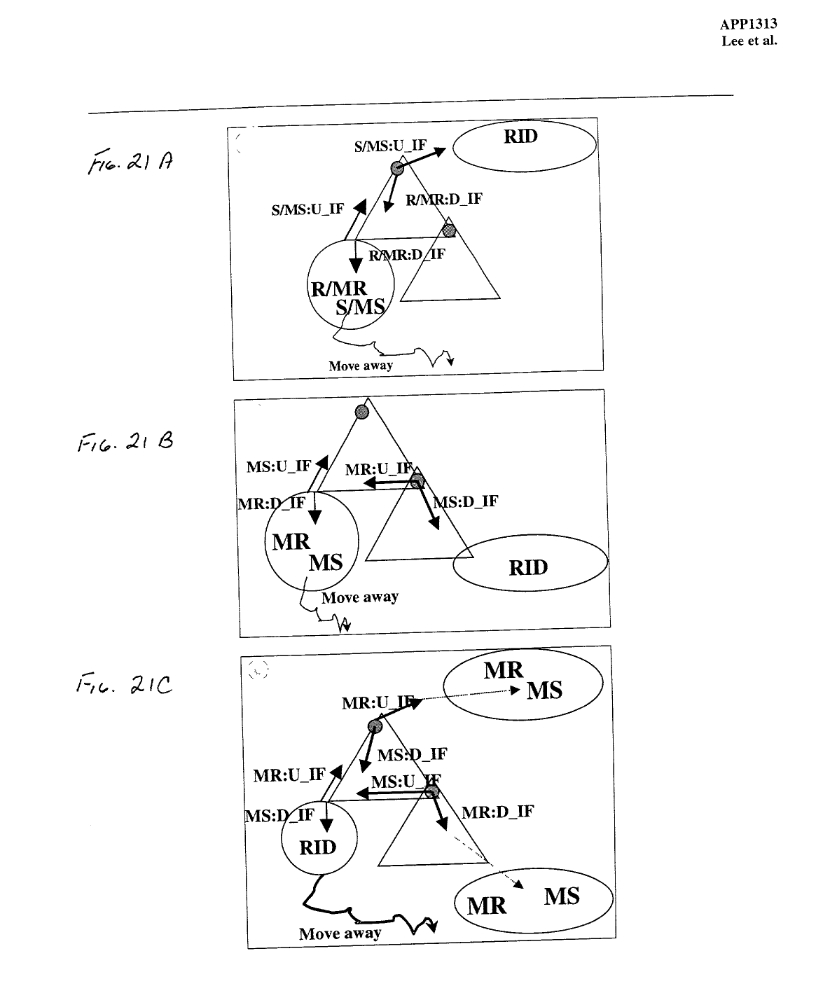

In FIGS. 22 and 23, two receivers MR1 and MR2 have moved out of the scope region (not shown) and continue to receive multicast packets of the session from the RID. The multicast tree of the session is represented by the arrows of U_IF (up arrow), D_IF (down arrow) and L_IF (right arrow). In this first example, the subnetwork containing the RID at router HDR11 of a GA moves from the parent HDR at the old location HDR11 to the new parent HDR at the new location HDR11′. In the course of the HLIM_Net_Join(R) operation, each HDR proceeds as follows.

Once root router HDR11 detects its movement to a new location HDR11′ and finds the attachment of (MR:U_IF) in its R_MFC it will issue a HLIM_Net_Join[GA, R] 140 toward the old parent router HDR21.

Routers HDR24 and HDR32, upon receiving a HLIM_Net_Join[GA, R] 140, since each has the forwarding cache for the GA, compare the incoming interface of the message with the listed Outg_IF which is D_IF. Because they are the same (i.e., both are D_IF), the listed Outg_IF (D_IF) is switched to a transient deleted state. Since each is on the path toward the old parent router HDR21, routers HDR24 and HDR32 each sets up a transient forwarding cache, (MR:U_IF), for GA and relays the HLIM_Net_Join[GA, R] message 140 toward the old parent HDR HDR21. If either receives a HLIM_Net_Join_ACK 141, it will switch the forwarding cache with a transient state to a confirmed state and remove the forwarding cache with a transient deleted state.

HDR router HDR31, since it has the forwarding cache for the GA, compares the incoming interface of the message with the listed Outg_IF, which is U_IF. Because they are the same (i.e., both are U_IF), the listed Outg_IF (U_IF) is switched to a transient deleted state. It sets up a transient forwarding cache, (MR:D_IF), for GA and relays the HLIM_Net_Join[GA, R] message 140 toward the old parent router HDR21. When it receives a HLIM_Net_Join_ACK 141, it will switch the forwarding cache with a transient state to a confirmed state and remove the forwarding cache with a transient deleted state.

Old parent router HDR21, since it has the forwarding cache for the GA, compares the incoming interface of the message with the listed Outg_IF, which is U_IF. Because they are the same (i.e., both are U_IF), the listed Outg_IF (U_IF) is deleted. It sets up the confirmed Outg_IF of the GA opposite to the incoming interface of the message and sends a HLIM_Net_Join_ACK 141 to the incoming interface. It invokes the HLIM_Compare(M) operation.

All other routers ignore the HLIM_Net_Join/HLIM_Net_Join_ACK messages received.

FIG. 24 shows the adjusted multicast tree resulted from the HLIM_Net_Join(R) operation. As can be seen, shortest path multicasting is preserved after the network movement. The Outg_IF (D_IF) listed in router HDR31 and Parent HDR HDR21 will be deleted through the HLIM_Compare(M) and HLIM_M_Prune operations at the end since they are not needed.

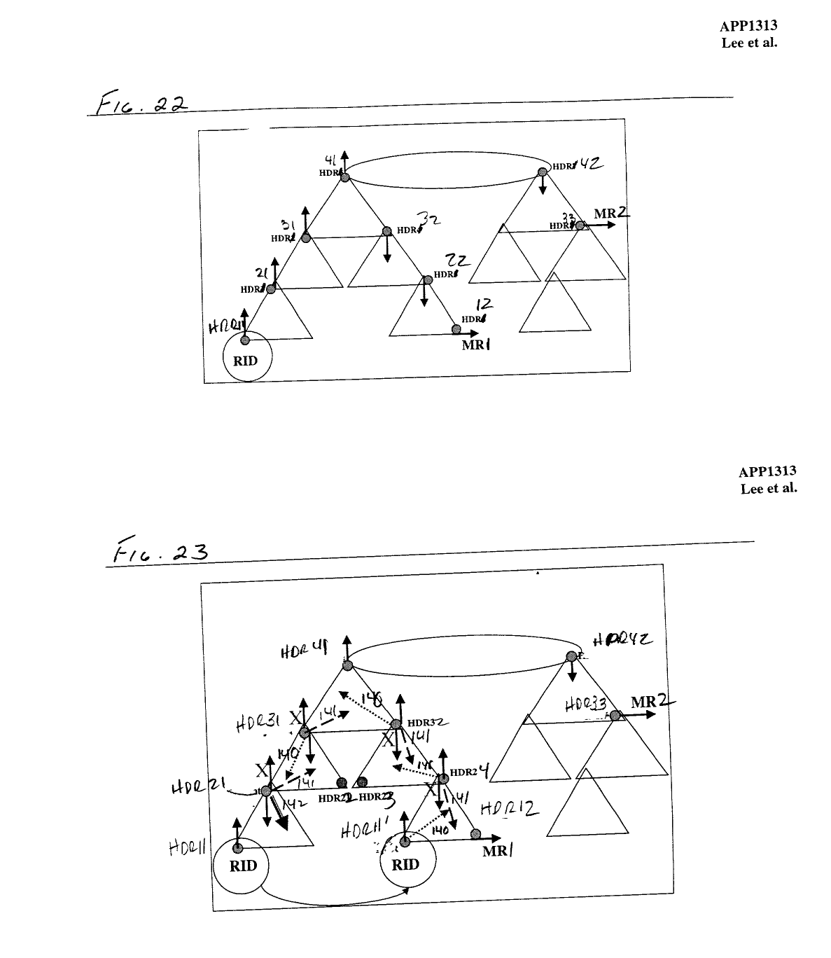

FIG. 25 depicts the message flows among the HDRs illustrated below convey the network receiver-join operation in time perspective.

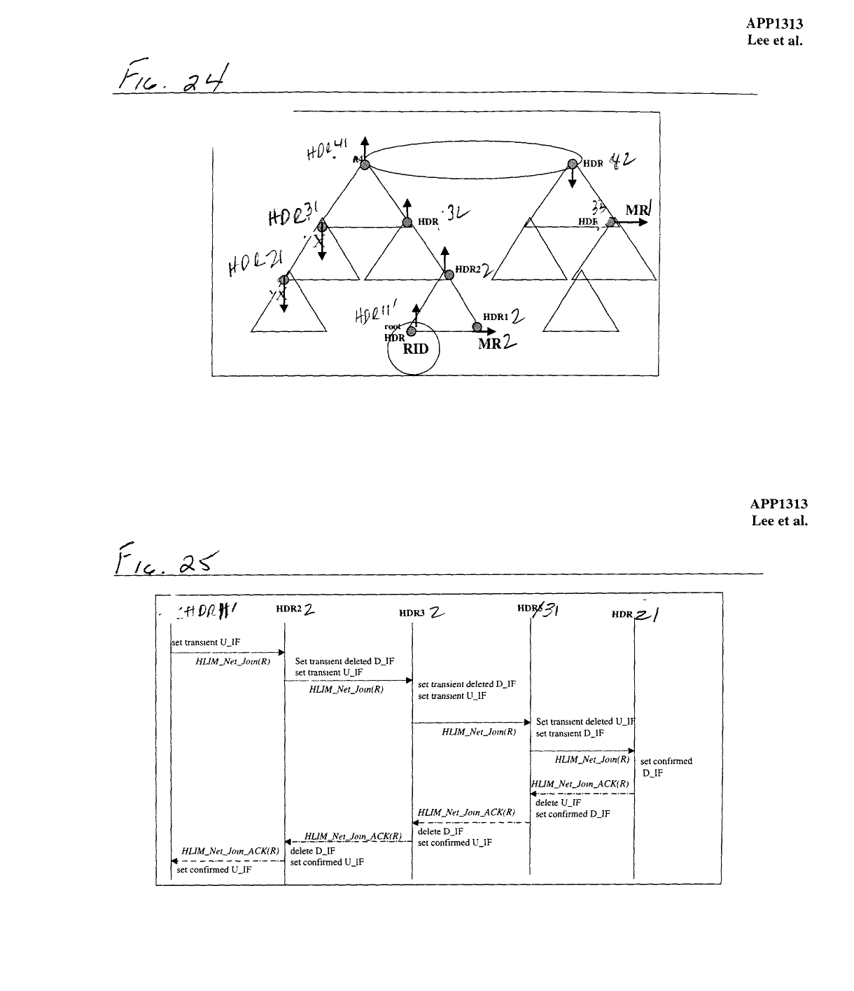

FIGS. 26, and 27 depict an example for the HLIM_Net_Join(S) 144 operation and HLIM_Net_Join ACK(S) 145 operation. The HLIM_Net_Join(S) operation is very similar to the HLIM_Net_Join(R), except the logic of setting up forwarding caches and comparison between the incoming interface toward the RID and the Outg_IF listed in the S_MFC. Opposite to the HLIM_Net_Join(R) operation, if these two interfaces are the same, the listed Outg_IF is set to a transient state; otherwise, the listed Outg_IF will be deleted. Also the HDRs on the path to the old parent HDR set the incoming interface of a HLIM_Net_Join[GA, S] message as an Outg_IF for the GA.

FIG. 28 depicts the message flows among the HDRs illustrated below convey the network source-join operation in time perspective. FIG. 29 shows the adjusted multicast tree resulting from the HLIM_Net_Join(S) operation.

### Reliability Support for the Protocol Messages

Reliability support for the multicast control packets is provided at the IP multicasting protocol level. Additional reliability support at the lower layers (e.g., forward error correction (FEC), automatic repeat request (ARQ) will increase the degree of reliability for the protocol messages. In the regular join and mobility join operations described above, there is always an acknowledgment sent back for each join message invoked. End-to-end retransmission can be implemented. For example, a join message (such as HLIM_Join) can be retransmitted if an acknowledgment (such as HLIM_ACK) is not received within a timeout period. Such end-to-end retransmission is relatively simple but has two problems. Because both the join and acknowledgment messages may traverse many hops, the timeout period is usually set to cover the worst-case scenario. Therefore, any retransmission must wait for such worst-case timeout period even though it is not necessary (e.g., the origination and destination of a join message are only a few hops away). A message lost in any hop between the origination and destination will ruin the end-to-end transaction and require end-to-end retransmission. Such end-to-end retransmission may generate a lot of traffic. For example, the whole transaction needs to be started over again even though only the message in the last hop is lost.

In order to avoid these shortcomings, a hop-by-hop retransmission scheme is added to the end-to-end retransmission. It should be noted that the end-to-end acknowledgment of a join message is not only to recover any message lost on the path, but also to maintain the integrity of the multicast tree being established. Such multicast tree integrity is especially important for the mobile join operation, which is forwarded with the help of a unicast routing table, and the table may be unstable at some instant. Therefore, we do not replace the end-to-end acknowledgment by the hop-by-hop acknowledgment. The basic idea of the hop-by-hop acknowledgment is to acknowledge any message successfully received by a node before forwarding the message to the next hop. If a message loss is encountered in a hop along the path, the hop-by-hop retransmission will recover the message in that hop without invoking the end-to-end retransmission. An end-to-end acknowledgment is finally returned to the origination when the destination has successfully received and processed the message. This end-to-end acknowledgment is also acknowledged hop-by-hop. Note that any message loss recovery can now be achieved much faster and generate less traffic. The end-to-end retransmission will be invoked only if the hop-by-hop retransmission fails to recover a message loss.

On the other hand, if the links are always highly reliable (though not likely in certain tactical environments), such hop-by-hop acknowledgment may seem unnecessary and may generate more traffic. The protocol design of the present invention allows the hop-by-hop acknowledgment to be turned off in such extreme cases to save the amount of traffic. Whether a hop-by-hop acknowledgment is required is indicated in the message sent.

In the existing IGMP design, there is no acknowledgment for a join message (IGMP_Report) from a host. The RFC recommends to send the IGMP_Report for two or three times to increase its reliability. Even if the message is still lost after two or three times, it can be sent again during the next periodic IGMP_Query. Such scheme is good for reasonably reliable links but may have problems in the hostile environments. Such problems include the delay of the “retransmission” of a lost IGMP_Report is up to the IGMP query interval, which is 125 seconds by default. This may be unacceptable for some applications, especially during a handover of an active multicast session (IGMP_M_Report is sent in the same way as IGMP_Report). Additonal problems include the number of consecutive retransmissions in the existing IGMP can be increased to compensate for the unreliable links. However, such approach is not adaptive, especially when the link condition varies dramatically. If the fixed number of retransmission is set to cover the worst-case condition, it will generate a lot of unnecessary traffic when the link condition is good.

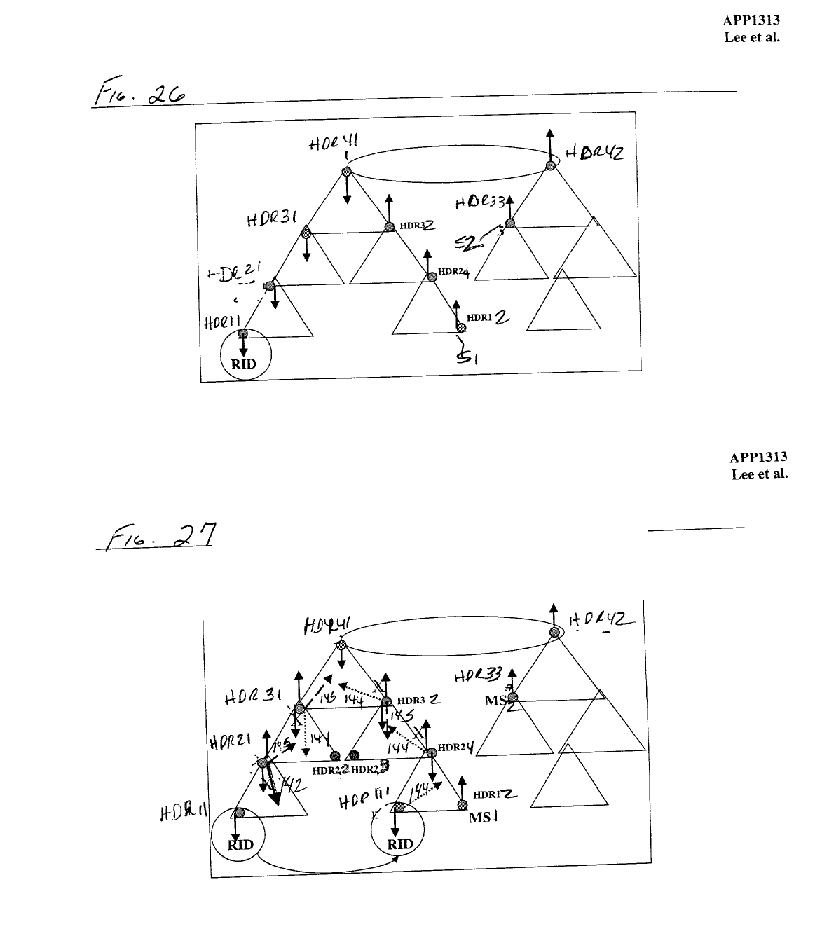

In the present invention there is an acknowledgment for the IGMP messages sent in the similar way (e.g., IGMP_M_Report). After a host sends out an IGMP message (e.g., IGMP_Report, IGMP_RID_Request), it will wait for an immediate acknowledgment (e.g., IGMP_Report_Ack, IGMP_RID_Request_Ack) from its serving HDR. If it does not receive the acknowledgment within the timeout period, it will retransmit the original message. However, if it receives the same message for the same multicast group (from another host), it will stop the retransmission timer. In other words, there will only be one host handling the retransmission of an IGMP message even though more than one host has sent out the same message for the same group. This is to limit the retransmission traffic within the local subnet. As discussed above, such acknowledgment scheme can be turned off if the underlying link condition is always good. FIGS. 30 and 31 show the reliable feature of HLIM in the regular and mobile join operations. In FIG. 31, M is the common level at which the paths from the BPT and from the new HDR merge M>i, H.

### Configuring D_IF and U_IF for a HLIM Router

At boot time, each of the highest HLIM routers at the highest hierarchical level N sets a Hello_RandTimer to the [Hello_Randtime]. For configuring a D_IF and U_IF for every HLIM Router, the following operations are proceeded:

If the Hello_RandTimer expires, the highest HLIM router will:

(1) send a HLIM_Conf_Hello to all of its interfaces except its L_IF (we assume that the L_IF is already predefined). A HLIM_Conf_Hello is multicast to all the other HLIM routers in the same core subnet. If the D_IF for the highest HLIM router has been already assigned, the message is sent only to the D_IF; and,

(2) set its HLIM_Hello_Timer to [Hello_interval] and wait for a HLIM_Hello_Reply. If the HLIM_Hello_Timer expires, it will retransmit the HLIM_Conf_Hello.

If an immediate descendant HLIM router (i.e., the second highest HLIM router, the level of which may be N or N−1) receives the HLIM_Conf_Hello through one of its interfaces, it will:

(1) assign that interface as its U_IF and the other interface as its D_IF;

(2) Reply with a HLIM_Hello_Reply through the U_IF; and,

(3) set a Hello_RandTimer to [Hello_Randtime].

If the highest HLIM router (which sent the HLIM_Conf_Hello) receives a HLIM_Hello_Reply through one of its interfaces, it will:

(1) Stop its HLIM_Hello_Timer; and,

(2) assign that interface as its D_IF and the other interface as its U_IF.

If one of the other highest HLIM routers receives the HLIM_Conf_Hello from one of its interfaces (other than the L_IF), it will restart its Hello_RandTimer and wait for a HLIM_Hello_Reply or HLIM_Conf_Hello.

If the Hello_RandTimer expires at one of the other highest HLIM routers, the router will:

(1) send a HLIM_Conf_Hello to the interface opposite to the one from which the previous HLIM_Conf_Hello was received; and,.

(2)Set its HLIM_Hello_Timer to [Hello_Interval] and wait for a HLIM_Hello_Reply. If the HLIM_Hello_Timer expires, it will retransmit the HLIM_Conf_Hello.

If one of the other highest HLIM routers receives a HLIM_Conf_Hello before the Hello_RandTimer expires, it will stop the timer and then wait for a HLIM_Hello_Reply.

If one of the other highest HLIM routers receives a HLIM_Hello_Reply, it will assign its interfaces as the highest HLIM router.

If the second highest HLIM router's Hello_RandTimer expires, the second highest HLIM router sends a HLIM_Conf_Hello to its D_IF. When the next highest HLIM routers receive the HLIM_Conf_Hello message, they will perform the same operations as the second highest HLIM router receiving a HLIM_Conf_Hello.

As this operation proceeds down to the lowest level, the D_IF and U_IF for every HLIM router are determined.

If a HLIM router does not get a HLIM_Hello_Reply within the [Hello_Interval], it retransmits a HLIM_Conf_Hello. The retransmission is repeated until the router gets a reply message or the maximum number of retransmissions is reached.

### Electing the Local HDR and Global HDR

As described above, there may be more than one router in a subnet (local or core). A designated router must be assigned to avoid any duplication of multicast traffic. A local HDR (L_HDR) is the HLIM router which is designated/elected to handle all the IGMP operations in its local subnet while a global HDR (G_HDR) is the HLIM router which is designated/elected to handle all the HLIM operations (i.e., handling global HLIM messages) in its core subnet. Both the HLIM and IGMP election operations will be performed by any HLIM router. The HLIM operations for electing a global HDR is described below.

Once the D_IF and U_IF for every HLIM router have been configured, each HLIM router sets its Hello_WaitRandTimer to [d], where d is a random time between 0 and [HoldTime] (e.g., 2 to 4 seconds).

If the Hello_WaitRandTimer expires, the HLIM router sends a HLIM_P_Hello[pref] into the core subnet via its D_IF and sets its Hello_WaitRandTimer to [HoldTime], where the pref is the preference value of the HLIM router for being elected as a global HDR. A lower pref value indicates that the router is more preferred to be a HDR. This value can be assigned by a network manager or according to the status of network resources. A HLIM_P_Hello[pref] is multicast to all the other HLIM routers in the same core subnet. When the Hello_WaitRandTimer expires, the HLIM router sends out the HLIM_P_Hello[pref] again.

If this router does not get a HLIM_P_Hello[pref] from the neighboring routers via the D_IF within 2×[HoldTime], it will:

Assume itself to be elected as a G_HDR (i.e., the HDR for the D_IF) and sets its pref to zero.

Send a HLIM_P_Hello[0] to its D_IF.

Reset its Hello_WaitRandTimer to [PeriodTime] where [PeriodTime] is greater than [HoldTime].

Send the HLIM_P_Hello[0] again when the Hello_WaitRandTimer expires.

If a HLIM router gets a HLIM_P_Hello[pref] through its D_IF before the Hello_WaitRandTimer expires, it compares the pref value carried in the message with its own pref value.

If the pref is lower than its own pref, or if the pref is equal to its own pref but the source IP address is lower than its own IP address, it resets its timer to the [2×PeriodTime+d].

Otherwise, it ignores the message.

Whenever a HLIM router receive a HLIM_P_Hello[0], it resets its Hello_WaitRandTimer to [2×PeriodTime+d].

If no periodic HLIM_P_Hello[0] message is sent out by the elected HDR (e.g., it has moved away, malfunctioned, or been destroyed), the Hello_WaitRandTimer of one of the other non-G_HDRs will eventually expire first and then send out a HLIM_P_Hello[pref]. The steps (from the second step) above to elect a new G_HDR are then followed.

The election of a L_HDR is performed through the IGMP_Hello message (which also is used to perform for the host mobility detection). The finite state machine defined for the current IGMP querier election in has a stability problem. Due to message loss, timing difference or new router coming, the status of a router in the local subnet may switch back and forth between “elected” and “not elected”. The finite state machine defined for the HLIM election is more stable. We therefore apply the same finite state machine to the local election process. The IGMP_Hello message carries a preference value (pref) to allow for more flexible selection criteria and to be consistent with the HLIM election process. The same pref value should be applied to both IGMP and HLIM election processes.

### Updating HDR Lists

As mentioned previously, the HDR lists are critical to our multicasting protocol. A HDR should get a HDR list from its immediate ascendant HDR when it first starts up or moves to a new location. The retrieval of a HDR list is achieved by two HLIM messages: HLIM_HDR_List_Solicit and HLIM_HDR_List_Update. At other moments, if there is any change in the HDR list (e.g., a HDR is replaced by a newly elected one), the updated list will be forwarded downward from the new HDR through the HLIM_HDR_List_Update message. When a HDR receives the updated HDR list, it sends the list to its descendent core subnet through a HLIM_HDR_List_Update message. The updating operations during network movement have been discussed in the previous chapter. This section will focus on the “unsolicited” updating operations (i.e., the updating is not in response to a solicitation).

Once a HDR is elected, it needs to send its HDR list and its own address and level to its child HDRs. In addition, every HDR can update its HDR list and immediate ascendant HDR (IA-HDR)'s address and level by sending a solicitation to its parent HDR (e.g., when moving to a new location). The updating operations for the HDR list are described below:

After a HLIM router has completed the election process and is elected to be a G_HDR, it will:

Send a HLIM_HDR_List_Solicit to its parent HDR through its U_IF (unless it is the highest router, which will send a HLIM_HDR_List_Update to its child HDRs instead) and then wait for a HLIM_HDR_List_Update from its parent HDR.

Retransmit the HLIM_HDR_List_Solicit, if the HDR does not receive the HLIM_HDR_List_Update within a timeout period, until a HLIM_HDR_List_Update is received or the maximum number of retransmissions is reached.

When a HDR receives a HLIM_HDR_List_Update message from its parent HDR:

It will update its own HDR list and IA-HDR's address and level based on the message received.

If its own level is lower than the IA-HDR's level, it will add IA-HDR's address to the HDR list. It will then send the list together with its own address and level in a HLIM_Hello_Update to its child HDRs.

Otherwise, it will send the HDR list and its own address and level to its child HDRs and local hosts only if the HDR list has been changed.

In order to limit the traffic volume flowing in the HMN, an HDR list is not sent periodically. Instead, it is sent on demand when there is either a solicitation (HLIM_HDR_List Solicit) from an immediate descendant HDR, or a change in the HDR list from an ascendant HDR. For the “unsolicited” update messages, acknowledgment is required to detect and recover any update message loss since the list is not sent periodically. The following scheme is used to increase the reliability of the updated list without knowing the exact number of recipients of the list:

When a HDR receives an updated list, it tries to send out an acknowledgment (HDR_List_ACK) in a similar way to the IGMP_RID_Requst, i.e., start a random timer, send out the acknowledgment if the timer expires or stop the timer when an acknowledgment for the update is received. This is to avoid a burst of acknowledgments sent out from all the child HDRs at the same time.

The HDR that does not receive an acknowledgment within a timeout period after sending out an updated list should retransmit the list.

An update acknowledgment should include the updated list received. This is to give a “second chance” for the other HDRs to receive the list if they have not received it. A host or HDR receives an update acknowledgment (besides an update message) should update its HDR list and IA-HDR's address and level based on the message.

This scheme allows the HDR that sends out the updated list to retransmit the list if no child HDRs receive the list. If at least one HDR receives the list and returns the acknowledgment, such acknowledgment can also update the list in the HDRs that have not received the original update message. In other words, this scheme provides at least two chances for the HDRs to receive the updated list. If higher reliability is required, the updated list can be sent for multiple times instead of only one time.

### HLIM_Compare(E)

When a new HDR is elected, it starts a Compare_Timer and issues a HLIM_Compare(E) message to both its U_IF (i.e., toward its upper core subnet) and D_IF (i.e., toward its lower core subnet). A HLIM_Compare(E) message contains only the source address of the message. The transmission of the HLIM_Compare(E) message will be repeated after a certain time interval for a number of times (≧1) to increase the reliability of this operation. All of the repeated transmissions should be finished before the Compare_Timer expires and the interval between two consecutive transmissions should be longer than the maximum value of the Compare_RandTimer mentioned below.

When a HDR receives a HLIM_Compare(E), it starts a Compare_RandTimer which is a random timer to wait before sending a HLIM_Compare_Reply(E). When the timer expires, the HDR returns a HLIM_Compare_Reply(E) message that contains inbound/outbound GAs associated with either regular or mobile hosts (R/S/MR/MS). Note that a HLIM_Compare_Reply(E) is unicast to the source of the HLIM_Compare(E) message (i.e., the new elected HDR).

When the Compare_Timer expires, it analyzes all the in/outbound GAs received in the HLIM_Compare_Reply messages collected during the timer period, and sets up its own R_MFC and S_MFC lists accordingly. No join or prune operation is required.

If the new HDR replaces the RID of the GA of an on-going multicast session, it will invoke the HLIM_Flush operation to update the forwarding caches of the established multicast tree. The HLIM_Flush is sent both upward and downward through the whole multicast tree.

The new HDR elected will send a HLIM_Flush[old RID, new RID] to any D_IF and U_IF listed in the affected caches its R_MFC and S_MFC lists, and an IGMP_Flush[old RID, new RID] to the L_IF if it is listed in the caches.

When a HDR receives a HLIM_Flush, it will check if it has any forwarding caches with the old RID.

If matches are found, it will update the caches with the new RID. It will then forward the HLIM_Flush to the Outg_IF (U_IF or D_IF) indicated in the caches, except the incoming interface of the message, and IGMP_Flush to the L_IF if it is listed in the caches.

Otherwise, it will ignore the message.

When a host receives an IGMP_Flush, it will update its own records for any active multicast sessions of the old RID.

Note that the new HDR elected may send the HLIM_Flush and IGMP_Flush for several times to recover any loss of these messages.

### Reliability on HLIM Control Operations

The HLIM protocol design (the previous one and the enhanced one) takes reliability into account. Reliability measures are built into the design of the present invention. The following table summarizes the reliability schemes applied to the protocol messages. Three main schemes are used to handle protocol message loss and increase the reliability at the HLIM protocol level. Additional reliability can be provided by the lower layers (such as forward error correction, automatic repeat request, etc.) but they are outside the scope of the HLIM design. The three reliability schemes used in HLIM are described below:

1. Periodic transmission—Some of the HLIM/IGMP messages are transmitted periodically. If one of them is lost, another one will always be sent some time later.

2. Acknowledgment and retransmission—Two-way handshake is applied to some of the HLIM/IGMP messages. If the acknowledgment of a protocol message is not received by the message originator within a timeout period, the message will be retransmitted until the maximum number of trials (the maximum number is chosen according to the target operating environments).

3. Multiple transmissions—In some cases, two-way handshake cannot be implemented. Multiple transmissions will be used instead. A protocol message will be sent consecutively for multiple times (the number of transmissions is chosen according to the target operating environments). Even if one of them is lost, the target recipient has other chances to receive the message.

TABLE 2
the Methods Applied for Increasing Reliability in HLIM Operations

| | Methods of Reliable |
|---|---|
| HLIM Control Operations | Transport for Control Message |
| Regular Membership Operation | Periodic transmission |
| IGMP_Query | |
| IGMP_Report | |
| IGMP_Leave | |
| Mobile Membership Operation | Acknowledgment and retransmission |
| IGMP_M_Report | |
| IGMP_M_Reply | |
| RID obtaining Operation | Acknowledgment and retransmission |
| IGMP_RID_Request | |
| IGMP_RID_Reply | |
| Host Mobility Detection | Periodic transmission |
| IGMP_Hello | |
| RID Updating Operation (in local) | Multiple transmissions |
| IGMP_Flush | |
| Join Operation | Acknowledgment and retransmission |
| HLIM_Join | |
| HLIM_ACK | |
| HLIM_M_Join | |
| HLIM_M_ACK | |
| Network mobility detection | Periodic transmission |
| HLIM_P_Hello | |
| HLIM_C_Hello | |
| HDR List Updating Operation | Acknowledgment and retransmission |
| HLIM_HDR_List_Solicit | |
| HLIM_HDR_List_Update | |
| HLIM_Compare(E) Operation | Multiple transmissions |
| HLIM_Compare(E) | |
| HLIM_Compare_Reply | |
| HLIM_Compare(M) Operation | Acknowledgment and retransmission |
| HLIM_Compare(M) | |
| HLIM_Compare_Reply | |
| Prune operation | Multiple transmissions |
| HLIM_Prune | |
| HLIM_Prune_Reply | |
| HLIM_M_Prune | |
| HLIM_M_Prune_Reply | |
| Network Join Operation | Acknowledgment and retransmission |
| HLIM_Net_Join | |
| HLIM_Net_Join_ACK | |
| RID updating operation (in global) | Multiple transmissions |
| HLIM_Flush | |

### Forwarding Cache Maintenance Operations

After a forwarding cache is established through HLIM_Join or HLIM_M_Join operation, it must be maintained: to refresh any valid entry and delete any invalid entry, and detect and recover any missing entries in the other HDRs. There are two ways to maintain forwarding caches: event-driven (hard state) and periodic (soft state) approaches.

The soft state approach is simple to operate and drives quick synchronization of forwarding cache, but the control overhead due to the periodic messaging is significantly high, which is not adequate to the wireless environment where the bandwidth is a critical issue. In the hard state approach, the forwarding caches are maintained exclusively through more complex operations in the response to the event such as the group membership leave, the network movement, HDR election etc. Since the control overhead is generated only when such the events take place, this approach is more appropriate to the wireless environment.

This is the periodic version of the HLIM_Compare operation. Every HDR sends a HLIM_Hello message in its U_IF and D_IF periodically (every [Hello_PeriodTime]) if it has forwarding caches. A HLIM_Hello message sent to a core subnet attached to a particular interface (U_IF or D_IF) carries the list of inbound group addresses and outbound group addresses. Furthermore, the HLIM_Hello message should indicate whether an inbound or outbound group address was created by a source or receiver.

Before the HDR sends out a HLIM_Hello message to its U_IF and D_IF, it starts its Prune_Timer (if it is not running) which is set at twice the HLIM_Hello period (2×[Hello_PeriodTime]), and Join_Timer (if it is not running) which is set at the HLIM_Hello period. If the HDR receives any HLIM_Hello message from a particular interface, it will process the message as follows:

If inbound group addresses are attached in the message, it compares those addresses with its own outbound group addresses for that interface.

If it has no outbound group addresses in its own forwarding cache list, it ignores the inbound group addresses received.

Otherwise, if its own outbound group address entries are created by sources, it refreshes those outbound group addresses that match with the source-created inbound group addresses received.

If the outbound group address entries are created by receivers, it marks those outbound group addresses which have no match in the receiver-created inbound group addresses received.

If outbound group addresses are attached in the message, it compares those addresses with its own inbound group addresses for that interface.

If it has no inbound group addresses in its own forwarding cache list, it ignores the outbound group addresses received.

Otherwise:

If its own inbound group address entries are created by a source, it marks those inbound group addresses which have no match in the source-created outbound group addresses received.

If its inbound group address entries are created by a receiver, it refreshes those inbound group addresses that match with the outbound group addresses received.

When the Prune_Timer expires, the HDR deletes all the interfaces in its forwarding cache list which have not been refreshed. When the Join_Timer expires, the HDR invokes HLIM_Join (if RID=its HDR(H+1)) or HLIM_M_Join (if RID≠its HDR(H+1)) for all the marked interfaces in the forwarding cache list. Note that before the Prune_Timer expires, the other HDRs in its core subnets should have sent two HLIM_Hello messages. In other words, the HDR deletes those interfaces in the forwarding cache list not refreshed for two HLIM_Hello periods.

### EVENT-DRIVEN MAINTENANCE: PRUNE OPERATIONS

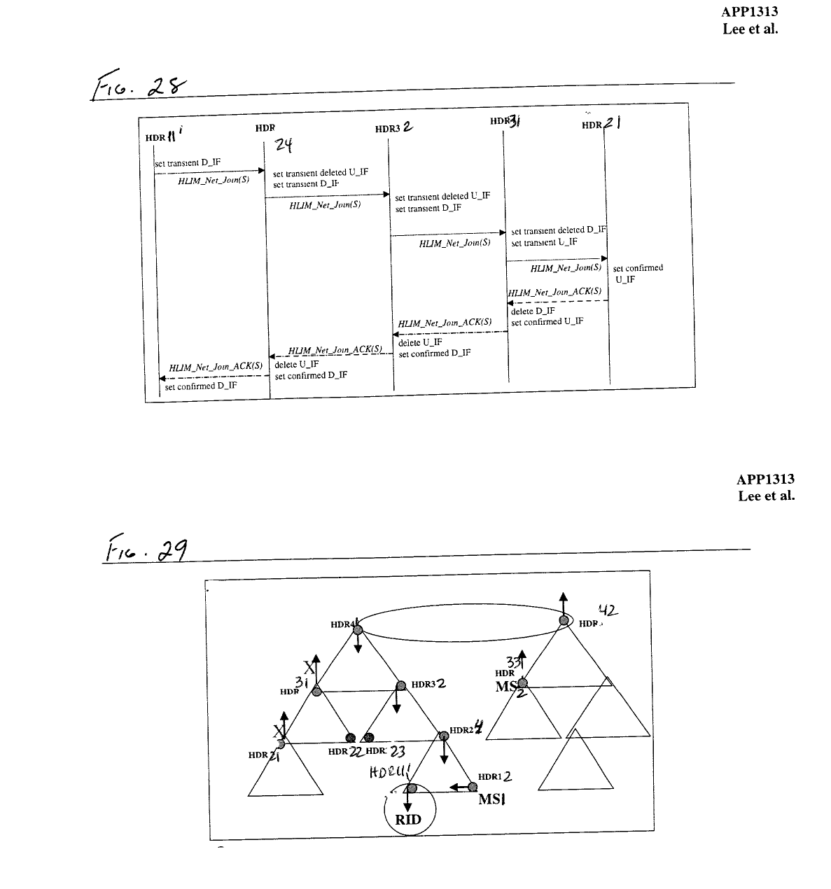

FIGS. 32 and 33 provide examples of a source prune operation. The following events result in an invocation of the prune operation at a HDR:

(1) when the R_MFC for a GA is deleted (e.g., after a multicast receiver moves away or leaves the multicast group),

(2) when an unmatched GA is found through the HLIM_Compare(M) operation (e.g., after a network movement),

(3) when a local source moves away or leaves the multicast group.

### For HLIM_Prune(S) and HLIM_M_Prune(S)

When a GA is registered in the source group membership list in a HDR, a prune timer is set for the GA. The timer is refreshed by IGMP_Report, which is sent in response to the periodic IGMP_Query.

If the prune timer expires, the router HDR21 in FIG. 32 and FIG. 33 deletes the GA from the membership list and is ready to prune the associating outgoing interface (D_IF (down arrow) or U_IF(up arrow)) for the GA listed in the S_MFC.

It sets a prune timer (Prune_Expire_Timer) for the outgoing interface and issues a number (≧2) of source prune messages (HLIM_Prune(S) or HLIM_M_Prune(S)) opposite to the listed outgoing interface (one after another separated by a certain time interval). For instance, the message is sent to D_IF if U_IF is listed in S_MFC. This repeated transmission increases the reliability of the message especially required in the tactical network.

If no prune reply (HLIM_Prune_Reply(S) or HLIM_M_Prune_Reply(S)) arrives from the interface to which the source prune message has been sent before the prune timer expires, the S_MFC is deleted and a source prune message is issued through the outgoing interface of the cache just deleted (i.e., toward the RID of the GA). Otherwise, it keeps the listed outgoing interface.

When a HDR receives a source prune message, it checks whether the GA is listed in its S_MFC list or not. If the GA is not listed, it (e.g., HDR11 in FIG. 37) will discard the prune message. If the GA is listed, it will compare the Outg_IF of the GA listed in the S_MFC with the incoming interface of the prune message received.

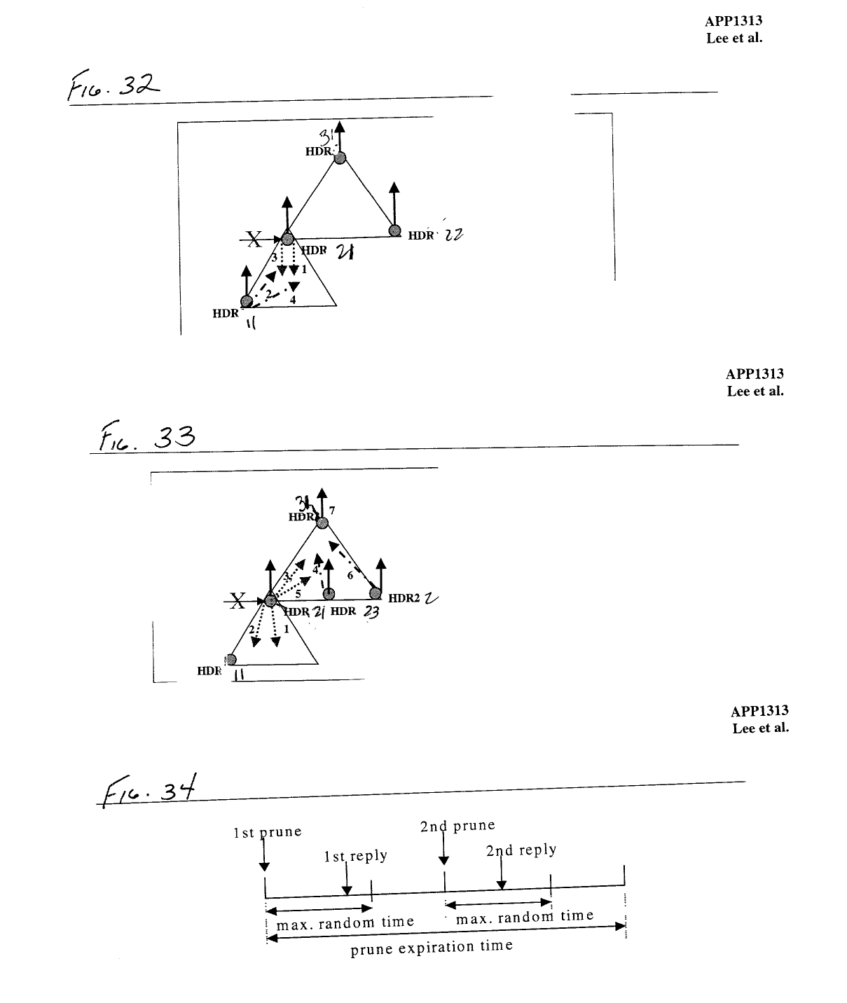

If the listed Outg_IF is the same as the incoming interface, the router (e.g., HDR11 in FIG. 36, HDR22, HDR23 in FIG. 37) sets a prune random timer (Rand_ReplyTimer) and then returns a prune reply (HLIM_Prune_Reply(S) or HLIM_M_Prune_Reply(S)) as the random timer expires. If it receives a prune reply message while the random timer is running, it stops the timer.

If the listed Outg_IF is not the same as the incoming interface, the HDR (e.g., HDR31 in FIG. 37) checks if there is a member of the GA in its source membership list.

If yes, it ignores the source prune message received.

Otherwise, it sets a prune timer on the listed Outg_l F and waits for a prune reply. If it doesn't receive a prune reply before the prune timer expires, it will delete the S_MFC and sends a number of source prune messages separated by a certain time interval through the outgoing interface which has just been deleted (i.e., toward the RID of the GA). If it receives a prune reply before the timer expires, it will keeps the listed Outg_l F. If it receives the same source prune message again while the timer is running, it ignores the message.

This operation proceeds to the HDR(H) for S (i.e., sources remaining inside the multicast scope region) and RID for MS (sources having moved out of the multicast scope region).

Because a number of repeated prune messages are issued during the prune operation, the same number of prune reply messages will be responded by the other HDRs (unless there is message loss due to bad wireless channel condition). The subsequent prune and prune reply messages seem to be redundant but they are definitely required to increase the reliability of the operation. Note that the total time needed to transmit all the prune messages should be shorter than the expiration of the prune timer, and the interval between two consecutive messages should be longer than the maximum expiration time of a random reply timer.

In FIG. 32 in step 1 router HDR21 sends a first prune message. Router HDR11 replies to the first prune message in step 2. In step 3 router HDR21 sends a second prune message and after step 4 in which router HDR11 sends another reply to router HDR11 the operation stops.

In FIG. 33 in steps 1 and 2 router HDR21 sends a first and second prune messages to D_IF. There is no reply to either prune message. Because there is no reply in step 3 router HDR21 sends a first prune message to the U_IF. In step 4, router HDR23 replies to the prune message sent by router HDR21. In step 5, router HDR21—sends the second prune message to the U_IF. Router HDR22 replies to the second prune message in step 6 and router HDR31 keeps the U_IF in step 7 and the operation stops.

Once HDR21 detects no source on the local subnetwork, it sets two timers, a prune timer and prune tramsission timer, and a prune-reply counter. The prune timer is set to prune the outgoing interface listed in its S_MRF (i.e., U_IF) and the prune transmission timer is set for issuing the second prune message. The prune reply counter counts the number of received prune-reply messages. It sends the first prune message to D_IF. As the prune transmission timer expires, it sends a second prune message.

When router HDR11 receives the first prune message through its U_IF which is the same as that listed in its S_MFC, it sets a prune random timer first and then sends a prune reply message after the random timer expires. It does the same for the second prune message received.

The counter on router HDR21 keeps counting the number of the received prune reply messages until its prune timer expries. When the prune timer expires, router HDR21 checks the number indicated on the counter. If the number is greater than 0, HDR21 keeps the outgoing interface (U_IF).

In the case of FIG. 33, HDR21 first sends out the prune messages as described in the previous example through its D_IF. Since HDR21 doesn't receive any prune reply message, the prune reply counter on HDR1 is zero. It then deletes the outgoing interface (U_IF) and sends the first prune message through the deleted outgoing interface.

Once routers HDR22 and HDR23 receive a prune message, each of them sets a prune reply random timer since both of them have the outgoing interface which is the same as the incoming interface of the prune message received. As one of the timers expires while the other one is still running, a prune reply message is sent out by the HDR with the expired timer. When the other HDR with a running timer receives the prune reply message, it will suppress its prune reply message by stopping its timer.

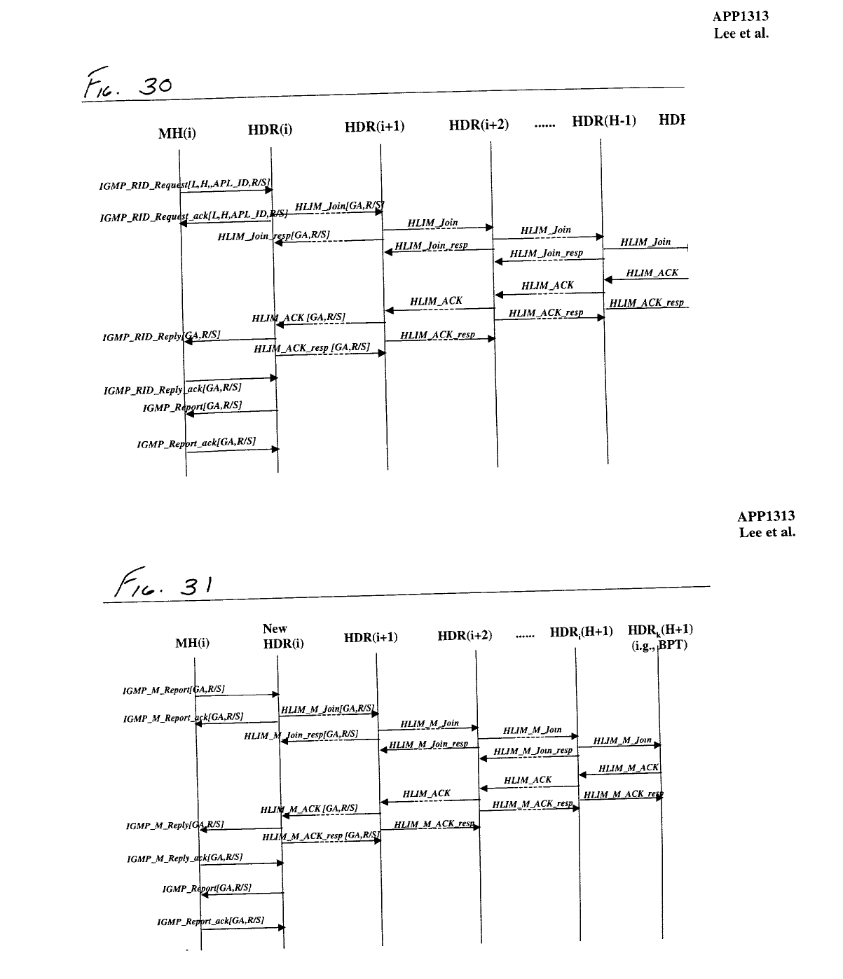

When router HDR31 receives a prune message from router HDR21, it sets a prune timer and prune reply counter, and waits for prune reply messages. If it receives a prune reply message from either router HDR22 or HDR23, it will increment the counter. In this case, it will receive two prune reply messages, each one from HDR22 and HDR23, unless the messages are lost due to bad wireless channel condition during the transmission. Since the number on the counter (2) is greater than 0, it will keep the outgoing interface. If it receives the second prune message from HDR1 while its prune timer is running (which has been initiated by the first prune message), it will discard the second prune message. FIG. 34 shows the message sequence in time at router HDR31 of FIG. 33.

### For HLIM_Prune(R) and HLIM_M_Prune(R)

When a GA is recorded in the receiver group membership list in a HDR, a prune timer is set for the GA. If the prune timer expires, the HDR deletes the GA from the membership list and the L_IF from the Outg_IF list of the R_MFC. The timer is refreshed by IGMP_Report, which is sent in response to the periodic IGMP_Query.

When the Outg_IF list of the R_MFC for a GA becomes empty, the HDR (e.g., HDR1 in FIG. 39) deletes the R_MFC and sends a receiver prune message (HLIM_Prune(R) or HLIM_M_Prune(R)) toward the RID of the GA. As in the previous operation, a number (≧2) of prune messages are issued for the reliability reason.

Upon receiving a receiver prune message, a HDR finds a match for the GA in its R_MFC list.

If it finds a match, it compares the incoming interface of the prune message with the Outg_IFs listed in its R_MFC of the GA.

If it has an Outg_IF which is the same as the incoming interface, it (e.g., HDR2, HDR4 in FIG. 39) sets a prune timer for that Outg_IF and a prune reply counter, and waits for a prune reply message (HLIM_Prune_Reply(R) or HLIM_M_Prune_Reply(R)).

As the HDR receives a prune reply message(s) before the prune timer expires, it increments the counter. When the prune timer expires, it checks the counter and it will keep the listed Outg_IF if the number on the counter is greater than 0. If it receives the same receiver prune message again while the timer is running, it ignores the message.

If it doesn't receive any prune reply before the timer expires (i.e., the number on the counter is zero), it deletes the listed Outg_IF and checks whether the Outg_IF list for the GA is empty or not (since L_IF may still be listed). If the list is empty, it sends a receiver prune message through the interface opposite to the deleted interface (i.e., toward the RID).

If the Outg_IF list of the R_MFC includes the L_IF or the interface opposite to the incoming interface, it (e.g., HDR3 in FIG. 39) sets a prune random timer and sends a prune reply message (HLIM_Prune_Reply(R) or HLIM_M_Purne_Reply(R)) if the prune random timer expires. If it receives a prune reply message before the time expires, it stops the timer.

This operation proceeds to the HDR(H) for R (i.e., receivers remaining inside the multicast scope region) and RID for MR (receivers having moved out of the multicast scope region).

Similar to the source prune message, the receiver prune message is transmitted several times to increase the reliability of the operation.

FIG. 35 shows an example of the receiver prune operation, assuming the prune message is sent twice.

Once router HDR11 finds that the R_MFC for a GA is empty, it issues the first receiver prune message through the interface opposite to the deleted Outg_IF (i.e., U_IF) in step 1 and sets a prune transmission timer for sending the second prune message in step 2.

If router HDR21 receives a prune message, it sets a prune timer for the listed Outg_IF (i.e., D_IF) and a prune reply counter for counting incoming prune reply messages. As the prune timer expires, router HDR21 checks the number on the counter. In this case, the number is zero since no prune reply message is received. Thus, router HDR21 deletes the listed Outg_IF in step 3, and sends a first prune message step 4 and sets a prune transmission timer as the router HDR11 did.

Upon receiving a prune message, router HDR22 sets a prune random timer since the incoming interface of the prune message is opposite to the Outg_IF listed in its R_MFC. At step 5, router HDR22 responds a prune reply message when the prune random timer expires. In this case, it responds a second time at step 7 since it receives a second prune messages from router HDR21 at step 6.

When router HDR41 receives a prune message from router HDR21, it sets a prune timer and a prune reply counter since the incoming interface of the prune message is the same as the Outg_IF listed in its R_MFC. Whenever router HDR41 receives a prune reply message, it increments the counter. In this case, the number on the counter (2) is greater than 0 when the prune timer expires. Thus, it keeps the listed Outg_IF at step 8 and the operation stops.

### Message Formats of HLIM

The format of the HLIM Group Address (“GA”) is structured as shown in FIG. 36. It is 64-bit in total length. The “1110” in field 201 indicates a class D IP address (i.e., multicast address). The length of the scope field 202 is 4-bit: 2 bits for each H and L. This field can be adjusted according to the highest level of hierarchy. The rest of the 32-bit destination address field 205 is specified by APL_ID field 203; 2²⁴ different multicast sessions can be generated in a given scope region. “RID” field is 32-bit of a unicast IP address since we assume that RID is represented by the IP address of a HDR.

In the IP header of a HLIM multicast packet, the first 32 bits of the GA is placed in the destination address field 205 while the remaining 32 bits (i.e., RID) of the GA is implemented in the IP option field 206 as shown in FIG. 37.

The first 4-bit field in an IP header, “vers”, contains the version of the IP protocol that was used to create the packet. All IP software is required to check the version field before processing an IP packet to ensure it matches the format the software expects. The current IP protocol version is 4. The header length field 204 “hlen” indicates the IP header length measured in 32-bit words. In HLIM, the header length is 7 (i.e., 28 bytes comprised of 20 bytes of minimum IP header plus 8 bytes of the IP Option for HLIM). The 8-bit “Service type” field 207 specifies how the packet should be handled especially in selecting routing paths. The “Total Length” field 208 gives the length of the IP packet measured in bytes, including bytes in the header and data. Since the field is 16 bits long, the maximum possible size of an IP packet is 2¹⁶ or 65,535 bytes. Three fields in the header, the “Identification” field 209, the “Flags” field 210, and the “Fragment Offset” field 211, control fragmentation and reassembly of packets. The details are specified in DoD Standard Internet Protocol, RFC 760,January 1980, ISI of University of Southern California. The field “Time to Live” (TTL) 212 specifies how long, in the number of hops, the packet is allowed to remain in the network. Each router along the path from source to destination is required to decrement the TTL by 1 when it processes the packet. Whenever the field reaches zero, the router discards the packet. For the both IGMP and HLIM control packets, the TTL of 1 is set by a source (i.e., the control packets traverse only one hop of local hosts or neighboring HDRs).

The value in the field “Protocol” 213, so called ‘Protocol Number’, specifies which high-level protocol (e.g., TCP, UDP, IGMP, ICMP, etc located right above IP layer in the layered protocol stack) was used to create and supposes to process the message. All the protocol numbers currently used are defined in RFC 1010. For example, the Protocol Number 17 is assigned for UDP, 6 for TCP, and 2 for IGMP. For HLIM multicast data packets which are transported through UDP, the value of the field is 17, whereas 2 is the value for IGMP and HLIM control messages (i.e., control messages from a HDR) because the control messages are transported through the Raw Socket associated with IGMP protocol. The more details will be described in the next chapter. The field “Header Checksum” 214 ensures integrity of header values.

The field “Source IP Address” 215 contains the 32-bit IP address of the packet's sender. The field “Destination IP Address” 205 contains the 32-bit class D_IP address. It is broken down into three subfields for the HLIM protocol: “1110” specifies that the packet is destined to a multicast session (or group), the subfield “L” and “H” represents the lowest and highest level to which the packet can traverse, and “Application ID” (APL_ID) specifies the particular multicast service. In a given scope region, 2²⁴ different multicast services can be generated. For the multicast control packets such as the IGMP and HLIM control packets, this field can also be assigned by the all-host group address, 244.0.0.1, which is the well-known group address registered by the Internet Assigned Numbers Authority (IANA), or the all-HLIM router group address, 244.0.0.22, which has been selected from the unregistered group address range from 224.0.0.12 to 224.0.0.255. More details on this field for such control packets will be described in the next subsection.

Eight-byte RID option is added to the IP header for each and only multicast data packet (which is not an IGMP or HLIM multicast control packet) in HLIM. The first 2 bytes have no meaning rather than the means of padding. The third byte, “OPT_TYPE”, specifies different IP Options and is represented by a number assigned to a specific IP Option. Since we are introducing the RID option as a new IP Option, we can choose any number that has never been used for the up-to-date implementation of IP Option. The next field “OPT_LENGTH” specifies the number of bytes used for this option. It includes bytes of all the option information, “OPT TYPE” and “OPT_LENGTH”, and option data, “RID”, in this case. Thus, 6 will be indicated in the “OPT_LENGTH” field for the RID option. “UDP DATA” is the payload of an IP multicast data packet. It is the UDP message because a multicast application uses an UDP socket.

### Formats and Specification of IGMP Messages (Local HLIM messages)

The IGMP_Report and Query messages defined in IGMP version 2 should be modified to adapt the new HLIM group address shown in FIG. 36. The IP address of a root HDR is chosen as the RID. In order to be backward compatible with the existing IGMP, these modified IGMP_Report and Query messages should be assigned new IGMP message types. New IGMP message types should also be introduced for the new messages: IGMP_M_Report, IGMP_M_Reply, IGMP_RID_Request, IGMP_RID_Reply, IGMP_Hello, and IGMP_Flush.

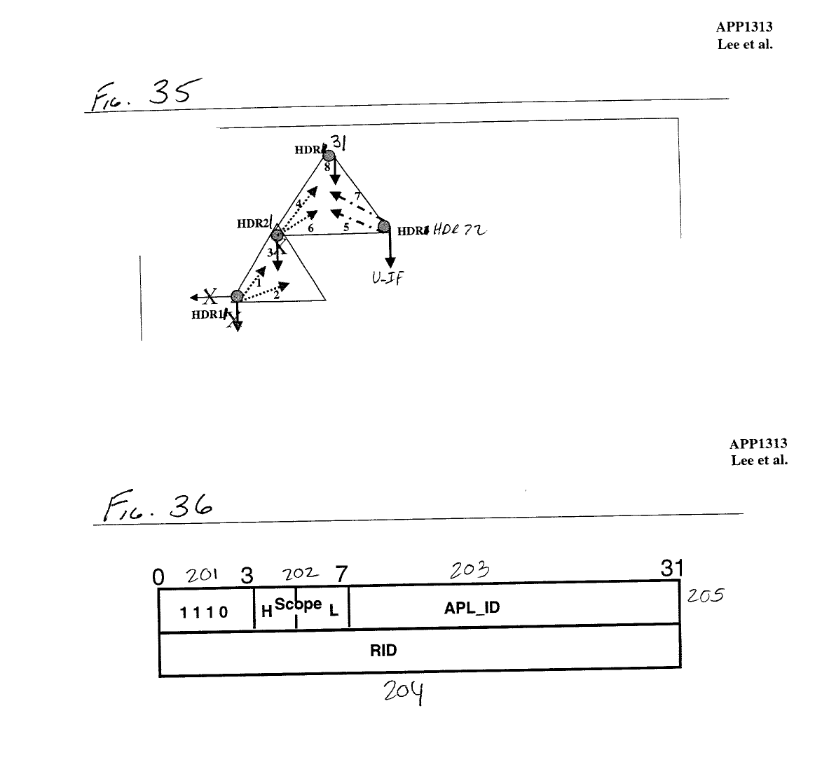

All of the IGMP messages share the same packet header shown in FIG. 38.

“Type” 220 is an 8-bit field specifying the type of the message. The following types are assigned to the IGMP messages:

type 15: IGMP_RID_Request

type 16: IGMP_RID_Reply

type 17: IGMP_Query

type 18: IGMP_Leave

type 19: IGMP_Specific_Query

type 20: IGMP_Report

type 21: IGMP_M_Report

type 22: IGMP_M_Reply

type 23: IGMP_Hello

type 24: IGMP_Flush

type 25: IGMP_HLIM

“Code/Max Resp Time” 221 is an 8-bit field. It specifies the type of the global HLIM message if the type field is assigned to IGMP_HLIM (type 25) or the maximum allowed time before sending a response to a IGMP Query if the type filed is assigned to IGMP_Query (type 17). Besides, it has no meaning so it should be set to zero. “Checksum” 222 is a 16-bit field carrying the 16-bit one's complement of the one's complement sum of the whole IGMP message (i.e., the entire IP payload).

The IP header for IGMP messages is shown in FIG. 39. TTL 212 is 1 since the message is expected to be transported from a host to the associated HDR within a local subnet. “Protocol” 213 is 2 which is IGMP Protocol because the message supposes to be passed to the user level process (i.e., HLIM daemon) through the Raw Socket with IGMP Protocol. “Destination IP address” 205 will be assigned according to a message type.

### IGMP_RID_Request

The format of IGMP_RID_Request is shown in FIG. 40. An IGMP_RID_Request message is used by a host to request for the RID for the given scope region specified by the scope field, L and H. The “type” field 221 is assigned by 15. Since this message is an IGMP message (i.e., the messages used between hosts and a router), the “code” field 221 is not specified. The eight-bit “class” field 225 is assigned by ‘R’ for receiver or ‘S’ for source. The eight-bit “future use” field 226 will be used for the future enhancement of HLIM protocol. The 16-bit “port” field 227 identifies the port number of UDP multicast data socket. It specifies the particular multicast session within a host.

Once a host (in fact the kernel) obtains the scope field from a multicast application (through the system call, setsockopt( ), from the application), it will request for the RID for the scope region associated with the scope field by sending the IGMP_RID_Request message. Upon receiving the IGMP_RID_Request, the local HDR (i.e., the HDR having L_IF) obtains the RID from its HDR list and replies with the IGMP_RID_Reply after completing the regular join operation.

### IGMP_RID_Reply

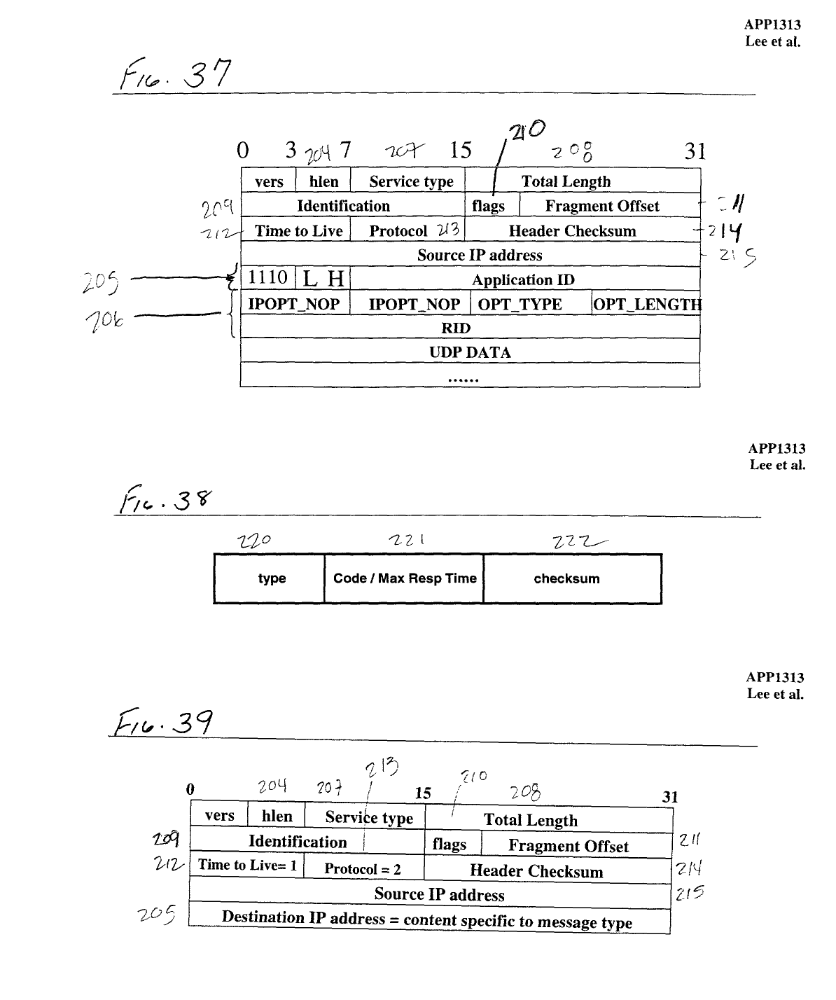

The IP header for an IGMP_RID_Request message is shown in the FIG. 41. The destination IP address 205 of IP header is the same as the second 32-bit of an IGMP_RID_Request message, [0001;L,H;APL_ID], which has been given from the multicast application at the user level. Consequently, the other hosts with the same multicast application and the associated HDR that accepts every multicast packet accept and process the IGMP_RID_Request message.

A host which has issued an IGMP_RID_Request message processes the IGMP_RID_Reply message corresponding to the IGMP_RID_Reqest message. The host acquires the complete HLIM GA from the message and records the HLIM GA into its HLIM GA list. Thereafter it sends IGMP_Report messages in response to periodic IGMP_Query messages and is able to receive and/or send HLIM multicast packets associated with the HLIM GA. The other hosts ignore the IGMP_RID_Reply message.

Since this message should be received and processed by every host in the local subnet, the destination IP address 205 must be assigned by the all-host group address, 244.0.0.1.

### IGMP_Query

FIG. 42 shows the format for an IGMP_Query. An IGMP_Query message is periodically issued by a HDR having L_IF. The type field 220 is set at 17. The query period in the “code/maxresp time” field 221 is adjustable. In the case of presence of multiple HDRs in a local subnet, one of the HDRs is elected as an IGMP querier by the local HDR election so that periodic IGMP_Query messages are issued only by that IGMP querier. If a host receives an IGMP_Query message, it sends the IGMP_Report message for each multicast session (for a receiver or sender) in respond to the IGMP_Query message within “max resp” time. A host without any multicast session will not respond to an IGMP_Query message. Since this message should be received and processed by every host in the local subnet, the destination IP address 205 of IP header (not shown) must be assigned by the all-host group address, 244.0.0.1. Note that every host joins the all-host group address at boot time.

### IGMP_Specific_Query

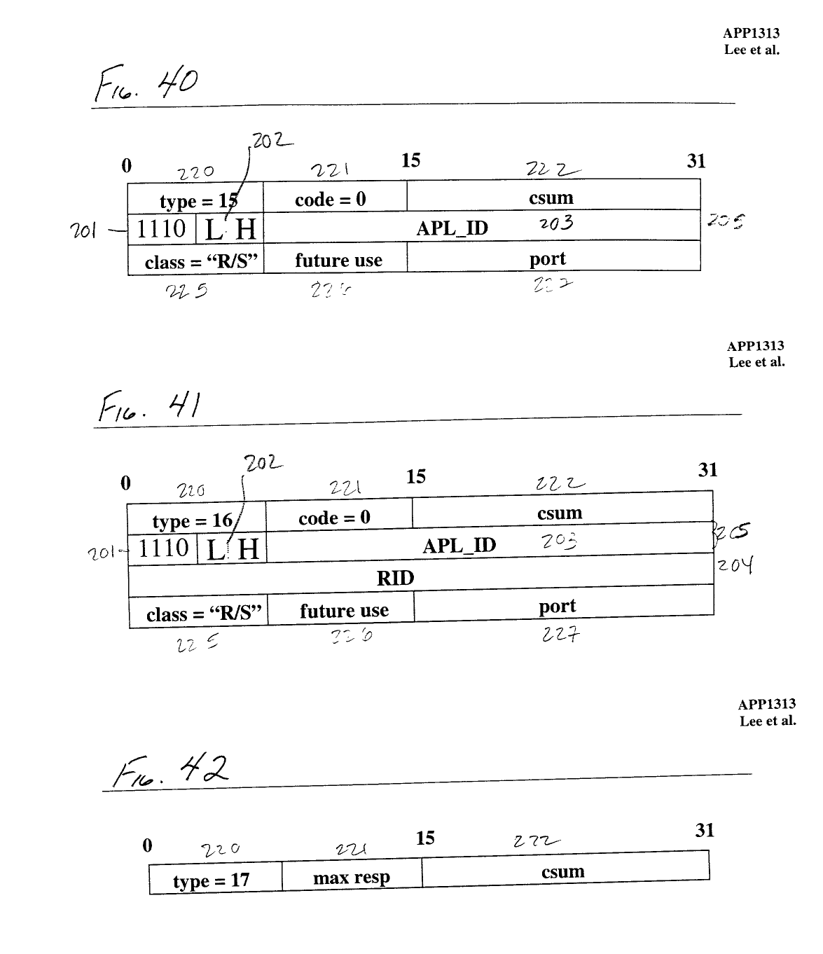

FIG. 43 shows the format for a certain set of messages including IGMP_Specific_Query. An IGMP_Specific_Query message is used by a HDR (i.e., an IGMP querier) to request for an IGMP_Report from hosts having a specific multicast session specified in the IGMP_Specific_Query message (i.e., the HLIM GA). When a host receives this message, it looks for the specific multicast session in its multicast database and then, if it finds the multicast session, it will send an IGMP_Report for the multicast session with in the “max resp” time. The destination IP address 205 of IP header is the same as the second 32-bit of this IGMP message, [0001;L,H;APL_ID], so only host engaging this destination IP address can accept and process the message. “Future Use” field 226 is three bytes in the IGMP_Specifc Query.

### IGMP_Leave

FIG. 43 also shows the format for an IGMP_Leave message. For IGMP_Leave the type field 220 would contain value 18. A host that wants to stop a multicast session issues an IGMP_Leave message. The message includes the HLIM GA of the multicast session. If a HDR receives the message, it will issue an IGMP_Specific_Query to its local subent. If other hosts have the same multicast session, they immediately set a random timer for sending an IGMP_Report for the HLIM GA. Only one of them whose timer expires first sends the IGMP_Report. This operation is the same as the existing IGMP operation. Since this message is processed only by the associated HDR, the destination IP address 205 of IP header for this message should be the all-HLIM group, 224.0.0.22.

### IGMP_Report

FIG. 43 also shows the format for an IGMP_Report message. For the IGMP_Report message the type field 220 would contain value 20. In response to a periodic IGMP_Query, IGMP_Specific_Query, or IGMP_Leave, a host sends an IGMP_Report message(s) as in the existing IGMP operations. In order to suppress the duplicate reports from other hosts engaging the same multicast session, the destination IP address 205 of IP header for this message must be the same as the [0111;L,H;APL_ID] in the message format. Thus, other hosts not engaging the multicast session can discard the message by their device level multicast filtering.

### IGMP_M_Report

FIG. 43 also shows the format for an IGMP_M_Report message. For IGMP_M_Report message the type field 220 would contain value 21. As soon as a mobile host engaging in a multicasting session detects its movement, it must promptly inform that it wants to keep engaging in the multicasting session by sending an IGMP_M_Report to the HDR at a new location. A IGMP_M_Report contains the HLIM GA for the multicast session.

If a local HDR receives the message, the HDR first searches for a match for the HLIM GA indicated inside the message, in its local group membership database. If a match is found, no further actions will be taken place. Otherwise it records the HLIM GA in its local group membership database and determines whether the mobile host has moved within or outside of the scope region. If it moved within the scope region, then the HDR invokes the HLIM_Join operation. Unless, it invokes the HLIM_M_Join operation. The destination IP address 205 of IP header for this message must be the same as the [0111;L,H;APL_ID] in the message format.

### IGMP_M_Reply

FIG. 43 also shows the format for an IGMP_M_Reply message. For IGMP_M_Reply the type field 220 would contain value 22. An IGMP_M_Reply message is issued by a HDR in response to an IGMP_M_Report. Once a mobile host which has originated an IGMP_M_Report receives an IGMP_M_Reply, it can now forward or receive multicast packets associated with the HLIM GA indicated in the message. The destination IP address 220 of IP header for this message must be the same as the [0111;L,H;APL_ID] in the message format.

### IGMP_Hello

FIG. 44 shows the format for an IGMP_Hello message. An IGMP_Hello message is periodically generated by a local HDR. The period of the message can be adjusted according to the rate of host mobility. The current period is around 2 seconds. This message is used to support the host mobility. Upon receiving the message, a host checks the source of the message. If the host detects the change of the source (e.g., a local HDR), it will assume that it has moved to a new location and issue an IGMP_M_Report to the local HDR at the new location. Since this message must be processed by both the hosts and associated HDR, the destination IP address of IP header for the message (not sown) should be the all-host group, 224.0.0.1.

### IGMP_Flush

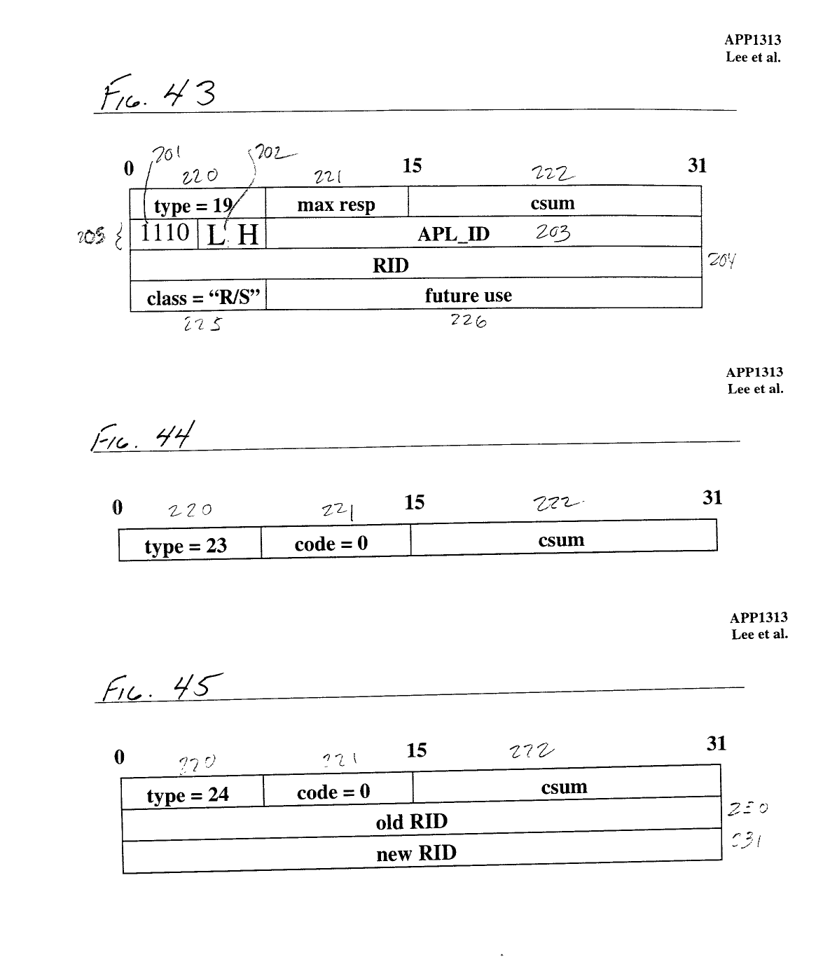

FIG. 45 shows the format for an IGMP Flush message. This message is to update the existing records of any active multicast sessions whose RID has been changed to a new RID. The “old RID” field 230 carries the previous RID (e.g., corresponding HDR's IP address) and the “new RID” field 231 carries the new RID (i.e., newly elected HDR's IP address). Whenever a local HDR receives a HLIM_Flush message from interfaces other than L_IF (i.e., U_IF or D_IF), it issues an IGMP_Flush into its local subnet. If a host in the subnet receives the message, it will scan out its local group membership database to match the old RID. If a match is found, it will update the database as replacing the old RID with the new RID. Unless it discards the message. Since this message must be processed by both the hosts and associated HDR, the destination IP address (not shown) of IP header for the message should be the all-host group, 224.0.0.1.

### Formats and Specifications of Global HLIM Messages

Global HLIM messages are used to provide the global operations such as the HLIM join, prune, HDR update, HDR global election, configuration operations among HDRs. The format of a HLIM control message and its IP header are shown in FIG. 46. The flow of HLIM messages is preferably limited to one hop distance (between neighboring HDRs), and hence, the value of TTL field 221 is 1. The IP protocol field 213 is 2 (i.e., IGMP protocol) because the messages are transported through the Raw Socket with IGMP protocol. (Note that, in the HLIM implementation, each HDR creates the process (i.e., HLIM daemon at user level), opens the Raw Socket with IGMP protocol, and then the process receives and sends the HLIM control messages through the opened socket.

The following codes are assigned to the HLIM control messages in the code field 221:

code 1: HLIM_Join

code 2: HLIM_M_Join

code 3: HLIM_HDR_List_Update

code 4: HLIM_HDR_List_Solicit

code 5: HLIM_ACK

code 6: HLIM_M_ACK

code 7: HLIM_Prune

code 8: HLIM_Prune_Reply

code 9: HLIM_M_Prune

code 10: HLIM_M_Prune_Reply

code 11: HLIM_P_Hello

code 12: HLIM_C_Hello

code 13: HLIM_Net_Join

code 14: HLIM_Net_Join_ACK

code 15: HLIM_Flush

code 16: HLIM_Conf_Hello

code 17: HLIM_Compare(E)

code 18: HLIM_Compare_Reply

code 19 HLIM_Compare(M)

### HLIM_Join

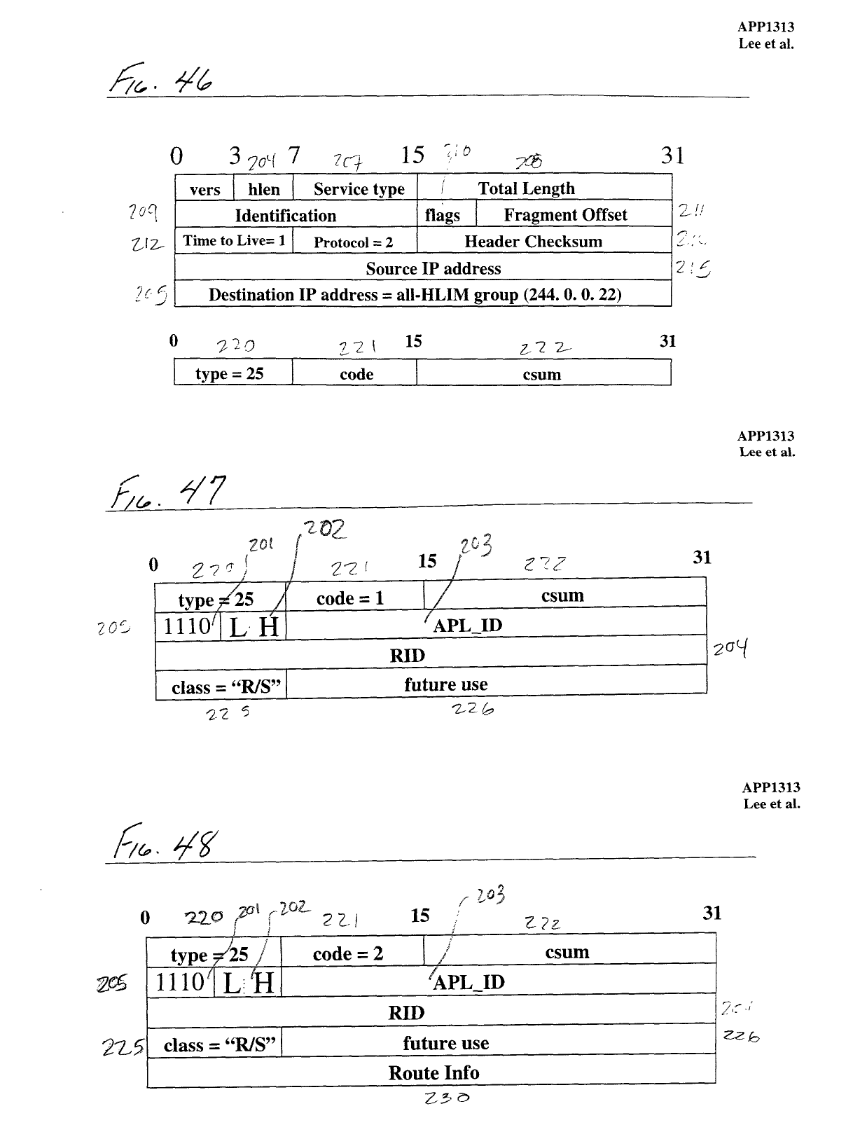

FIG. 47 depicts the format for a certain set of message including the HLIM_Join message. Type field 220 contains value 25 for the HLIM_Join message. Code field 221 contains value 1. This message is used to create a new multicast tree or join an existing one for a multicast session within its scope region. When a HDR receives an IGMP_RID_Request message from its local subnet, it will invoke the HLIM regular join operation by issuing an HLIM_Join message. Upon receiving an HLIM message, a HDR extracts the control information, L, H, APL_ID, RID, and R/S, from the received message and proceeds to the further operation. This message must be acknowledged by an HLIM_ACK message. Once acknowledged, the HDR sets up the forwarding cache, and hence, the multicast tree is set up. The method of acknowledgment is the end-to-end for now, but hop-by-hop acknowledgment can be implemented by exploiting the “future use” field 226 for hostile environments.

### HLIM_M_Join

FIG. 48 shows the format for the HLIM_M_Join message 112. This message is used to hand over an active multicast session to/from a mobile host/HDR moving outside the original scope region (i.e., to extend the multicast tree from the original scope region to a new location). It is very similar to that of HLIM_Join, except that there is an additional “Route Info” field 230 that is used to direct the message to the HDRs on the path toward the RID. The value of the field can be obtained from the underlying unicast routing protocol (e.g., RIP or OSPF).

### HLIM_HDR_List_Update

FIG. 49 shows the format for the HLIM_HDR_List_Update message. This message is used by a HDR to update the HDR list. The HDR(N) field 231 is the IP address of the HDR at the highest level, N. The HDR(N−1) field 232 is the IP address of the HDR at the next highest level and the HDR (k+1) field 233 is the IP address of the HDR at first level (k+1) above level k. The message shown in the FIG. 53 is an example where the message is assumed to be generated by a HDR at level k+1 and received by a HDR at level k.

### HLIM_HDR_List_Solicit

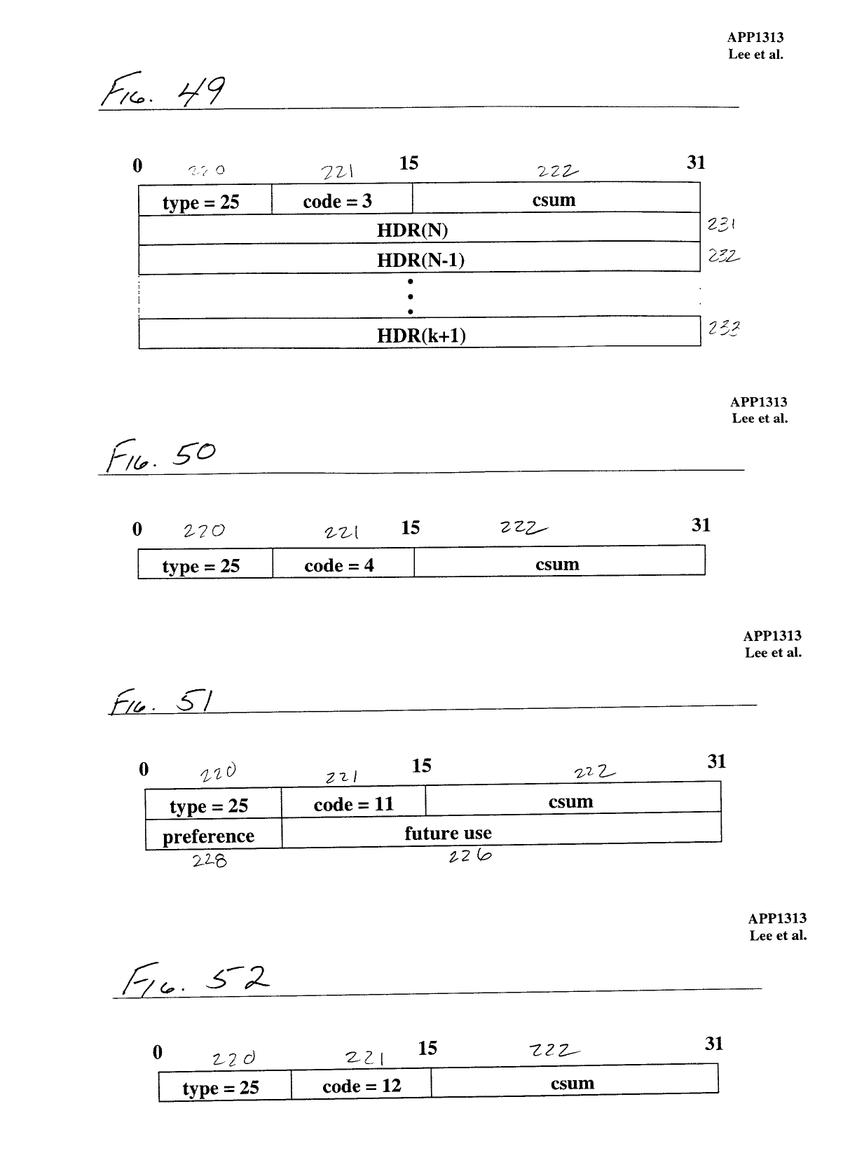

FIG. 50 shows the format for the HLIM_HDR_List_Solicit message. This message is used by a HDR to request for the HDR list from its parent HDR. It carries only the HLIM control packet header, type field 220, code field 221 and checksum field 222 and no other parameters.

### HLIM_ACK

FIG. 47 also shows the format for the HLIM_ACK message 113. This message is used to indicate the successful completion of the multicast tree initiated or extended by a previous HLIM_Join operation. Its format is the same as that of HLIM_Join but with a different message code 5 in the code field 221. The message is accepted and processed by only a HDR that has the associated transient forwarding cache with the right outgoing interface. Otherwise, it is discarded. The message is originated by the HDR at the highest level of the scope region, H, and is relayed down to the HDR keeping the associated transient forwarding cache with only L_IF as an outgoing interface.

### HLIM_M_ACK

FIG. 47 also shows the format for the HLIM_M_ACK message 121. This message is used to confirm the successful completion of the multicast tree extension by a previous HLIM_M_Join. Its format is the same as that of HLIM_ACK but it traverses and is processed outside the scope region but code field 221 contains the value 6. Unlike an HLIM_ACK that is always forwarded through D_IF, the message can be forwarded or received either U_IF or D_IF. Thus, to proceed to forwarding the message, the incoming and outgoing interface of the message must be compared.

### HLIM_Prune

FIG. 47 shows the format for the HLIM_Prune message. An HLIM_Prune message is generated when all the listed outgoing interfaces (Outg_IF) for a multicast session (i.e., represented by a HLIM group address comprised of [0111L;H:APL_ID] and [RID]) are deleted. The message is always forwarded through U_IF and processed within the scope region defined by L, H, and RID. Only the HDRs with the same group process the message. Its format is the same as that of HLIM_Join but code field 221 contains the value 7.

### HLIM_Prune_Reply

FIG. 47 also shows the format for the HLIM_Prune_Reply message. An HLIM_Prune_Reply message is issued in response to an HLIM_Prune message. This message notifies the affiliating HDR (i.e., the parent HDR) that an outgoing interface of a child HDR still depends on that of the parent HDR, and hence, the parent HDR overrules the HLIM_Prune message previously received. Its format is the same as that of HLIM_Join but code field 221 contains the value 8.

### HLIM_M_PRUNE

FIG. 47 also shows the format for the HLIM_M_Prune message. While an HLIM_Prune message is processed within a scope region, an HLIM_M_Prune message is processed outside the scope region. Like an HLIM_M_Join, this message is forwarded from a local HDR (i.e., a HDR with L_IF) to the RID. Unlike an HLIM_Prune that is always forwarded through U_IF, the message can be forwarded or received either U_IF or D_IF. Thus, to proceed to forwarding the message, the incoming and outgoing interface of the message must be compared. Note that, since the message is forwarded to the RID, the outgoing interface of the message is determined according to the unicast routing protocol. Its format is the same as that of HLIM_Join but code field 221 contains the value 9.

### HLIM_M_PRUNE REPLY

FIG. 47 also shows the format for the HLIM_M_Prune_Reply. Like an HLIM_Prune_Reply, an HLIM_M_Prune_Reply message is issued in response to an HLIM_M_Prune message. Its format is the same as that of HLIM_Join but it traverses but code field 221 contains the value 10.

### HLIM_P_HELLO

FIG. 51 shows the format for the HLIM_P_Hello message. If a HDR had D_IF, it periodically issues an HLIM_P_Hello message through D_IF (toward its child HDRs). The period can be adjusted according to the extent of mobility. The message is accepted and processed by its child HDRs which, in turn, detect their movements by catching the change of their parent HDR. A child HDR determines the change of its parent HDR by tracking the source IP address of the message which can be obtained from the IP header of the message. The neighboring HDRs connected through their D_IF use this message for the HDR election. The 8-bit “preference” field 228 carries the preference value of a HLIM router to be elected as a HDR.

### HLIM_C_HELLO

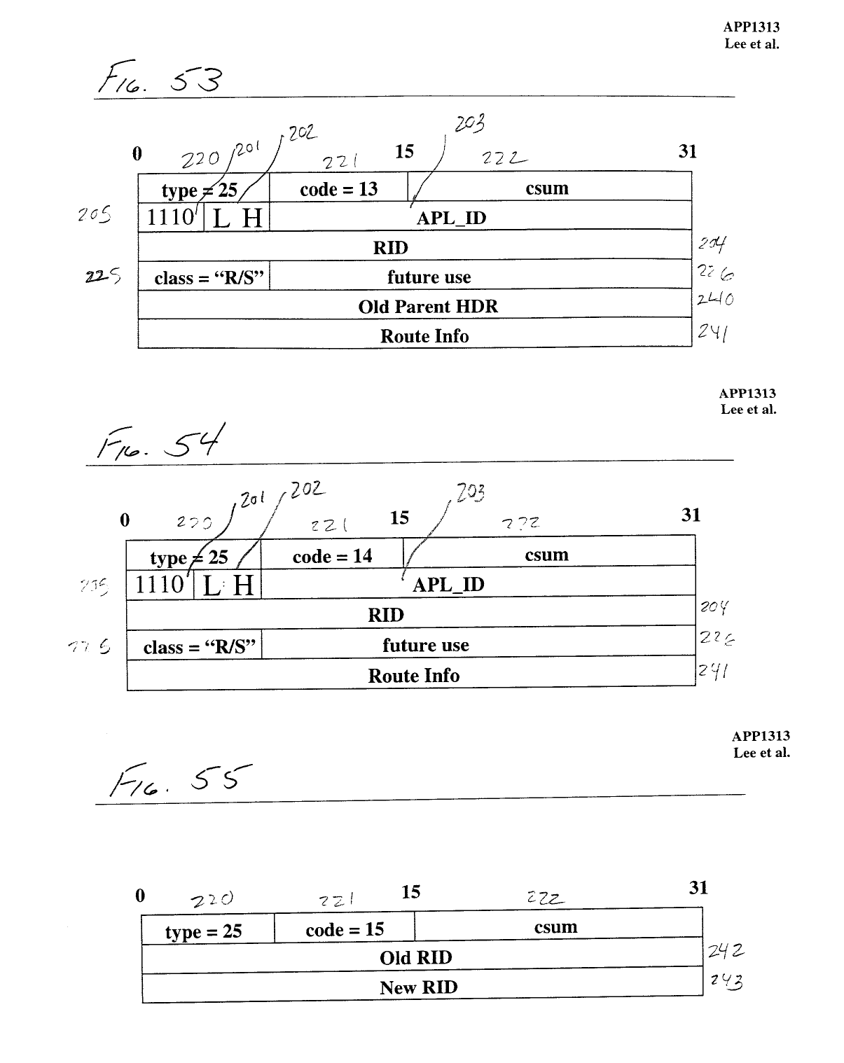

FIG. 52 shows the format for an HLIM_C_Hello message. An HDR with U_IF, except for the highest HDRs, periodically sends an HLIM_C_Hello message through U_IF (toward the parent HDR). This message is used for a parent HDR to detect the movement of its child HDRs. The source IP address (the IP address of child HDR) is obtained from the IP header.

### HLIM_NET_JOIN

FIG. 53 depicts a format for the HLIM_Net_Join. If the network movement including the RID is detected, the HLIM_Net_Join operation will be invoked. The root HDR of the moving network forwards an HLIM_Net_Join message toward its previous parent HDR at the old location. Field “Old Parent HDR” 240 is the destination of the message and the IP address of the previous parent HDR at the old location. The field “Route Info” 241 contains the unicast information that is used by the HDRs on the path toward the destination.

### HLIM_Net_Join_ACK

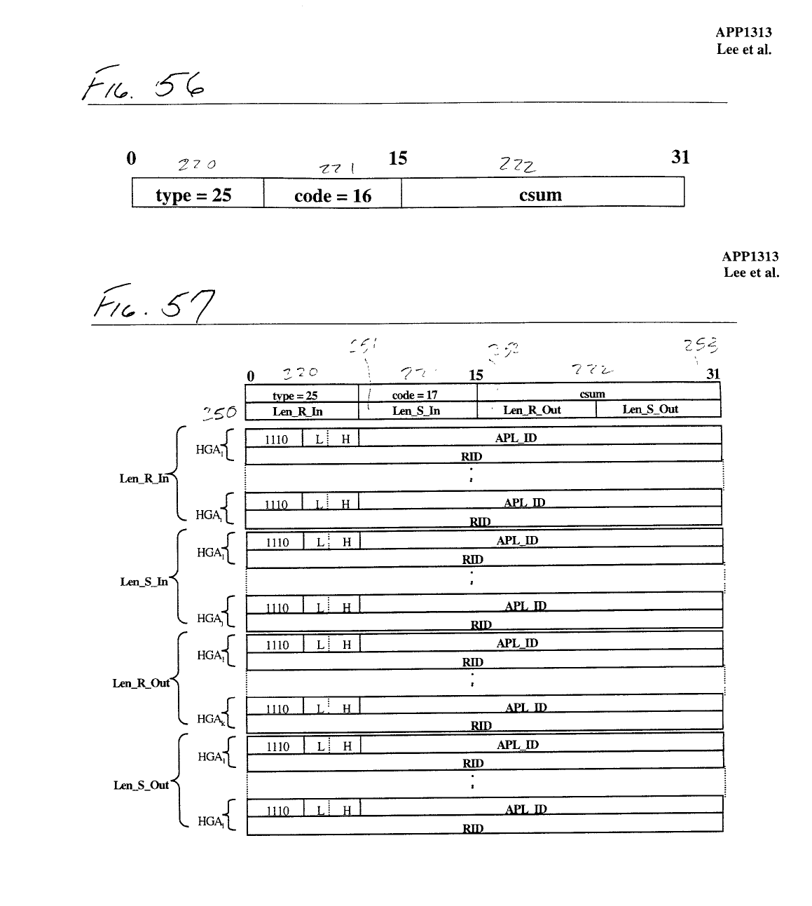

FIG. 54 depicts a format for the HLIM_Net_Join_ACK message. This message is used to confirm the successful completion of the multicast tree being extended by a previous HLIM_Net_Join. Like an HLIM_M_ACK message, an HLIM_Net_Join_Ack is processed outside the scope region. The HDRs having the transient forwarding cache for the group (i.e., comprised of the fields, [0001;L,H;APL_ID], and RID) process and forward the message. The field “Route Info” 241 here provides the information on reaching the final destination (i.e., the originator of the HLIM_Net_Join message). Note that it is not the destination IP address of the message. Rather, it can be either the IP address of the parent HDR at a new location or null (i.e., 0.0.0.0). Since the message can be forwarded or received either U_IF or D_IF, the interface filtering, which is the comparison of the incoming and outgoing interface of the message, must be exercised.

### HLIM Flush

FIG. 55 depicts a format for the HLIM_Flush message. This message is to update the existing forwarding caches and records of any active multicast sessions whose RID has been changed. The “Old RID” field 242 carries the outdated RID and the “New RID” field 243 carries the IP address of a new elected HDR that replaces for the outdated RID. If a HDR receives this message, it will update all the forwarding caches associated with the outdated RID by substituting the outdated RID with the new RID. This message further invokes the IGMP_Flush at the local subnet. Consequently, the whole multicast tree is updated.

### HLIM_Conf_Hello

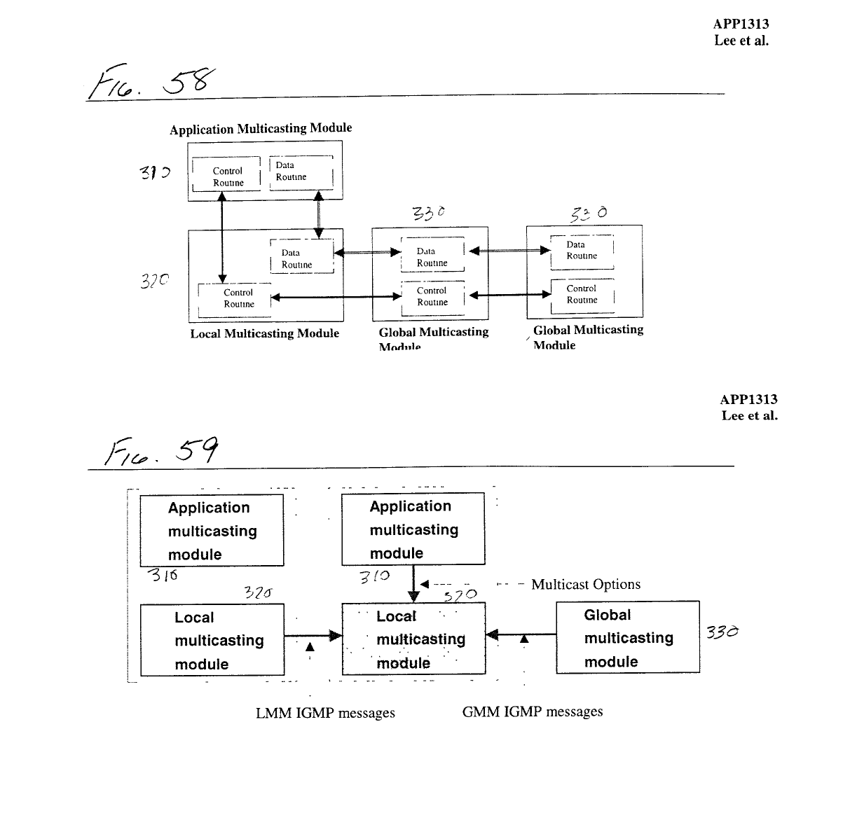

FIG. 56 depicts a format for the HLIM_Conf_Hello message. This message is used to configure the U_IF and D_IF of a HLIM router during network start-up. It carries only the HLIM control packet header and no other parameters because the recipient is just required to find out which physical interface the message has arrived. U_IF is assigned to the interface that the message has arrived, and D_IF is assigned to the interface opposite to the arrival interface.

### HLIM_Compare(E), HLIM_Compare_Reply, and HLIM_Compare(M)

FIG. 57 depicts a format for the HLIM_Compare(E), HLIM_Compare_Reply and HLIM_Compare(M). The formats of these messages are all same. The messages are differentiated by the “code” field: 17 for HLIM_M_Compare, 18 for HLIM_M_Compare_Reply, 19 for HLIM_E_Compare, and 20 for HLIM_E_Compare_Reply. The 8-bit “Len_R_In” field 250 specifies the number of inbound HLIM group addresses (HGA) generated by receivers. The 8-bit “Len S In” field 251 specifies the number of outbound HGA generated by sources. The 8-bit “Len_R_Out” field 252 specifies the number of outbound HGA generated by receivers. And the 8-bit “Len_S_Out” field 253 specifies the number of outbound HGA generated by sources.

### SOFTWARE DESIGN OF HLIM

The existing multicast implementation paradigm comprises of one or more Application Multicast Modules 310, one or more Local Multicasting Modules 320 and one or more Global Multicasting Modules 330 as shown in FIG. 58. The Application Multicasting Module (AMM) 310 passes multicast options, such as group membership information, of multicast applications to the Local Multicast Module (LMM) 320 through user level APIs, setsockopt( ) and getsockopt( ). LMM 320 implements IGMP that transfers the information of group membership from the application to the Global Multicast Module (GMM) 330. The LMM 320 is implemented inside the kernel of host.

The GMM 330 consists of two components. One is the multicast routing daemon resided in the user level, called ‘mrouted’ which handles the control messages from either its neighboring global multicasting modules 330 or the local multicasting module 320. The other is the multicast forwarding cache (MFC) resided in the kernel. From the MFC, the kernel can forward multicast data packets from its local hosts or its neighboring multicast routers to appropriate locations. Even though the MFC is maintained at the kernel, the MFC is controlled by the mrouted daemon in user level using system calls. The GMM 330 uses a socket(s) to communicate to other GMM 330 or LMM 320. There are two approaches to implement such a communication: single socket and multi socket approaches. In the single socket approach, one socket called ‘socket_igmp’ (i.e., illustrated as igmp socket in the previous chapters) handles all of the interaction between GMMs, between GMM and LMM, and between GMM to MFC. In the other approach, a distinct socket is used for each of the interactions (e.g., one socket for between GMMs, another socket for between GMM and LMM, etc).

### Application Multicast Module

In general, a host can be informed of available multicast sessions by means of Session Directory applications such as SD [SD] or SDR[SDR1][SDR2][SDR3]. The session directory application itself is a multicast session with a well-known multicast address. It uses the Session Announcement Protocol (SAP) and the Session Description Protocol (SDP) to describe and advertise available multicast sessions for multicast applications such as video-vic[VIC1][VIC2], audio-fphone[FRE1][FRE2], rat[RAT],vat[VAT]. Note that the session of such applications can be also advertised without the help of the session directory by running its own version of the session advertising function.

The SDR registers multicast sessions initiated by SDR users and advertises these sessions to all other SDR users. Thus each SDR user can discern available multicast sessions and choose multicast sessions for which it wants to become a receiver, source, or both (which is usually the case). If a SDR user chooses to be a receiver for a multicast session, an UDP socket is created and bound with the socket address (i.e., a specified group address and UDP port number) assigned for the multicast session, and then the user can receive multicast packets (MPs) for the session through the socket by calling recvfrom( ) on that socket. While, if a SDR user chooses to be a source of a multicast session, an UDP socket is created only, and the system call, sendtoo, instead of recvfrom( ), is invoked on that socket to send the MPs. The UDP socket addresses of the source and receiver can be same depending on the implementation of multicast applications, but usually they are differed by the UDP port number.

### Multicast API

There are two system calls that can be invoked by an AMM 310 to interface with the LMM 320: setsockopt( ) (pass multicast options to the kernel) and getsockopt( )(to retrieve information regarded multicast behavior). The followings are the prototypes of the system calls:

int setsockopt (int s, level, int optname, const void* optval, int optlen),

int getsockopt (int s, int level, int optname, void* optval, int* optlen).

The first parameter, s, is the socket that the system call applies to. For multicasting, it must be a socket of the family (AF_INET (Internet Address Family) and its type is SOCK_DGRAM (i.e., UDP socket) or SOCK_RAW (i.e., raw socket). SOCK_DGRAM is used for multicast data packets. SOCK_RAW is used for transferring multicasting control messages between the local and global multicasting modules, between the global multicasting modules, or between the global multicast modules in user level and kernel level.

The second one, level, identifies the layer that is to handle the option. For example, SOL_SOCKET is for the socket layer and IPPROTO_IP for the IP layer. For multicasting implementation, level will always be IPPROTO_IP. Optname identifies the option we are setting/getting. Its value (either supplied by the application multicasting module or returned by the local multicasting module) is optval. The optname involved in multicast programming are: IP_MULTICAST_LOOP, IP_MULTICAST_TTL, IP_MULTICAST_IF, IP_ADD_MEMBERSHIP, and IP_DROP_MEMBERSHIP. For getsockopt( ), only the first three options are allowed. Optlen carries the size of the data structure optval points to. Both setsockopt( ) and getsockopt( ) return 0 on success and −1 on error.

If one wants a multicast session (source of the session) to be looped back to one's host, then one sets IP_MULTICAST_LOOP option to the socket associated with the session. IP_MULTICAST_TTL specifies the scope of multicast packet. If unspecified, multicast packets are sent with a default value of 1. IP_MULTICAST_IF specifies an outgoing interface for a given socket. If the host has more than one interface and the IP_MULTICAST_IF option is not set, multicast packets are sent from the default interface, although the remaining interfaces might be used for multicast forwarding if the host is acting as a multicast router. IP_ADD_MEMBERSHIP option along with a multicast group informs the kernel of your interest to receive multicast packets for the group from the socket while the IP_DROP_MEMBERSHIP option informs the kernel to stop to do so.

### Local Multicasting Module

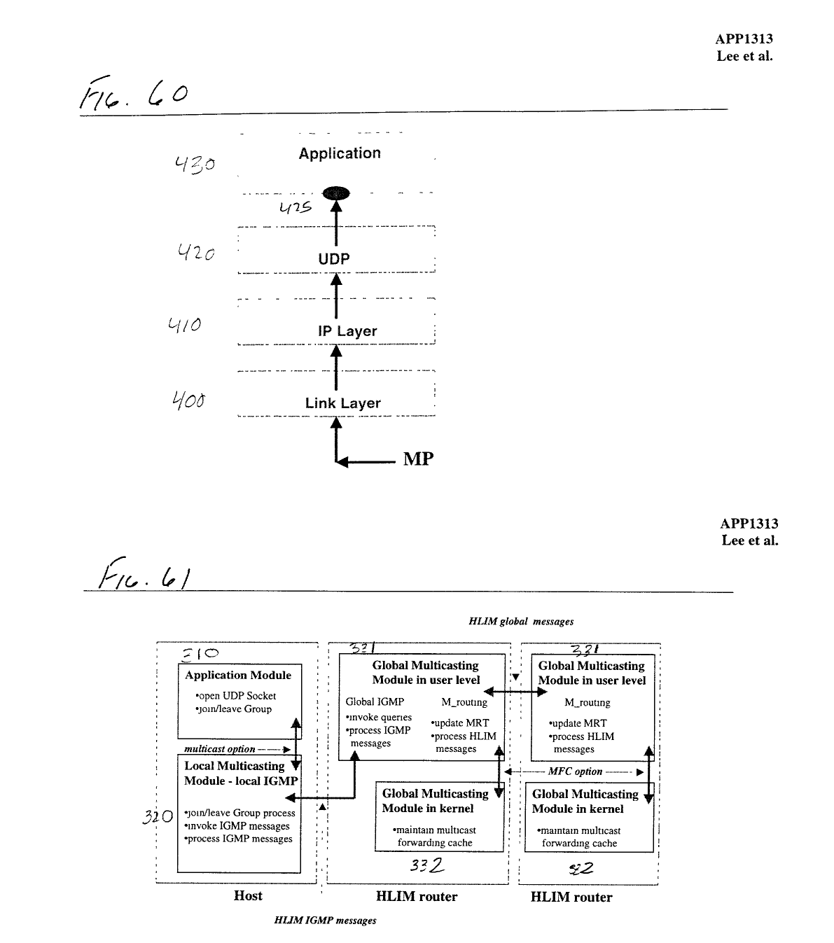

As shown in FIG. 59, the invocation of LMM 320 can be triggered by the multicast options from the AMM 310, LMM IGMP messages (e.g., IGMP_Report) from other LMMs (from other multicast receivers or sources), or GMM IGMP messages (e.g., IGMP_Query) from the GMM 330. A LMM 320 is further broken down into two major functions: local IGMP function and local MP processing function.

When a host joins as a receiver for a multicast session, the AMM 310 passes a system call, setsockopt( ) with an IP_ADD_MEMBERSHIIP option along with a multicast group and the local interface, to the LMM 320. Upon receiving the multicast option, the LMM 320 adds the group address to the multicast group list associated with the socket and the local interface device, and then sends an IGMP report to the GMM.

IGMP conveys group membership information between the LMM 320 and GMM within a local subnet. The IGMP of GMM (denoted as GMM IGMP) periodically multicasts IGMP queries to the all-hosts group 224.0.0.1. The IGMP of LMM 320 (denoted as LMM IGMP) responds to the queries by multicasting IGMP report messages. From an architectural perspective, the local IGMP is a transport protocol above IP. It has a protocol number, “2”, and its messages are carried in IP datagrams. Since the global IGMP is the part of mrouted which is a user-level process, all such IGMP messages are sent and received through the raw socket, socket_igmp.

The local IGMP sets the local interface device to be joined with a given multicast group, as a multicast application wants to receive MPs for the multicast group. FIG. 60 shows the flow-routine of MP from the local interface device to the multicast application. When a MP is arrived at the local interface device, the link layer filtering at link layer 400 for multicast frames is invoked, which performs best-effort filtering due to the imbalance of address mapping between IP layer and link layer multicast addresses. The mapping of 28-bit IP multicast address to 23-bits Ethernet multicast address implies that 32 (2⁵) IP multicast addresses are mapped to the same Ethernet address). Once MPs reach the IP layer 410 after passing through the link layer multicast filter, the perfect filtering operation is applied to the MPs by the IP layer. After filtering out the unwanted MPs and taking off IP headers from the remaining MPs, the IP layer exercises demultiplexing to hand over the MPs to the UDP handler 420 which then processes the MPs (which have become UDP packets) and passes them to the appropriate UDP socket 425 that the multicast application 430 (receiver) has opened.

### Global Multicasting Module

GMM is the core part of the IP multicasting. To generate a multicast tree is the main function. According to the method to form a multicast tree, the IP multicasting protocols such as CBT, DVMRP, PIM-DM, and PIM-SM are differentiated. In the implementation perspectives, they are usually different from each other by the operational functions of ‘mrouted’ in user level (called “mrouted daemon”). Thus, in order to build a new IP multicasting protocol, based upon the existing IP multicasting paradigm, a new mrouted daemon merely needs to be implemented and replaced. However the HLIM implementation requires additional kernel modification because the HLIM provides mobility support and other advanced features that the existing multicasting protocols do not support.

When the LMM 320 receives an IP_ADD_MEMBERSHIIP option from the AMM 310, the LMM 320 sends an IGMP report to the GMM 330. Upon receiving the IGMP report, the GMM 330 of mrouted exercises the global multicasting operation that creates the multicast tree.

In the cases of CBT and PIM-SM, the mrouted daemon sends a join message to its neighboring mrouted on the path toward the core router and at the same time it sets up the multicast forwarding cache into the kernel by calling a system call, setsockopt( ). Both protocols use two raw sockets, called socket_mroute and socket_igmp. In other words, the join message is sent and received through the socket_mroute from one router to another, and the signaling from the system call from the user level is passed to the kernel through the socket_igmp.

In the cases of DVMRP or PIM-DM, when the GMM IGMP receives an IGMP report from the LMM IGMP of a receiver, the routing part of mrouted (i.e., multicast routing) just sets (or updates) on-state on the local interface which the IGMP report has arrived on. In consequence, it updates the multicast routing table (MRT) in the user level as well as multicast forwarding cache (MFC) in the kernel to instruct the kernel to forward any incoming MP to the receiver. These operations establish only the leaf part of a multicast tree. The operation to complete setting up the multicast tree is exercised when the first MP with a new group address appears in the kernel. The kernel first checks the MFC for a new arriving MP. Since the MP is new, there is no entry for the MP in MFC. At this time the kernel passes the source and group (destination) addresses to the routing part of mrouted which then finds the parent interface for the MP through the RPF (reverse path forwarding) operation, updates its MRT, and FIGS. out all the information required for setting up a new cache entry. The mrouted passes the information for multicast routing (i.e., the parent interface and outgoing interface) back to the kernel which then sets up the entry for the MP in MFC.

### Provisions for HLIM Implementation

In implementation perspective, the major differences of HLIM protocol from the existing multicast protocols are the HLIM GA and mobility support. The size of HLIM GA is longer than that of the existing protocols. The HLIM GA comprises of two IP addresses: one 32-bits class D_IP address consisting of APL_ID and SR(L,H) and the other 32-bit of IP address representing a RID. None of the existing protocols supports mobility since they have been built without mobility consideration. These new features of HLIM, along with other advanced features of HLIM, cause the changes in multicasting modules in the current IP multicasting paradigm. In addition to that, the changes need to be made in accordance with the implementation approach and policy

The HLIM protocol will be able to support all the current existing multicasting applications. This implies that the HLIM implementation will comply with the current AMM that includes the uses of multicasting APIs and UDP socket. The current multicasting APIs, setsockopt( ) and getsockopt( ), are used to interface the applications with the local IGMP. Only APL_ID and scope parts of HLIM GA (total of 32 bits) are applied as an UDP socket address, and a complete HLIM GA is constituted by adding a RID at the kernel.

There are two issues for supporting mobility: mobility detection and mobility management. We want HLIM itself to be able to detect host and network mobility without any intervention of lower layer detection such as mobility detection of physical layer. Also, we want the HLIM protocol to have its own version of mobility management so that the HLIM does not have to depend on another layer equipped with the mobility management such as mobile IP. The reason for not leveraging from other layers is to let our HLIM protocol be more generic and layer-independent.

### HLIM Software Design Architecture

The HLIM Software design comprises of three modules: AMM 310, LMM 320 and GMM 330 (as in the existing multicasting paradigm). Each module has data and control routines. FIG. 58 shows an embodiment of the HLIM software architecture. The AMM 310 and LMM 320 are located at multicast hosts and the GMM 330 is located at HLIM routers.

As a multicast session is created, HLIM sets up two paths: control and data paths for the session. The control path is established through interfaces between the control routines of the AMM 310 and LMM 320, between the LMM 320 and GMM 330, and between the GMMs. These interfaces are implemented by the system calls, IGMP messages (both LMM 320 and GMM IGMP messages), and HLIM global messages respectively. The control routines create and maintain a data path (i.e., a multicast tree) for the session. Once the data path is established, MPs of the session traverse through the data path.

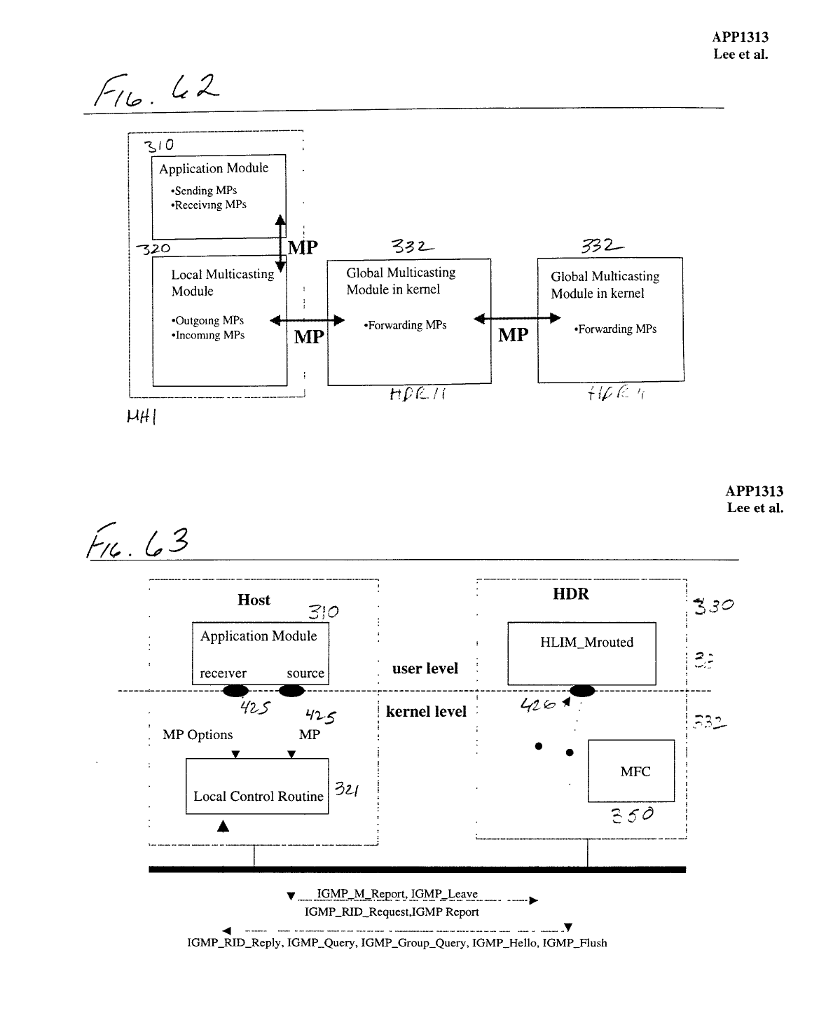

FIG. 61 shows the overview of control paths between control routines in multicasting modules. The AMM 310 opens an UDP socket and binds the socket with the group address and UDP port number for a multicast session, joins/leaves the group by calling the system call, setsockopt( ) on the socket to transfer multicast options to LMM 320. AMM 310 is transparent to host mobility.

The LMM 320 processes the multicast options from AMM, invokes to send IGMP messages to GMM 330, processes IGMP messages from the GMM and other LMM 320 respectively, and invokes RID request to find the RID of the multicast group.

GMM in user level 331 sends GMM IGMP messages (i.e., IGMP_Query, IGMP_Hello, IGMP_Flush, IGMP_RID_Reply) to the LMM 320, processes LMM IGMP messages and GMM IGMP messages from other GMMs (for local HDR election), sends HLIM messages to other GMMs, processes HLIM messages from GMM's 330, maintains a multicast routing table (MRT), triggers the kernel level GMM 331 to update Multicast Forwarding Cache (MFC), and detects network mobility and invokes network support operations

GMM in kernel 332 processes the incoming information from the user level GMM 331, maintains a MFC.

Between AMM 310 and LMM 320 is an interface through a UDP socket for a multicast session and an API through system calls, setsockopt( ) and getsockopt( ). Between LMM 320 and GMM 330 is an interface through socket_igmp on GMM 330 and passage of LMM and GMM IGMP messages.

Between GMMs is an interface through socket_igmp on GMM 330 and passage of HLIM messages. Between user level GMM and kernel level GMM is an interface through socket_igmp and an API to the kernel level GMM through system calls, setsockopt( ) and getsockopt( ).

FIG. 62 shows data paths between data routines in the modules. The AMM 310 sends MPs through the UDP socket that has been opened by the AMM 310 and receives MPs through the UDP socket that has been opened and bound by the AMM 310. The LMM processes incoming MPs from GMM 330, passes MPs to AMM by filtering and demultiplexing incoming MPs and sends outgoing MPs to GMM 330. The GMM in kernel 332 processes incoming MPs from either LMM or GMM and forwards MPs to either LMM 320 or another GMM.

### LMM for HLIM

Since, in accordance with the policy of HLIM implementation described in the previous section, the existing Application Multicasting Module 310 is unchanged in the HLIM implementation, the software implementation for LMM 320 and GMM 330 is important for HLIM.

In order to support HLIM, the new functions associated with new IGMP messages are added on the current existing implementation of LMM (i.e., IGMPv2). Thus, in particular, we will focus more on the new functions and IGMP messages.

The LMM 320 links GMM 330 and AMM 310 together. It is located in the kernel of each multicast host and handles multicast control information and data packets between GMM 330 and AMM 310. The LMM of HLIM is divided into Control routine and Data routine.

The following functions are implemented in the Control Routine of LMM processes the multicast control options from AMM 310, sends IGMP messages to GMM 330, processes IGMP messages from other LMM 320 and GMM 330, and detects host mobility.

The Data Routine in LMM 320 processes incoming multicast packets (MPs) from GMM 330, integrates a RID into an IP header using IP Option and sends outgoing MPs to GMM 330.

All these functions are implemented in the kernel (/usr/src/linux/net/ipv4/) of host.

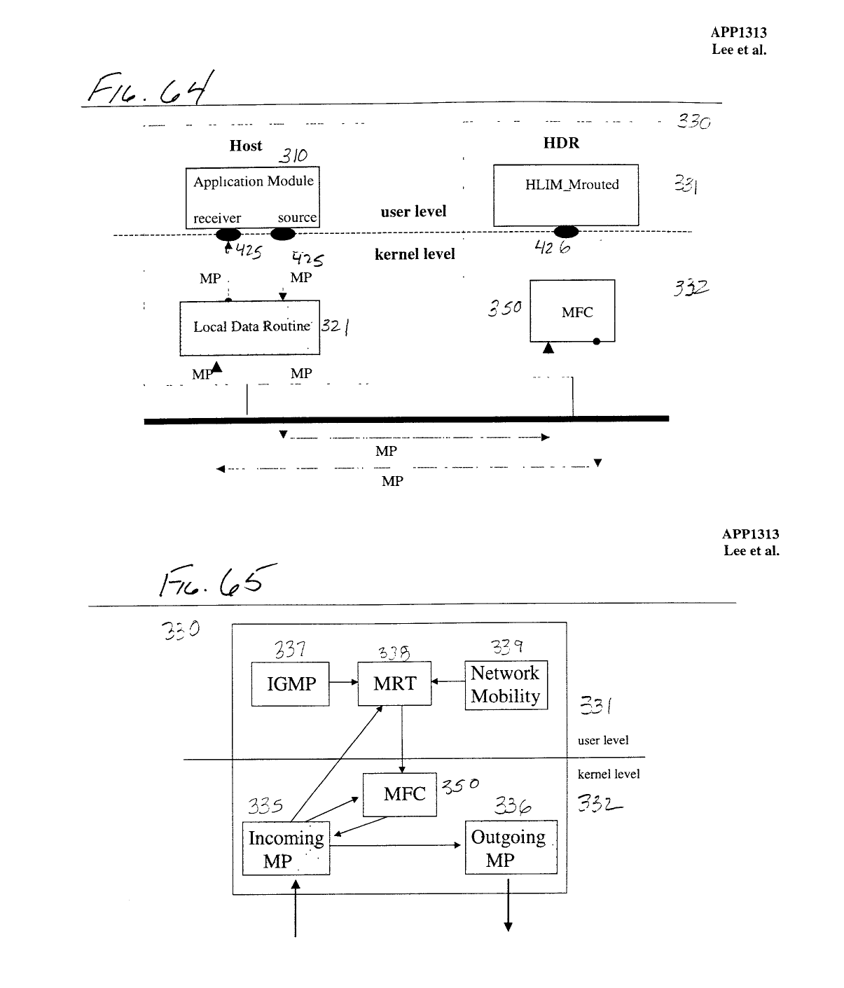

FIG. 63 describes the implementation for each control operation in LMM 320. An AMM 310 opens an UDP socket 425 (e.g., a receiver wants to have a multicast session). The multicast options from the AMM 310 are passed to Control Routine 321 of LMM 320 through the UDP socket 425. The Control Routine 321 processes the multicast options and accordingly sends an IGMP_RID_Request, IGMP_Report, IGMP_Leave, and IGMP_M_Report to the GMM 330. Also it receives and processes an IGMP_RID_Reply, IGMP_Query, IGMP_M_Reply, IGMP_Flush and IGMP_Hello from the GMM 330 and an IGMP_RID_Request, IGMP_Report, and IGMP_M_Report from the neighboring LMMs.

When a receiver host MR10 wants to have a multicast session, the AMM 310 passes the multicast options to LMM 320 as follows. The AMM 310 invokes the system call, setsockopt( ) to pass the multicast options (M_option) to LMM 320. (2) According to the M_option received, the LMM 320 invokes the following functions. For MULTICAST_GROUP_JOIN option

1. ip_mc_join_group( ) (ipv4/igmp.c) is called to add a group into the socket's group list.

2. ip_mc_inc_group( ) is called to add the group into the device's multicast address list for filtering incoming MPs. This function maps an IP group address to a device multicast address.

3. igmp_send_RID_request( ) (ipv4/igmp.c) is called to issue an IGMP_RID_Request and wait for an IGMP_RID_Reply. Remind that the “class” field in the message format is “R”. This function is newly added on the existing implementation.

Once an IGMP_RID_Reply is received from the GMM 330,

4. igmp_group_added( ) (ipv4/igmp.c) is called. It creates and initiates the timer for the group, and sends the first IGMP_Report to the GMM 330.

5. Thereafter, igmp_send_report( ) (ipv4/igmp.c) can be called to send an IGMP_Report in response to an periodic IGMP_Query from the GMM 330.

b) For MULTICAST_GROUP_LEAVE option:

1. ip_mc_delete_group( ) (ipv4/igmp.c) is called to delete the group from the socket's group list,

2. ip_mc_dec_group( ) (ipv4/igmp.c) is called to delete the group from the device's multicast address list,

3. igmp_group_dropped( ) (ipv4/igmp.c) is called to delete the group along with all the associated information such as router information and the timer.

4. igmp_send_report( ) (ipv4/igmp.c) is called to send an IGMP_Leave to notify the end of the multicast session to the GMM 330.

### Implementation for Detecting Host Mobility

LMM 320 detects host mobility through an IGMP_Hello advertisement message. An IGMP_Hello message from the GMM 330 is advertised periodically over a local subnet (approximately 2 to 3 seconds interval). The LMM 320 listens the message and checks the source of the message (affiliating HDR). If it detects any change of the source, it regards that it has moved to a new location and sends an IGMP_M_Report message instantly.

Upon receiving an IGMP_Hello, igmp_hear_hello( ) (ipv4/igmp.c) is called. If the source IP address is the same as the previous one, no further action is taken since no mobility is involved. Unless, igmp_mobile_report( ) (ipv4/igmp.c) is called to send an IGMP_M_Report.

### Implementation for Sending IGMP Messages to Global Multicasting Module

Before an IGMP message can leave LMM, they have to undergo the following three steps: building an IGMP header, building an IP header, and queuing an IP packet to be sent out. Building an IP header and queuing to be sent out can be implemented by the existing function calls. On the other hand, since the IGMP header for an HLIM control message is different from the existing IGMP header because of the introduction of a new field, RID, the existing implementation for building an IGMP header needs to be modified for building an IGMP header for HLIM. The modified data structure of IGMP header, igmphdr, is shown below:

struct igmphdr

{

| | | |
|---|---|---|
| u_int8 | type; | /* IGMP message identifier */ |
| u_int8 | code; | /* HLIM message identifier */ |
| u_int16 | csum; | /* check sum */ |
| u_int32 | group; | /* [0111,L,H,APL_IP] */ |
| u_int32 | rid; | /* RID for group */ |

| | | |
|---|---|---|
| u_int8 | class; | /* source or receiver */ |

};

When a LMM receives a M_option from the AMM 310, or an IGMP message from the GMM 330, one of the following IGMP messages is sent out toward the GMM 330 consequently: IGMP_RID_Request, iGMP_Report, IGMP_Leave, IGMP_M_Report. The following procedures are exercised to send the IGMP messages:

1. igmp_send_message( ) is called to send an IGMP message.

2. ip_build_header( ) (ipv4/ip_output.c) is called to build IP header.

3. The IGMP header is built in accordance with the type of message (e.g., “rid” field in igmphdr should be empty for IGMP_RID_Request).

4. ip_queue_xmit( ) (ipv4/ip_output.c) is called to queue an IP packet to be sent out.

Implementation for processing IGMP messages from other LMM and GMM 330 All incoming IP packets are processed in the kernel function, ip_rcv( ). Among these incoming IP packets, IGMP messages are passed to igmp_rcv( ) through igmp protocol handler, ipprot→handler( ). igmp_rcv( ) distinguishes the type of the received IGMP message by extracting the igmphdr of the message and, in turn, calls the appropriate function for the message.

For IGMP_RID_Reply: When igmp_rcv( ) in the LMM receives an IGMP_RID_Reply, it calls igmp_heard_rid_reply(GA) and following procedure is exercised.

1. The multicast groups affiliating to the socket opened through the AMM 310 are compared with the received incomplete multicast. The [0001;L,H;APL_ID], “class”, and the affiliating network interface (e.g., Ethernet) are compared.

2. If a match is found, the RID in the received message is added to the socket multicast group.

3. ip_mc_inc_group( ) is called to add the GA into the interface multicast group.

Note that, in the kernel, the multicast group list is associated to both the socket and interface.

For a regular IGMP_Query: When a LMM receives an IGMP_Query, it calls igmp_heard_query( ).

1. If there are timers for multicast groups running, igmp_timer_stop( ) is called to stop the timers and then igmp_start_timer( ) is called to reset the timers.

2. igmp_start_timer( ) calls random( ) to generate a random expiration time for the timer waiting to send an IGMP_Report in response to the IGMP_Query.

3. add_timer( ) is called to record the associated timer information into the timer queue and an IGMP_Report is sent out after the timer has expired.

For IGMP_Report: When a LMM receives an IGMP_Report message, igmp_heard_report( ) is invoked.

1. The group address carried in the report is compared with those in the multicast group list.

2. If there is a match, igmp_stop_timer( ) is called to stop the timer associated with the GA, and hence, the IGMP_Report, which has been ready for being sent out, is suppressed.

For IGMP_Flush: When a LMM receives an IGMP_Flush, igmp_heard_flush( ) is called.

1. The multicast group list associated with the socket is updated with the new RID indicated in the message.

2. The multicast group list associated with the interface device is updated with the new RID.

For IGMP_Hello: When a LMM receives an IGMP_Hello, igmp_heard_hello( ) is called. Every LMM keeps the router (i.e., querior) information such as the IP address of the querior and the associated interface. If the querior (i.e., the source IP address of the IGMP_Hello) has been changed, the LMM will send the IGMP_M_Report to the GMM 330.

### Implementation for Data Routine in LMM

As shown in FIG. 80, an AMM 310 (e.g., multicast receiver or sender) opens an UDP socket for sending or receiving MPs (some multicast applications open a single UDP socket for both sending and receiving). MPs coming from the network device are processed by the IP processing module at the IP layer in the kernel (ip_input.c) and then passed to the appropriate UDP socket. MPs coming from the AMM 310 are captured by the IP processing module where the IP header with the RID Option is added to the MPs, and forwarded to the appropriated network device.

At the device level, the device driver (i.e., the driver for wireless card (IEEE 802.11) in wavelan.c) points to the frame processing module (netif_rx( ) in /net/core/dev.c) which peels off the header from the frame carrying the MP (i.e., IP packet) and, in turn, passes the IP packet to the IP layer.

Upon receiving the MP from the device module, the IP processing module (ip_rev( ) in ip_input.c) finds out whether the MP should be filtered out or not.

If the MP is not filtered out, the UDP protocol handler (ipprot→handler(MP) in ip_input.c) is called to pass the MP to the UDP socket listening to the port specified in the UDP header of the MP.

The AMM 310 in a source host passes multicast messages to the LMM through the source UDP socket associated with a class D IP address and port number. When the LMM receives the first multicast message from the particular socket, the LMM sends an IGMP_RID_Request containing the scope field and APL_ID to the GMM 330 and waits for the IGMP_RID_Reply carrying the complete HLIM GA, [1110;L,H;APL_ID;RID]. Once the RID is obtained, the LMM generates the MPs by appending the RID onto the IP header of the MPs as an IP Option and then passes the MPs to the interface device and, in consequence, the MPs are sent out from the LMM.

When the LMM receives the multicast message from AMM 310 through the associated UDP socket, the following functions are invoked:

1) The UDP layer passes the message to the IP layer through the function, send_udp( ) (ipv4/udp.c).

2) The IP layer builds the IP header and RID_IP Option for the message and passes the message to the interface device. (ip_build_xmit( ) in ipv4/ip_output.c).

While building the IP header, the destination address of a message is scanned if it is a multicast address (i.e., a class D IP address). Note that, at this point, the destination address doesn't include the RID, so it is not a complete HLIM GA. If so, the multicast address will be compared to find a match from the multicast address list (i.e., HLIM GA list) maintained in the LMM. If the match is found (i.e., the associated RID for the destination address is found), the RID will be added to the IP header of the message through the RIP IP Option function. Unless, the LMM will issue an IGMP_RID_Request to obtain the RID from the GMM 330. In response to the IGMP_RID_Request[G,S], the GMM 330 replies with IGMP_RID_Reply.

Once the LMM obtains the associated RID, it records the destination address and the RID to the HLIM GA list as a new entry. Now the RID is added to the IP header of the message as to form an MP (i.e., HLIM IP multicast packet) and, consequently, the MP is passed to the interface device.

### GMM for HLIM

GMM 330 is the implementation of a HDR. Main functions of GMM 330 are the creation of multicast trees and dissemination of multicast packets over the multicast trees. GMM 330 consists of Control and Data Routines. The Control Routine handles all the HLIM control messages from the LMM and other GMMs. The Data Routine forwards MPs to the LMMs and other on-tree GMMs.

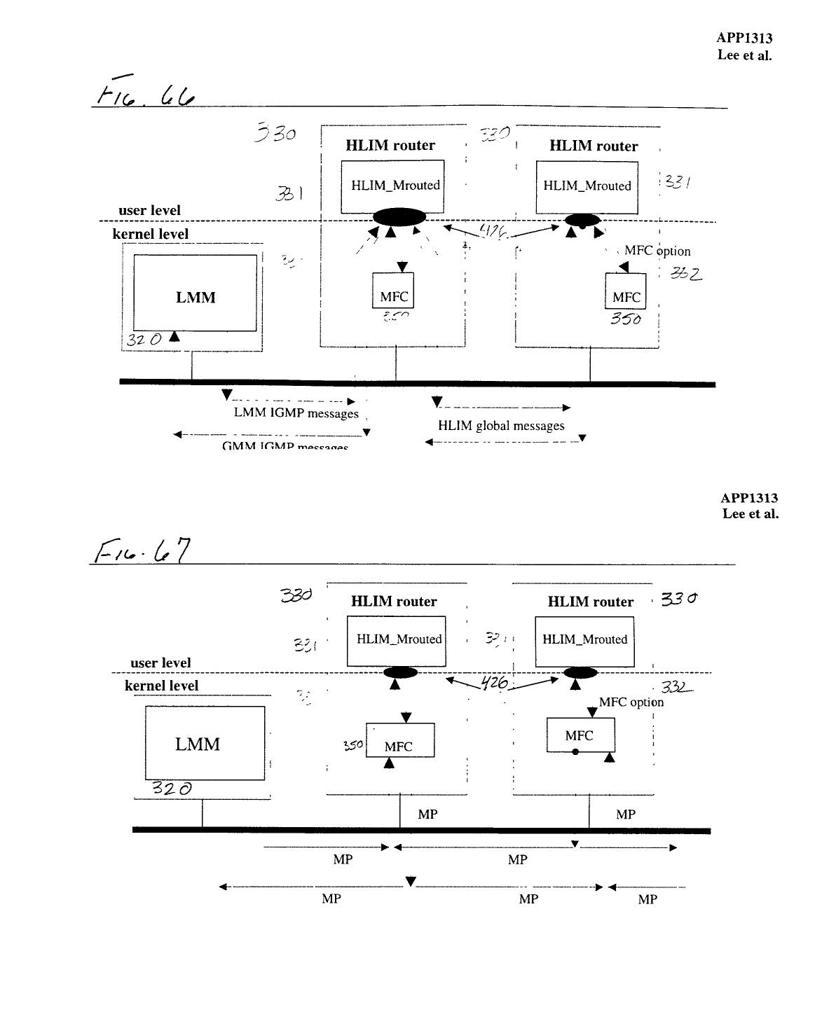

The functions of GMM 330 are implemented in both user level and kernel level. FIG. 65 shows the layout of main components of the GMM 330 and their inter-relationships.

The Incoming MP 335 and Outgoing MP 336 functions belong to the Data Routine of GMM 330 and the rest belong to the Control Routine of GMM 330. As shown in the FIG. 65, the Control Routine is implemented in both user level 331 and kernel level 332, while the Data Routine is implemented only inside the kernel. The functions of each component are summarized as follows:

### Control Routine of GMM

HDR IGMP maintains the local group (or multicast) membership list whose entry consists of HLIM GA (i.e., class D_IP address plus RID) and class (i.e., “R” or “S”), sends IGMP messages to LMMs and GMMs within a local subnet, and processes IGMP messages from LMMs and other GMMs within a local subnet (for L_HDR election).

Multicast Routing Table (MRT) Processing 338 maintains MRT which entry consists of HLIM GA, class, and outgoing interfaces, sends HLIM global messages to GMMs, processes HLIM global messages from GMMs, maintains MRT, and triggers the kernel level GMM to update Multicast Forwarding Cache (MFC) 350.

Network Mobility Support 339 detects network mobility and invokes the operations for supporting network mobility.

Multicast Forwarding Cache (MFC) Processing 351 maintains MFC 350 which entry consists of HLIM GA, class, and outgoing interfaces, processes the incoming control messages from the user level GMM, and sets up and maintains MFC.

### Data Routine of GMM

Incoming MP processes incoming MPs from either LMM or other GMMs.

Outgoing MP forwards MPs to either LMM or other GMMs.

Note that each HDR must keep its local group membership list, MRT, and MFC. In fact MFC is the kernel version of MRT.

As shown in FIG. 66, all the IGMP messages (i.e., IGMP messages from both LMM 310 and GMM 330) and HLIM global messages are delivered to the user level GMM 331 (i.e., HLIM_Mrouted) through the socket_igmp 426. The interaction between the user level GMM 331 and kernel level GMM 332 (i.e., MFC) (by system calls) is achieved through the same socket 426.

### HDR IGMP (IGMP in GMM) Implementation

One aspect is the implementation of processing IGMP messages from LMMs, and other GMMs within the local subnet (for Local_HDR election). The IGMP in GMM (i.e., IGMP functions of HDR) handles all the messages coming from the L_IF (i.e., local interface) via the socket_igmp 426. These messages are IGMP_RID_Request, IGMP_Report, IGMP_M_Report, and IGMP_Leave from LMMs, and IGMP_RID_Reply, and IGMP_Query messages from other GMMs in the same local subnet. All the IGMP messages are processed by the input processing function of the user level GMM (accept_igmp( ) in igmp.c).

The input processing function receives LMM IGMP messages with the IP header through the socket_igmp 426. It first processes the IP header; the source and destination IP addresses are obtained. After taking off the IP header, it processes the IGMP header and payload.

From the IGMP header, the type of the message is identified, and the group (i.e., multicast address used in AMM 310), RID, and class are obtained as well. The payload is the necessary information that will be used for the function call being associated with the message.

Once the IP and IGMP headers are processed (i.e., the incoming IGMP message is identified by the “type” field in the IGMP header), the associated message processing function takes a place. Such a message processing function starts with the message filtering procedures. There are two main filtering procedures: subnet filtering which filters out messages coming from a host affiliating to a different subnet, and L_IF filtering which filters out messages received on the interfaces other than L_IF. However in the case of IGMP_M_Report, the subnet filtering must be disabled because all the legitimate IGMP_M_Reports are issued from the host moved from a different subnet. The processing routine for each IGMP message is described below.

Upon receiving IGMP_RID_Request message 110, the input processing function (igmp_read( )) invokes the message-specific processing function (accept_rid_request( ) in igmp_protoc.c). The message-specific processing function begins with the filtering procedures. In the subnet filtering, the source IP address of the message is compared with the IP address of incoming interface (in this case the IP address of L_IF of the HDR). If their subnet addresses are the same, the message will proceed to the next filtering phase, the L_IF filtering. Otherwise, the message will be discarded. In the L_IF filtering, it makes sure that the incoming interface of the message must be the L_IF since the message is an IGMP message. If the incoming interface is identified as other than L_IF, the message will be discarded. For this message, one more filtering step takes place: Group Address Valid Check that is the HLIM specific feature. It filters out the message from a host outside the scope region defined by the scope information in the message. Once the message successfully passes through the filtering steps, the message processing function obtains the corresponding RID from the HDR list and calls the message-specific processing function for IGMP_Report (accept_group_report( )).

Upon receiving an IGMP_Report, the input processing function invokes the message-specific processing function (accept_group_report( )). The message gets involved in the subnet and L_IF filtering. After the filtering, the GA is examined if the GA is listed in the local group membership list. If listed, the timer for that GA will be reset. Furthermore it checks if the GA is listed in the MRT (check_to_setup( ) in mobile.c). If the GA is not listed, the GA will be added to the local group membership list. Also it updates the MRT by adding the HLIM GA, class, and L_IF as an outgoing interface (add_table_entry( ) in vif.c), and then initiates the join operation by sending an HLIM_Join (send_join_on_vif( ) in vif.c). Note that each GA listed in the local group membership is associated with its own timer. If the timer expires, the prune operation will start.

Upon receiving an IGMP_M_Report, the input processing function (igmp_read( )) invokes the input message-specific processing function (accept_group_mreport( )). Only the L_IF filtering is exercised for this message. If the GA has been already listed in the local group membership list (e.g., by a prior mobile host), the timer for the GA will be reset and IGMP_M_Reply will be issued in response to the IGMP_M_Report. If the GA is not listed, The movement detection takes place: within or outside the scope region. If within-movement is detected, the input message-specific processing function for IGMP_Report (accept_group_report( )) will be called. If outside-movement is detected, first the GA along with class will be added in the local group membership list, secondly the outgoing interface toward the RID is obtained (find_gw( )) in mobile.c), thirdly the GA along with the class and outgoing interface (i.e., L_IF for receiver and the outgoing interface toward the RID for receiver) will be added to the MRT (add_table_entry( )), finally the mobile join operation is initiated by sending an HLIM_M_Join to the outgoing interface just added in the MRT (send_mjoin_on_vif( )).

Upon receiving an IGMP_Leave, the input processing function invokes the input message-specific processing function (accept_leave_message( )). In addition to the subnet and L_IF filtering, the GA filtering gets involved; the message will be discarded if the GA is not listed in the local group membership list. After the filtering step, the timer for the GA is reset to LEAVE_EXPIRE_TIME and an IGMP_Specific_Query is issued through the L_IF

The IGMP_Hello message is used for the local HDR election and processed by only non-active HDRs. This message contains the preference (i.e., “hdr_pref”) of sender (degree of eligible to be an active HDR). Except for the election period, the value is always zero (the highest preference).

Note that every HDR keeps the following HLIM router information.

struct hdrinfo

{

| | | |
|---|---|---|
| u_int | hdr_level; | /* the level of HDR */ |
| u_int | hdr_state; | /* state of HDR: 0 for active or |
| | | 1 for idel */ |

| | |
|---|---|
| #define ACTIVE | 0 |
| #define IDLE | 1 |

| u_int16 | hdr_pref; | /* HDR preference value */ |
|---|---|---|
| u_int32 | hdr_list[MAXLEVEL-1]; /* HDR list: MAXLEVEL | |
| | is the maximum level in hierarchy */ | |
| u_int32 | hdr_parent; | /* parent HDR */ |
| u_int32 | hdr_oldprt; | /* old parent HDR for network mobility */ |
| u_int32 | hdr_tparent; | /* temperal parent HDR */ |
| u_int | hdr_tpcount; | /* for election */ |
| u_int32 | hdr_globalhdr; | /* elected HDR for global election */ |
| u_int32 | hdr_localhdr; | /* for local election */ |
| u_long | hdr_timerid; | /* for idle HDR timer for election |
| | | purpose */ |

struct childnode *hdr_child /* child HDR list */

};

Upon receiving an IGMP_Hello, the input processing function invokes the input message-specific processing function (accept_igmp_hello( )). After the subnet and L_IF filtering, the input message-specific function checks the preference value. It will reset the timer for the local election (SetHelloWaitRandTime( ) in mobile.c) if the received preference value is zero or less than its own preference value. Note that if the timer expires, it will start to send an IGMP_Hello. The GMM ignores IGMP_RID_Reply, IGMP_Flush and IGMP_Query.

### Implementation for Sending IGMP and HLIM Messages

Once a HLIM router is configured and defined as an active HDR, the HDR sends IGMP and HLIM messages to the LMM or GMM 330 through the output processing routine. All the output message-specific processing functions for, not only IGMP messages but also HLIM messages (e.g., send_join_on_vif( ), send_mjoin_on_vif( ), etc) point to the output processing function (send_igmp( ) in igmp.c).

The input processing function prepares the IP header and builds the IGMP header in accordance with a message. (note that the IP header is completely built in the kernel) It calls the system call, sendto( ), which is a socket level function which will initiate the corresponding kernel function. The following routine takes place in the kernel.

sys_sendto( ) (the asmlinkage for sendto( ) inside kernel) invokes sendmsg( ) (in /net/iipv4/socket.c).

sendmsgo invokes raw_sendmsg( ) (in /net/ivp4/raw.c)

raw_sendmsgo calls ip_build_xmit( ) which completely builds the IP header.

finally dev_queue_xmit( ) is called and the message is sent out through the associated interface.

### Implementation for Updating MRT

The MRT is the user level multicast routing table. It will be updated by the following incoming messages: IGMP_RID_Request, IGMP_Report, HLIM_Join, HLIM_ACK, HLIM_M_Join, HLIM_M_ACK, HLIM_Flush, HLIM_Compare, HLIM_Compare_Reply, HLIM_Prune and HLIM_M_Prune. Its entry contains HLIM GA, class, state (i.e., specifies the state of GA, confirm or transient state), and outgoing interfaces. The data structure for the MRT is shown below:

struct gtable

{

| | | | |
|---|---|---|---|
| u_int32 | gt_mcastgrp; | /* multicast group associated | */ |

| | | | |
|---|---|---|---|
| u_int32 | gt_rid; | /* multicast rid associated | */ |
| u_char | gt_class; | /* source/receiver cache | */ |

| | | | |
|---|---|---|---|
| u_char | gt_ttls[MAXVIFS]; | /* ttl vector for forwarding | */ |
| vifbitmap_t | gt_grpmems; | /* forw. vifs for src, grp | */ |

| | | |
|---|---|---|
| u_int | gt_joinstate; | /* join state transient or confirmed*/ |
| u_int | gt_netjoinstate; | /* netjoin state transisent or deleted*/ |

}

The MRT is accessed and modified by the following functions: find_grp( ), delete_lclgrp( ), add_table_entry( ).

find_grp( ) finds the particular GA from the MRT.

delete_lclgrp( ) deletes the particular GA from the MRT.

add_table_entry( ) adds the particular GA to the MRT.

Whenever the MRT is altered, the user level GMM should notify the kernel level GMM to take the corresponding action on the MFC.

### Implementation for Signaling Between the User Level GMM and the Kernel Level GMM

As the user level GMM detects the change of the MRT, it will send a signal to the kernel level GMM to update the MFC in kernel. The user level functions, k_add_rg( ),and k_del_rg( ) (in kern.c), will invoke a system call, setsockopt( ) to add and delete the MFC respectively. The information transferred by setsockopt( ) is handled by the kernel function, ip_mroute_setsockopt( ) (in /ipv4/ipmr.c). The ip_mroute_setsockopt( ) function updates the MFC through ipmr_mc_modifty( ).(in /ipv4/impr.c)

### Implementation for Network Mobility

A HDR can detect the movement of its child HDR through the HLIM_C_Hello operation. A HDR can detect its own movement by examining an incoming HLIM_P_Hello from its prospective parent HDR. If a HDR detects the change of a source of HLIM_P_Hello, it declares that it has moved to a new location and registers its new parent HDR through register_new_phdr( ). The HDR needs to get a new IP address from the new parent HDR at a new location through DHCP (dynamic host configuration protocol). Once it acquires a new IP address, it updates the associated interface (i.e., U_IF) with the new IP address. It updates its HDR list and initiates the join operation (regular, mobile, or net join) in accordance with the outgoing interface specified in the MRT. (prepare_mjoins( ) in mobile.c).

FIG. 67 shows how the MP flows between GMMs. MPs are relayed from one GMM to another GMM according to the contexts in the MFC. One aspect is the implementation for processing incoming and outgoing MPs. An MP is captured by the input processing function in the IP layer (ip_rcv( ) in /ipv4.ip_input.c). The processing function examines the destination address of an incoming packet to classify the packet as a broadcast, unicast, or multicast packet. If the packet is recognized as a multicast packet, the multicast output processing function is called (ipmr_forward( ) in /ipv4/ipmr.c). The processing function finds the associated forwarding cache for the MP in the MFC (.ipmr_cache_find( ) in /ipv4/ipmr.c). If the cache is found, the MP is passed to the outgoing interface(s) indicated by the cache. (ipmr_queue_xmit( ) in /ipv4/ipmr.c) and is sent out from the interface devices (dev_queue_xmit( ) in /ipv4/dev.c). If the cache is not found, the MP is discarded.

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

We claim:

1. A method for routing packets of data from a source to a plurality of routers and receivers in a hierarchical network comprising the steps of:
assigning each router in said network to one of a plurality of hierarchical levels;
identifying a scope region bounded by one or more of the plurality hierarchical levels in which to route said packets of data;
identifying a root identifier for the scope region;
forwarding packets of data from said source to the routers in the network wherein said packets of data contain data fields identifying the scope region and the root identifier of the scope region.

2. The method of claim 1 further comprising the steps of:
identifying each router that is capable of sending packets of data to or from a router at a higher or lower level as a hierarchical designated router;
identifying the root identifier for the scope region as the hierarchical designated router directly above the scope region.

3. The method of claim 2 further comprising the steps of:
identifying a binding point for providing a linkage between the scope region and a location for a receiver that has moved outside the scope region.

4. The method of claim 1 further comprising, prior to the forwarding step, the steps of:
receiving a packet of data at a router in the network;
determining whether the router is within the scope region specified in the data field identifying the scope region for the packet of data; and,
discarding the data packet is the router is outside the scope region.

5. A method of joining a receiver to a multicast tree of a multicast session for receiving data packets from a source wherein the source is sending data packets to a plurality of routers in a scope region in a hierarchical network of routers for the mulitcast session having an application identifier comprising the steps of:
obtaining at the joining receiver the scope region and the application identifier of the multicast session from the source;
sending a root identifier request from the joining receiver to a first parent router to which said joining receiver is in communication wherein said root identifier request contains the scope region and the application identifier of the multicast session;
determining at the first parent router whether the first parent router is within the scope region;
if the first parent router is within the scope region, locating the root identifier for the scope region at the first parent router;
invoking a join operation at the first parent router to join the receiver to the multicast session;
and then replying from the first parent router to the receiver with a root identifier reply message once the join operation is completed.

6. The method of claim 5 wherein the step of invoking a join operation further comprises the steps of:
determining if the first parent router is part of the multicast tree;
if the first parent router is not part of the multicast tree, setting up a transient forwarding cache at the first parent router consisting of a group address and a corresponding outgoing interface for the joining receiver;
sending a join message from the first parent router to a second parent router;
receiving an acknowledge message from the second parent at the first parent router after the second parent router has joined the multicast tree.

7. The method of claim 6 further comprising:
determining at the first parent router if there is a transient forwarding cache for the group address specified in the acknowledge message;
switching the transient forwarding cache to a confirmed forwarding cache prior to replying with the root identifier to the receiver.

8. The method of claim 5 wherein the joining receiver receives the scope region and the application identifier from the source through the Internet.

9. The method of claim 5 wherein the joining receiver receives the scope region and the application identifier from the source through session announcement protocol.

10. The method of claim 5 wherein the joining receiver receives the scope region and the application identifier through session description protocol.

11. In a hierarchical network, a method for receiving at a receiver packets of data routed by routers from a source as part of a multicast session identified by a scope region having a unique root identifier and an application identifier wherein the receiver has moved from being in communication with a first router to being in communication with a second router comprising the step of:
sending a mobility report message from the mobile receiver to the second router wherein the mobility report message contains data identifying the scope region of the multicast session, the application identifier of the multicast session and the root identifier of the scope region.

12. The method of claim 11 further comprising the steps of:
receiving the mobility report message at the second router;
determining at the second router if the second router is outside the scope region; and,
invoking a mobile join operation if the router is outside the scope region.

13. The method of claim 12 wherein the step of invoking a mobile join operation comprises the step of:
sending a mobile join message from the second router toward a third router toward the router associated with the root identifier.

14. The method of claim 13 wherein the step of sending a join message toward a router associated with the root identifier further comprises the steps of:
placing a transient entry in the forwarding cache indicating the router associated with the root identifier as source of data packets to be forwarded to the mobile receiver.

15. The method of claim 13 wherein the mobile join message is sent by the second router to all other routers with which it is in communication.

16. The method of claim 13 wherein the step of invoking the mobile join operation further comprises the steps of:
receiving the mobile join message at the third router;
determining at the third router whether the third router is the binding point for communication to the mobile receiver wherein the binding point is the router that provides a linkages between the scope region and the mobile receiver through the shortest path.

17. The method of claim 16 wherein the third router is the binding point if the address of the third router is equal to the root identifier or if the address of any ascendant router in which the third router is in communication is equal to the root identifier.

18. The method of claim 16 further comprising the steps of:
sending a mobile acknowledge message from the third router to the second router once the binding point has been determined.

19. The method of claim 18 further comprising the steps of:
sending a mobile reply message from the second router to the mobile receiver; and,
forwarding packets of data from the multicast session to the mobile receiver through the binding point, the third router and the second router.

20. A method of forwarding packets of data from a multicast session in a network of routers arranged into a plurality of hierarchical levels comprising the step of forwarding packets of data between routers, wherein said packets of data contain data identifying a scope region containing the lower and upper hierarchical levels to which the packets will be forwarded, an application identifier for the multicast session and a unique root identifier for the scope region.
